(19) United States
(12) Patent Application Publication
(10) Pub. No.: US 2024/0098678 A1
(43) Pub. Date: Mar. 21, 2024

(54) SIDELINK POSITIONING AND RANGING OF MOBILE DEVICES WITH LOCATION SERVER ASSISTANCE

(71) Applicant: QUALCOMM Incorporated, San Diego, CA (US)

(72) Inventors: Stephen William EDGE, Escondido, CA (US); Sven FISCHER, Nuremberg (DE)

(21) Appl. No.: 18/469,547

(22) Filed: Sep. 18, 2023

Related U.S. Application Data
(60) Provisional application No. 63/376,437, filed on Sep. 20, 2022.
(60) Provisional application No. 63/484,171, filed on Feb. 9, 2023.
(60) Provisional application No. 63/501,670, filed on May 11, 2023.

(51) Int. Cl. H04W 64/00

(52) U.S. Cl. CPC H04W 64/00; H04W 92/18

(57) ABSTRACT

Embodiments provide for enhanced procedures for a Mobile Originated Location Request (MO-LR), Mobile Terminated Location Request (MT-LR) and periodic or triggered MT-LR that may be used to enable sidelink positioning and ranging location results to be obtained for a group of two or more UEs with assistance from an LMF and to be provided to the group of UEs (MO-LR) or to an LCS Client or AF (MT-LR or periodic or triggered MT-LR). The enhancements allow the LMF to interact with just one UE of the group of UEs and for an LCS Client or AF to indicate a preference for the one UE.

### RELATED APPLICATIONS

This application claims the benefit of U.S. Provisional Application No. 63/376,437, filed Sep. 20, 2022, entitled “SIDELINK POSITIONING AND RANGING OF MOBILE DEVICES WITH LOCATION SERVER ASSISTANCE”, U.S. Provisional Application No. 63/484,171, filed Feb. 9, 2023, entitled “SIDELINK POSITIONING AND RANGING OF MOBILE DEVICES WITH LOCATION SERVER ASSISTANCE”, and U.S. Provisional Application No. 63/501,670, filed May 11, 2023, entitled “SIDELINK POSITIONING AND RANGING OF MOBILE DEVICES WITH LOCATION SERVER ASSISTANCE”, all of which are assigned to the assignee hereof and incorporated herein by reference in their entirety.

### BACKGROUND

### 1. Field of Disclosure

The present disclosure relates generally to the field of wireless communications, and more specifically to determining the location of a User Equipment (UE) using measurements of radio frequency (RF) signals transmitted over or coordinated over a sidelink communications channel.

### 2. Description of Related Art

In a wireless communication network, such as a mobile/cellular broadband network (e.g., a fifth-generation (5G) wireless network), UEs may be capable of communicating with each other using sidelink (SL) communications, a form of wireless RF communications. Further, procedures may be established to enable two or more UEs to perform positioning (including ranging) using SL communications. However, many aspects of these SL-based procedures are not yet formalized.

### BRIEF SUMMARY

This disclosure provides enhanced procedures for Mobile Originated Location Request (MO-LR), Mobile Terminated Location Request (MT-LR) and periodic or triggered MT-LR that may be used to enable sidelink positioning and ranging location results to be obtained for a group of two or more UEs with assistance from an LMF and to be provided to the group of UEs (MO-LR) or to a Location Service (LCS) Client or Application Function (AF) (MT-LR or periodic or triggered MT-LR). The enhanced procedures allow the LMF to interact with just one UE of the group of UEs and for an LCS Client or AF to indicate a preference for the one UE.

An example method performed at a location server for supporting sidelink positioning of a plurality of user equipments (UEs), according to this disclosure, comprises: receiving a request for location related information for the plurality of UEs, the request associated with a first UE of the plurality of UEs, the request based on one of: a Mobile Originated Location Request (MO-LR) sent by the first UE, or a Mobile Terminated Location Request (MT-LR) or a periodic or triggered MT-LR sent by an external client. The method further comprises obtaining, from the first UE of the plurality of UEs, capability information of each UE of the plurality of UEs. The method further comprises obtaining the location related information. The method further comprises sending the location related information, wherein the sending comprises one of: sending the location related information to the first UE, responsive to the request of location related information being based on (i) MO-LR, wherein the location related information supports the sidelink positioning of the plurality of UEs; or sending the location related information to the external client, responsive to the request of location related information being based on (ii) MT-LR or periodic or triggered MT-LR, wherein the location related information is based on the sidelink positioning of the plurality of UEs.

An example method performed at a first UE of a plurality of UEs for supporting sidelink positioning of the plurality of UEs, according to this disclosure, comprises: performing an operation comprising one of: (i) sending an MO-LR request for location related information towards a location server, or (ii) receiving an MT-LR request or a periodic or triggered MT-LR request for the location related information from the location server; discovering other UEs of the plurality of UEs. The method further comprises obtaining capability information of each UE of the plurality of UEs. The method further comprises sending the capability information of each UE of the plurality of UEs to the location server. The method further comprises receiving a message from the location server, the message based at least in part on the capability information of each UE of the plurality of UEs. The method further comprises coordinating the sidelink positioning of the plurality of UEs based at least in part on the message. The method further comprises obtaining location measurements, location results, or both, based on the sidelink positioning of the plurality of UEs. The method further comprises sending the location measurements or the location results to the location server when the message comprises a request for the location measurements or the location results, wherein the location server calculates the location results based on the location measurements when the first UE sends the location measurements to the location server.

An example location server for supporting sidelink positioning of a plurality of user equipments (UEs), according to this disclosure, comprises: one or more transceivers; one or more memories; and one or more processors communicatively coupled with the one or more transceivers and the one or more memories. The one or more processors are configured to receive, via the one or more transceivers, a request for location related information for the plurality of UEs, the request associated with a first UE of the plurality of UEs, the request being based on one of: a Mobile Originated Location Request (MO-LR) sent by the first UE, or a Mobile Terminated Location Request (MT-LR) or a periodic or triggered MT-LR sent by an external client. The one or more processors are further configured to obtain, via the one or more transceivers from the first UE of the plurality of UEs, capability information of each UE of the plurality of UEs; obtain the location related information. The one or more processors are further configured to send the location related information via the one or more transceivers, wherein the sending comprises one of: sending the location related information to the first UE, responsive to the request of location related information being based on (i) MO-LR, wherein the location related information supports the sidelink positioning of the plurality of UEs; or sending the location related information to the external client, responsive to the request of location related information being based on (ii) MT-LR or periodic or triggered MT-LR, wherein the location related information is based on the sidelink positioning of the plurality of UEs.

An example first UE of a plurality of UEs for supporting sidelink positioning of the plurality of UEs, according to this disclosure, comprises one or more transceivers; one or more memories; and one or more processors communicatively coupled with the one or more transceivers and the one or more memories. The one or more processors are configured to perform an operation comprising one of: (i) sending an MO-LR request for location related information towards a location server, or (ii) receiving an MT-LR request or a periodic or triggered MT-LR request for the location related information from the location server. The one or more processors are further configured to discover other UEs of the plurality of UEs. The one or more processors are further configured to obtain capability information of each UE of the plurality of UEs. The one or more processors are further configured to send the capability information of each UE of the plurality of UEs to the location server. The one or more processors are further configured to receive a message from the location server, the message based at least in part on the capability information of each UE of the plurality of UEs. The one or more processors are further configured to coordinate the sidelink positioning of the plurality of UEs based at least in part on the message. The one or more processors are further configured to obtain location measurements, location results, or both, based on the sidelink positioning of the plurality of UEs. The one or more processors are further configured to send the location measurements or the location results to the location server when the message comprises a request for the location measurements or the location results, wherein the location server calculates the location results based on the location measurements when the first UE sends the location measurements to the location server.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of an architecture of a communication system including a number of UEs, a Radio Access Network (RAN), and a 5G Core Network (5GC).

FIG. 2 shows an architecture of a communication system for network supported sidelink (SL) positioning.

FIG. 3 is a signal flow illustrating signaling between UEs and a location server for network supported sidelink positioning.

FIGS. 4A and 4B are block diagrams illustrating implementations of the structure of a sidelink positioning protocol (SLPP) message.

FIG. 5 is a signal flow diagram of embodiments of an SLPP positioning session between UEs in a UE-based or “autonomous” mode.

FIG. 6 is another signal flow diagram of embodiments of an SLPP positioning session between UEs in a UE-based or “autonomous” mode.

FIG. 7 is a signal flow diagram of a first example of an SLPP positioning session in a network assisted mode.

FIG. 8 is a signal flow diagram of a second example of an SLPP positioning session in a network assisted mode.

FIG. 9 is a signal flow diagram of a third example of an SLPP positioning session in a network assisted mode.

FIG. 10 is a diagram of an example sidelink positioning/ranging procedure for a group of UEs where there is no server assistance.

FIG. 11 is a diagram of an example enhanced MO-LR procedure applied to a group of UEs.

FIG. 12 is a diagram of an example enhanced MT-LR Procedure for Sidelink Positioning/Ranging with server assistance.

FIG. 13 is a diagram of an example enhanced periodic or triggered MT-LR procedure for sidelink positioning/ranging with server Assistance.

FIG. 14 is a diagram of an example enhanced periodic or triggered MO-LR procedure for sidelink positioning/ranging with server Assistance.

FIG. 15 is a diagram of an example MT-LR procedure for ranging between target UEs.

FIG. 16 is a block diagram of an embodiment of a UE.

FIG. 17 is a block diagram of an embodiment of a computer system.

FIG. 18 is a diagram of an example periodic and triggered MT-LR procedure for ranging between target UEs.

FIG. 19 is a diagram of an embodiment of a method performed at a location server for supporting sidelink positioning of a plurality of UEs.

FIG. 20 is a diagram of an embodiment of a method performed at a UE for supporting sidelink positioning of a plurality of UEs.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c). Additionally, operations within some procedures illustrated in the figures may be shown as numerals and referred to herein as stages (which may or may not be separately labeled in the figures).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Also, references made herein to “TS” documents (e.g., “TS 23.304”) refer to corresponding technical specifications of the 3rd Generation Partnership Project (3GPP).

As noted, SL-based signaling between two or more UEs potentially can be used to perform positioning (including ranging) of at least one of the UEs. However, the many procedural aspects of such positioning have yet to be defined or formalized. Embodiments herein address these and other issues by providing enhanced procedures for a mobile originated location request (MO-LR), a mobile terminated location request (MT-LR), and a periodic or triggered MT-LR, that may be used to enable sidelink positioning and ranging location results to be obtained for a group of two or more UEs with assistance from a location server (e.g. an LMF) and to be provided to the group of UEs (MO-LR) or to an LCS Client or AF (MT-LR or periodic or triggered MT-LR). Embodiments are described after a review of relevant technology.

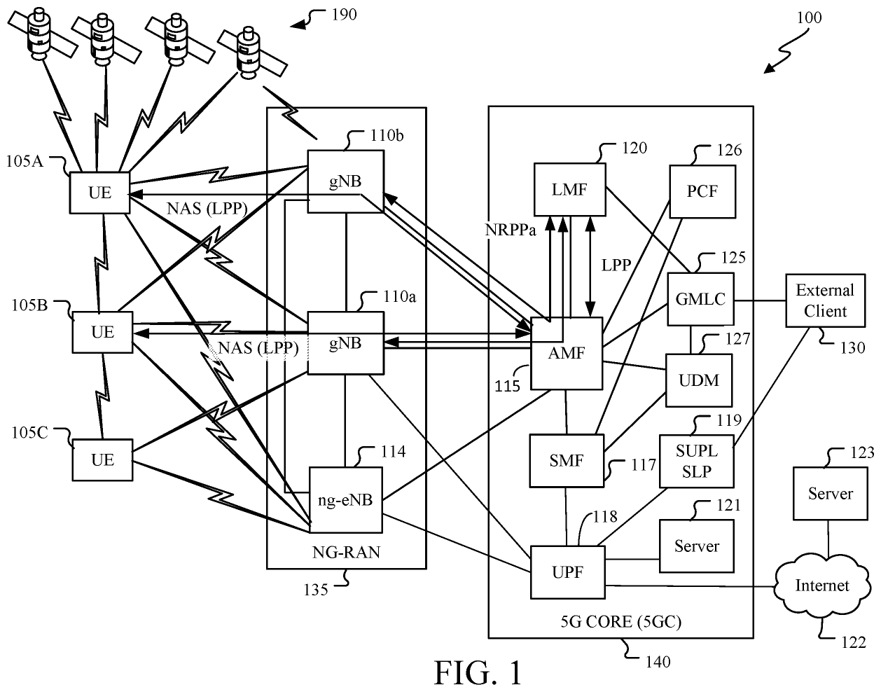

FIG. 1 shows an example of a communication system 100 that includes a first UE 105A, a second UE 105B, a third UE 105C, a Radio Access Network (RAN) 135, here a Fifth Generation (5G) Next Generation (NG) RAN (NG-RAN), and a 5G Core Network (5GC) 140. The 5GC 140, for example, may be a public land mobile network (PLMN). The UEs 105A, 105B, and 105C may be sometimes referred to herein as UE 105 individually or UEs 105 collectively. The UE 105 may be, e.g., an IoT device, a location tracker device, a cellular telephone, a vehicle, an On-Board Unit (OBU), or other similar type of device. The UE 105 may additionally be considered as a roadside unit (RSU) that can support vehicle to everything (V2X) communication and procedures and/or a positioning reference unit (PRU). A 5G network may also be referred to as a New Radio (NR) network; NG-RAN 135 may be referred to as a 5G RAN or as an NR RAN; and 5GC 140 may be referred to as an NG Core network (NGC). The RAN 135 may be another type of RAN, e.g., a 3G RAN, a 4G Long Term Evolution (LTE) RAN, etc. The communication system 100 may utilize a constellation of satellite vehicles (SVs) 190 which may support a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). In some embodiments, a UE 105 may communicate via an SV 190 and an Earth station (not shown in FIG. 1) with a RAN node (e.g. a gNB 110) or a 5GC 140 node, in which case the UE 105 may not communicate directly with a RAN node but only via the SV 190. This may be used to increase the coverage and/or the capacity of the NG-RAN 135. Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, a Gateway Mobile Location Center (GMLC) 125, a Policy Control Function (PCF) 126, a Unified Data Management (UDM) 127, a User Plane Function (UPF) 118, and a Secure User Plane Location (SUPL) Location Platform (SLP) 119. The gNBs 110a, 110b, and the ng-eNB 114 are communicatively coupled to each other, are each configured wirelessly to communicate bi-directionally with the UEs 105, and are each communicatively coupled to, and configured to bi-directionally communicate with, the AMF 115 and the UPF 118. The gNBs 110a, 110b, and the ng-eNB 114 may be referred to as base stations (BSs) or RAN nodes. The AMF 115, the SMF 117, the LMF 120, and the GMLC 125 are communicatively coupled to each other, and the GMLC 125 is communicatively coupled to an external client 130 which may also be referred to as a location services (LCS) client. The AMF 115, the SMF 117, the UPF 118, and the SLP 119 are communicatively coupled to each other, and the SLP 119 is communicatively coupled to the external client 130. Server 121, the Internet 122, and server 123 may be communicatively coupled with the UPF 118 and may facilitate SL positioning, according to some embodiments. The SMF 117 may further serve as an initial contact point of a Service Control Function (SCF) (not shown) to create, control, and delete media sessions. The base stations 110a, 110b, 114 may be a macro cell (e.g., a high-power cellular base station), or a small cell (e.g., a low-power cellular base station), or an access point (e.g., a short-range base station configured to communicate with short-range technology such as WI-FI, WI-FI DIRECT (Wi-Fi D), BLUETOOTH, Bluetooth-Low Energy (BLE), ZIGBEE, etc. One or more of the base stations 110a, 110b, 114 may be configured to communicate with the UEs 105 via multiple carriers. Each of the base stations 110a, 110b, 114 may provide communication coverage for a respective geographic region, e.g., a cell. Each cell may be partitioned into multiple sectors as a function of the base station antennas. An interface between a UE 105 and a gNB 110 or ng-eNB 114 may be referred to as a Uu interface and an interface between two UEs 105 may be referred to as a sidelink or PC5 interface.

The PCF 126 may support a unified policy framework to govern network behavior, provide policy rules to control plane functions to enforce them, access subscription information relevant for policy decisions, provision UEs 105 with necessary policies and parameters for Ranging/SL Positioning services. Policies and parameters for Ranging/SL Positioning services provisioned in UEs 105 may include authorization policy and parameters for Ranging/SL Positioning over PC5, authorization policy and parameters for network based SL Positioning, and network assisted SL Positioning and authorization policy and parameters for Ranging/SL Positioning service exposure.

The UDM 127 may support generation of UE authentication credentials, user identification handling (e.g. storage and management of a Subscription Permanent Identifier (SUPI) and GPSI for each UE), de-concealment of a privacy-protected subscription identifier (SUCI), access authorization based on subscription data (e.g. roaming restrictions), subscription management, and mobility management (e.g. by storing the current serving AMF and serving PLMN identity for each subscribed UE).

FIG. 1 provides a generalized illustration of various components, any or all of which may be utilized as appropriate, and each of which may be duplicated or omitted, as necessary. Specifically, although only UEs 105 are illustrated, many UEs (e.g., hundreds, thousands, millions, etc.) may be utilized in the communication system 100. Similarly, the communication system 100 may include a larger (or smaller) number of SVs (i.e., more or fewer than the four SVs 190 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UEs 105) or at base stations 110a, 110b, 114 and/or provide location assistance to the UEs 105 (via the LMF 120 or SLP 119 or other location server) and/or compute a location for one or both of the UEs 105 at a location-capable device such as the UEs 105, the base stations 110a, 110b, the LMF 120, or SLP 119 based on measurement quantities received at the UEs 105 or the base stations 110a, 110b, 114 for such directionally-transmitted signals. The GMLC 125, the LMF 120, the AMF 115, the SMF 117, the UPF 118, the SLP 119, the ng-eNB (eNodeB) 114, and the gNBs (gNodeBs) 110a, 110b are examples and may, in various embodiments, be replaced by or include various other entities, including location server functionality and/or base station functionality.

The communication system 100 is capable of wireless communication in that components of the system 100 can communicate with one another (at least sometimes using wireless connections) directly or indirectly, e.g., via the base stations 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UEs 105 may include multiple UEs and may be a mobile wireless communication device but may communicate wirelessly and via wired connections. The UEs 105 may be any of a variety of devices, e.g., a smartphone, a tablet computer, a vehicle-based device, etc., but these are examples only as the UEs 105 is not required to be any of these configurations, and other configurations of UEs may be used. Other UEs may include wearable devices (e.g., smart watches, smart jewelry, smart glasses, or headsets, etc.). Still other UEs may be used, whether currently existing or developed in the future. Further, other wireless devices (whether mobile or not) may be implemented within the system 100 and may communicate with each other and/or with the UEs 105, the base stations 110a, 110b, 114, the core network 140, and/or the external client 130. For example, such other devices may include IoT or Industrial Internet of Things (IIoT) devices, medical devices, home entertainment and/or automation devices, etc. The core network 140 may communicate with the external client 130, the server 123, or the server 121 (e.g., which may each be a computer system), e.g., to allow the external client 130, the server 123 or the server 121 to request and/or receive location information regarding the UEs 105 (e.g., via the GMLC 125, SLP 119 or UPF 118).

The UEs 105 or other devices may be configured to communicate in various networks and/or for various purposes and/or using various technologies (e.g., 5G, Wi-Fi communication, multiple frequencies of Wi-Fi communication, satellite positioning, satellite communication, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or Wi-Fi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105 may communicate with each other through UE-to-UE sidelink (SL) communications by transmitting over one or more sidelink channels, such as a physical sidelink synchronization channel (PSSCH), a physical sidelink broadcast channel (PSBCH), a physical sidelink control channel (PSCCH), Synchronization Signal Block (SSB), sidelink channel state information reference signal (SL-CSIRS), physical sidelink feedback channel (PSFCH), or sidelink sounding reference signals (SL-SRS).

The UEs 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UEs 105 may correspond to a cellphone, smartphone, laptop, tablet, PDA, tracking device, navigation device, Internet of Things (IoT) device, asset tracker, health monitors, security systems, smart city sensors, smart meters, wearable trackers, or some other portable or moveable device. Typically, though not necessarily, the UEs 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 Wi-Fi (also referred to as Wi-Fi), Bluetooth (BT), Worldwide Interoperability for Microwave Access (WiMAX), 5G new radio (NR) (e.g., using the NG-RAN 135 and the 5GC 140), etc. The UEs 105 may support wireless communication using a Wireless Local Area Network (WLAN) which may connect to other networks (e.g., the Internet) using a Digital Subscriber Line (DSL) or packet cable, for example. The use of one or more of these RATs may allow the UEs 105 to communicate with the external client 130, the server 121, and/or the server 123 (e.g., via elements of the 5GC 140 and possibly the Internet 122) and/or allow the external client 130, the server 121 and/or the server 123 to receive location related information regarding the UEs 105 (e.g., via the GMLC 125, SLP 119 or UPF 118).

Each of the UEs 105 may include a single entity or may include multiple entities such as in a personal area network where a user may employ audio, video, and/or data I/O (input/output) devices and/or body sensors and a separate wireline or wireless modem. An estimate of a location of a UE, e.g., UE 105, may be referred to as a location, location estimate, location fix, fix, position, position estimate, or position fix, and may be geographic, thus providing location coordinates for the UE (e.g., latitude and longitude) which may or may not include an altitude component (e.g., height above sea level, height above or depth below ground level, floor level, or basement level). Alternatively, a location of the UE may be expressed as a civic location (e.g., as a postal address or the designation of some point or small area in a building such as a particular room or floor). A location of the UE may be expressed as an area or volume (defined either geodetically or in civic form) within which the UE is expected to be located with some probability or confidence level (e.g., 67%, 95%, etc.). A location of the UE may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise.

When sidelink positioning is used, an absolute (e.g. global) or relative location of a UE may not always be obtained. Instead, location results may be obtained for a UE which may include a range or distance between the UE and each of one or more other UEs, a direction from the UE to each of one or more other UEs, a location of the UE relative to the location of some other UE, a location of one or more other UEs relative to the location of the UE, a velocity of the UE, and/or a velocity of each of one or more other UEs. A velocity of a UE may be absolute (e.g. relative to the Earth) or may be relative to some other UE, and may then be referred to as a “relative velocity”. A relative velocity of a UE B relative to another UE A may include a “radial velocity” component, which may be equal to a rate of change of a range from the UE A to the UE B, and a “transverse velocity” component which may be at right angles to the radial velocity component as seen by the UE A and may be equal to a rate of angular change of a direction to the UE B from the UE A multiplied by the range from the UE A to the UE B. In the description contained herein, the use of the term “location result” or “location results” for sidelink positioning of a UE or a group of UEs may comprise any of these variants unless indicated otherwise.

The UEs 105 may be configured to communicate with other entities using one or more of a variety of technologies. The UEs 105 may be configured to communicate with one or more other UEs (e.g. other UEs 105) via one or more device-to-device (D2D) peer-to-peer (P2P) links. The D2D P2P links may be an example of (or may be supported by) sidelink signaling and be supported with any appropriate D2D radio access technology (RAT), such as LTE Direct (LTE-D), Wi-Fi Direct (Wi-Fi D), Bluetooth, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UEs 105 via wireless communication between the UEs and one or more of the gNBs 110a, 110b, which may provide wireless communications access to the 5GC 140 on behalf of the UE using 5G. In FIG. 1, the serving gNB for the UE 105A is assumed to be the gNB 110b, while the serving gNB for the UE 105B is assumed to be the gNB 110a, although another gNB may act as a serving gNB if the UEs 105 move to another location or may act as a secondary gNB to provide additional throughput and bandwidth to the UEs 105 and the UEs 105 may share the same serving gNB.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UEs 105. One or more of the gNBs 110a, 110b, and/or the ng-eNB 114 may be configured to function as positioning-only beacons which may transmit signals to assist with determining the position of the UEs 105 but may not receive signals from the UEs 105 or from other UEs.

The base stations 110a, 110b, 114 may transmit one or more downlink reference signals, including a positioning reference signal (PRS) transmission. The PRS transmission may be configured for a specific UE 105 to measure and report one or more report parameters (for example, report quantities) associated with positioning and location information. The PRS transmission and report parameter feedback may support various location services (for example, navigation systems and emergency communications). In some examples, the report parameters supplement one or more additional location systems supported by the UE 105 (such as global positioning system (GPS) technology).

A base station 110a, 110b, 114 may configure a PRS transmission on one or more PRS resources of a channel. A PRS resource may span resource elements of multiple physical resource blocks (PRBs) within one or more OFDM symbols of a slot depending on a configured number of ports. For example, a PRS resource may span one symbol of a slot and contain one port for transmission. In any OFDM symbol, the PRS resources may occupy consecutive PRBs. In some examples, the PRS transmission may be mapped to consecutive OFDM symbols of the slot. In other examples, the PRS transmission may be mapped to interspersed OFDM symbols of the slot. Additionally, the PRS transmission may support frequency hopping within PRBs of the channel.

The one or more PRS resources may span a number of PRS resource sets according to a PRS resource setting of the base station 110a, 110b, 114. The structure of the one or more PRS resources, PRS resource sets, and PRS resource settings within a PRS transmission may be referred to as a multi-level resource setting. For example, a multi-level PRS resource setting of the base station 110a, 110b, 114 may include multiple PRS resource sets and each PRS resource set may contain a set of PRS resources (such as a set of 4 PRS resources).

The UEs 105 may receive the PRS transmission over the one or more PRS resources of the slot. The UEs 105 may determine a report parameter for at least some PRS resources included in the transmission. The report parameter (which may include a report quantity) for each PRS resource may include one or more of a time of arrival (TOA), a reference signal time difference (RSTD), a reference signal receive power (RSRP), an angle, a PRS identification number, a reception to transmission difference (UE Rx-Tx), a signal-to-noise ratio (SNR), or a reference signal receive quality (RSRQ).

Similarly, the UEs 105 may be configured to transmit one or more additional uplink reference signals that may be received by base stations 110a, 110b, 114 and used for positioning. For example, UEs 105 may transmit a sounding reference signal (SRS) for positioning. Base stations 110a, 110b, 114 that receive uplink reference signals from a UEs 105 may perform positioning measurements, such as one or more of a time of arrival (TOA), reception to transmission difference (UE Rx-Tx).

A position estimation of the UE may be determined using reference signals, such as PRS signals or SRS for positioning signals, or other reference signals, from one or more base stations 110a, 110b, 114 or the UE. Positioning methods, such as downlink (DL) Time Difference of Arrival (DL-TDOA), DL Angle of Departure (DL AOD), Enhanced Cell ID (ECID) are position methods that may be used to estimate the position of the UE using reference signals from base stations. DL-TDOA, for example, relies on measuring Reference Signal Time Differences (RSTDs) between downlink (DL) signals received from a base station for a reference cell and base station(s) for one or more neighbor cells. The DL signals for which RTSDs may be obtained comprise a Cell-specific Reference Signal (CRS) and a Positioning Reference Signal (PRS).

Other positioning methods may use reference signals transmitted by the UE including uplink based positioning methods and downlink and uplink based positioning methods. For example, uplink based positioning methods include, e.g., UL Time Difference of Arrival (UL-TDOA), UL Angle of Arrival (UL AOA), UL Relative Time of Arrival (UL-RTOA) and downlink and uplink based positioning methods, e.g., multi cell Round-trip time (RTT) with one or more neighboring base stations. Additionally, sidelink based positioning may be used in which UEs transmit and/or receive sidelink positioning reference signals that are measured and used for positioning.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UEs 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UEs 105, including cell change and handover, and may participate in supporting a signaling connection to the UEs 105 and possibly data and voice bearers for the UEs 105. The LMF 120 may communicate directly or indirectly with the UEs 105, e.g., through wireless communications, or directly or indirectly with the base stations 110a, 110b, 114. The LMF 120 may support positioning of the UEs 105 when the UEs 105 access the NG-RAN 135 and may support position procedures/methods such as Assisted GNSS (A-GNSS), Time Difference of Arrival (TDOA) (e.g., Downlink (DL) TDOA or Uplink (UL) TDOA), Real Time Kinematic (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UEs 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE) may be performed at the UE (e.g., using signal measurements obtained by the UE for signals transmitted by wireless nodes such as the gNBs 110a, 110b and/or the ng-eNB 114, and/or assistance data provided to the UE, e.g., by the LMF 120). At least part of the positioning functionality (including derivation of the location of the UE) alternatively may be performed at the LMF 120 (e.g., using signal measurements obtained by the gNBs 110a, 110b and/or the ng-eNB 114. The AMF 115 may serve as a control node that processes signaling between the UEs 105 and the core network 140, and provides QoS (Quality of Service) flow and session management. The AMF 115 may support mobility of the UEs 105 including cell change and handover and may participate in supporting signaling connection to the UEs 105.

The GMLC 125 may support a location request for the UEs 105 received from the external client 130 and may forward such a location request to the AMF 115 for forwarding by the AMF 115 to the LMF 120 or may forward the location request directly to the LMF 120. A location response from the LMF 120 (e.g., containing a location estimate or sidelink location results for the UEs 105) may be returned to the GMLC 125 either directly or via the AMF 115 and the GMLC 125 may then return the location response (e.g., containing the location estimate or sidelink location results) to the external client 130. The GMLC 125 is shown as connected to both the AMF 115 and LMF 120, though only one of these connections may be supported by the 5GC 140 in some implementations. A GMLC may act as a home GMLC (H-GMLC) when located in a home PLMN for a target UE or as a visited GMLC (V-GMLC) when located in a serving PLMN for a target UE, or may act as both an H-GMLC and V-GMLC when located in a home PLMN for a non-roaming target UE. The term (H)GMLC or GMLC may be used to indicate a GMLC that acts as an H-GMLC and may act as a V-GMLC.

A User Plane Function (UPF) 118 may support voice and data bearers for UE 105 and may enable UE 105 voice and data access to other networks such as the Internet 122 and to servers such as server 121 and server 123. The UPF 118 may be connected to gNBs 110 and ng-eNB 114. UPF 118 functions may include: external Protocol Data Unit (PDU) session point of interconnect to a Data Network, packet (e.g. Internet Protocol (IP)) routing and forwarding, packet inspection and user plane part of policy rule enforcement, Quality of Service (QoS) handling for user plane, downlink packet buffering and downlink data notification triggering. UPF 118 may be connected to the SLP 119 to enable support of positioning of UE 105 using SUPL. SLP 119 may be further connected to or accessible from external client 130.

As illustrated, a Session Management Function (SMF) 117 connects to the AMF 115 and the UPF 118. The SMF 117 may have the capability to control both a local and a central UPF within a PDU session. SMF 117 may manage the establishment, modification, and release of PDU sessions for UE 105, perform IP address allocation and management for UE 105, act as a Dynamic Host Configuration Protocol (DHCP) server for UE 105, and select and control a UPF 118 on behalf of UE 105.

As further illustrated in FIG. 1, the LMF 120 may communicate with the gNBs 110a, 110b and/or the ng-eNB 114 using a New Radio Position Protocol A (NRPPa), which may be defined in 3GPP Technical Specification (TS) 38.455. NRPPa messages may be transferred between the gNB 110a (or the gNB 110b) and the LMF 120, and/or between the ng-eNB 114 and the LMF 120, via the AMF 115. As further illustrated in FIG. 1, the LMF 120 and the UEs 105 may communicate using an LTE Positioning Protocol (LPP), which may be defined in 3GPP TS 37.355. Here, LPP messages may be transferred between the UEs 105 and the LMF 120 via the AMF 115 and the serving gNB 110a, 110b or the serving ng-eNB 114 for the UEs 105. For example, LPP messages may be transferred between the LMF 120 and the AMF 115 using service operations based on the Hypertext Transfer Protocol (HTTP) and may be transferred between the AMF 115 and the UEs 105 using a 5G Non-Access Stratum (NAS) protocol.

The LPP protocol may be used to support positioning of the UEs 105 using UE-assisted and/or UE-based position methods such as A-GNSS, RTK, TDOA, AOA, AOD, and/or E-CID. The NRPPa protocol may be used to support positioning of the UEs 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional Synchronization Signal (SS) transmissions from the gNBs 110a, 110b, and/or the ng-eNB 114. The LMF 120 is illustrated in FIG. 1 as being located in the core network 140, but may be external to the core network 140, e.g., in an NG-RAN. For example, the LMF 120 may be co-located or integrated with a gNB, or may be disposed remote from the gNB and configured to communicate directly or indirectly with the gNB.

With a UE-assisted position method, the UE, e.g., UE 105A or UE 105B may obtain location measurements and send the measurements to a location server (e.g., the LMF 120) for computation of a location estimate for the UE. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ), AOA, AOD, for the gNBs 110a, 110b, the ng-eNB 114, and/or a WLAN AP. The location measurements may also or instead include measurements of GNSS pseudorange, code phase, and/or carrier phase for the SVs 190.

With a UE-based position method, the UE, e.g., UE 105A or UE 105B, may obtain location measurements (e.g., which may be the same as or similar to location measurements for a UE-assisted position method) and may compute a location of the UE (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114), may obtain location measurements (e.g., measurements of RSSI, RTT, RSRP, RSRQ, AOA, AOD, or Time of Arrival (ToA) for signals transmitted by the UE, e.g., UE 105A or UE 105B) and/or may receive measurements obtained by the UE. The one or more base stations or APs may send the measurements to a location server (e.g., the LMF 120) for computation of a location estimate for the UE.

As noted, while the communication system 100 is described in relation to 5G technology, the communication system 100 may be implemented to support other communication technologies, such as GSM, WCDMA, LTE, etc., that are used for supporting and interacting with mobile devices such as the UEs 105 (e.g., to implement voice, data, positioning, and other functionalities). For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125.

Positioning for UEs in a radio network, such as communication system 100 shown in FIG. 1, typically uses Uu interfaces, i.e., a radio interface between a UE 105 and the radio access network, for DL PRS and/or UL PRS. Positioning for UEs may also or instead use sidelink PRS (SL-PRS), which may be a specific sidelink defined reference signal for positioning or may reuse Uu PRS, e.g., UL PRS, sometimes referred to as Sounding Reference Signal for positioning (SRSPos), or other reference signals may be transmitted in the sidelink channel. Sidelink positioning may enhance UE positioning by providing additional transmission (or reception) nodes. A UE, such as UE 105B, with a known position may be used to support position determination of another target UE, such as UE 105A, where the UE 105B is sometimes referred to as an anchor node.

With a sidelink positioning method, a UE 105A for example may transmit a sidelink PRS or sidelink SRS signal which is received and measured by another UE 105B. In addition or instead, the UE 105B for example may transmit a sidelink PRS or sidelink SRS signal which is received and measured by the UE 105A. A sidelink PRS may be similar to a PRS (e.g. DL PRS) transmitted by a gNB 110, e.g. as described previously. A sidelink SRS may be similar to an SRS (e.g. uplink) SRS transmitted by a UE 105 for measurement by a gNB 110, e.g. as described previously. Measurements of SL PRS or SL SRS signals may include a reception to transmission time difference (Rx-Tx), time of arrival (TOA), reference signal receive power (RSRP), reference signal receive quality (RSRQ), angle of arrival (AOA) and reference signal time difference (RSTD). SL position methods may include SL round trip signal propagation time (RTT) (also referred to as ranging), SL AOA, SL AOD, or any combination thereof.

In some scenarios, a group of UEs (not shown in FIG. 1) may support SL positioning. In this case, one UE in the group may transmit an SL PRS or SL SRS signal which may be measured by some or all of the other UEs in the group. Some or all of the other UEs in the group may also each transmit an SL PRS or SL SRS signal (e.g. with each UE transmitting SL SRS or SL PRS at a different time or times than times at which other UEs in the group transmit SL PRS or SL SRS) which may be measured by some or all other UEs in the group different to the UE transmitting the UL PRS or ULS SRS. Measurements made by UEs applicable to the transmission of SL PRS or SL SRS by a group of UEs may include Rx-Tx, TOA, RSTD, AOA, RSRP, RSRQ, or any combination thereof. Position methods supported by these measurements may include sidelink RTT (e.g. ranging), sidelink AOA, sidelink AOD, sidelink TDOA (SL-TDOA), or any combination thereof. Based on the measurements and the position methods(s), each UE may determine location results for itself and/or for one or more other UEs in the group. As described previously, the location results for a UE may include a range or distance between the UE and each of one or more other UEs in the group, a direction from the UE to each of one or more other UEs in the group, a direction to the UE from each of one or more other UEs in the group, a location of the UE relative to a location of some other UE in the group, a location of the UE relative to some other known location, an absolute location of the UE, a velocity of the UE or a velocity of the UE relative to some other UE.

Sidelink positioning may be used for positioning of UEs independently of a core network (e.g. 5GC 140) or a serving PLMN. One example implementation of sidelink positioning may be found in vehicular communication systems, such as V2X, which may be used for safety related applications, such as safety warnings, traffic congestion (e.g., automated traffic control), and coordinated or automated vehicle maneuvering. One aspect of sidelink positioning that may require a solution for standardization is a sidelink positioning protocol (SLPP) that can be used between UEs, including between an RSU and UEs, and location servers. The SLPP, for example, may support sidelink positioning between UEs, RSUs, and PRUs with network access independence. The SLPP may provide support for sidelink positioning for a pair of UEs (e.g., ranging), groups of UEs (V2X), and for UEs that are members of multiple different groups. By way of example, SLPP may provide support for various position techniques currently standardized for UE-based and UE-assisted support by a location server (e.g. LMF 120) such as PRS RTT, AOA, Differential AOA (DAOA), AOD, Differential AOD (DAOD), but may also enable the support of other PRS and SRS based position methods and non-PRS methods such as RTK at a later time. By enabling the addition of new capabilities and methods at a later time, the SLPP may avoid the need to define separate new positioning protocols different to SLPP. By way of example, additional position methods that may be included in SLPP at a later time may include RTK, Wi-Fi, Ultra-Wideband (UWB), BT positioning methods. The SLPP may enable direct sidelink operation initially (where UEs communicate and coordinate positioning by exchanging SLPP messages using sidelink signaling), and may be extended later to sidelink operation via relays and operation via a network, where UEs may exchange SLPP messages via a network or via intermediate relay UEs. For example, this might be used to coordinate positioning of two vehicles on a collision course at a corner where direct SL signaling between the two vehicles is not possible. Thus, SLPP may define support for SL PRS based positioning initially in a generic manner to simplify extension to support of other position methods later. For example, SLPP may define generic SLPP messages similar to generic LPP messages defined for LPP in 3GPP TS 37.355. SLPP may support separate position methods (e.g. SL PRS RTT, SL PRS AOA, SL PRS AOD) using common procedures and common parameters where feasible. SLPP may define procedures that can be reused for multiple position methods and are not limited to just one or a few position methods. SLPP may be enabled to be transferred and used by various entities, such as UEs, RSUs, PRUs, and location servers, such as LMFs and SUPL SLPs. The location server (e.g., LMF and SUPL SLP) usage may transfer SLPP messages inside LPP messages to enable UE-assisted positioning by an LMF or SUPL SLP. Alternatively, the location server (e.g., LMF and SUPL SLP) usage may transfer SLPP messages not in association with LPP messages to enable UE-assisted positioning by an LMF or SUPL SLP. SLPP may further support relative (local) and global positioning.

The term “target UE” as used herein may refer to a UE for which location results are desired. When a group of two or more UEs participate in SL positioning, only some of the group of UEs may be target UEs as location results may already be known or may not be needed for the other UEs. However, for generality, when discussing the techniques described herein for positioning of a group of UEs, all of the UEs can be considered to be potentially target UEs, as there may be little or no difference in how the techniques described herein are used for the positioning.

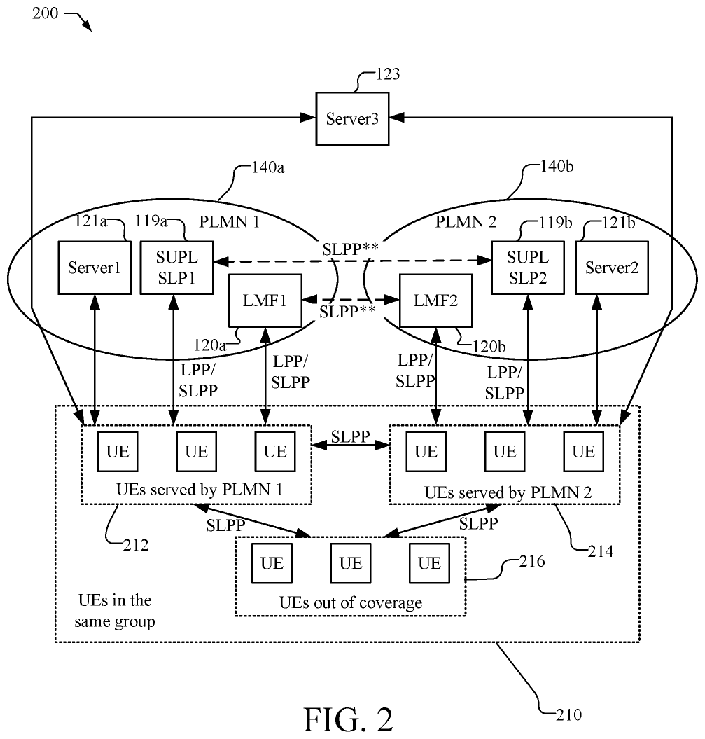

FIG. 2, by way of example, shows an architecture of a communication system 200 capable of network-supported sidelink positioning. As illustrated in FIG. 2, a number of UEs may be combined within a same group 210 for sidelink positioning. Within the group 210, various subgroups of UEs may be present. For example, the group 210 of UEs may include a first subgroup 212 of UEs that is served by a first network (PLMN1 140a), while a second subgroup 214 of UEs is served by a second (different) network (PLMN2 140b), and a third subgroup 216 of UEs is out of coverage of and is not served by either network. One or more of the UEs served by a network, e.g., the UEs in subgroup 212 served by PLMN1 140a, or the UEs in subgroup 214 served by PLMN2 140b, may include RSUs.

A location server in a serving network, e.g., LMF1 120a, SUPL SLP1 119a, or Server1 121a in the serving PLMN1 140a, LMF2 120b, SUPL SLP2 119b, or Server2 121b in the serving PLMN2 140b, and Server3 123 (communicating to UEs via PLMN1 140a and/or PLMN2 140b), may assist some or all UEs in a group that is served by the network (PLMN), e.g., subgroups 212 and 214, respectively. As illustrated, the location servers may support UEs by communicating with the UEs using “LPP/SLPP,” which represents communicating using LPP, SLPP, embedding SLPP in LPP, or a combination thereof. For example, LMF1 120a and LMF2 120b may embed SLPP in LPP while supporting UEs in subgroups 212 and 214, respectively (e.g. where each SLPP message transferred between a UE and LMF1 120a or LMF2 120b is embedded in one LPP message and where one LPP message may include one or more than one embedded SLPP messages). Similarly, SUPL SLP1 119a and SUPL SLP2 119b may embed SLPP in LPP with LPP messages embedded in SUPL UserPlane Location Protocol (ULP) messages while supporting UEs in subgroups 212 and 214, respectively. Additionally or alternatively, LPP messages and/or SLPP messages may be used, where SLPP messages are not embedded in LPP messages (though LPP messages or SLPP messages may still be embedded in SUPL ULP messages). Additionally, the UEs within each subgroup, and UEs in different subgroups may exchange SLPP messages with one another to support and coordinate SL positioning.

The location server (e.g., LMF/SUPL SLP/Server1/Server2/Server3) support for a particular UE or UEs may not be visible to other UEs in the group. For example, the location server support from the PLMN1 140a for UEs in subgroup 212 may not be visible to UEs in subgroup 214 and may not be visible to the out of coverage UEs in subgroup 216. The support provided by location servers to the UEs may include determination or verification of SL PRS configurations and calculation of location results for UEs, including for UEs that are supported and for UEs that are not supported (e.g. such as calculating location results for UEs within a supported subgroup and for UEs within an unsupported subgroup, e.g. if position information for the UEs in the unsupported subgroup is provided to the location server). In some implementations, signaling between location servers in separate networks may be used to provide more complete network support. As illustrated, LMF-LMF or SUPL SLP-SUPL SLP signaling may use an extension of SLPP (referred to as SLPP** in FIG. 2) to enable more complete network support.

The SLPP message types may align with LPP message types to enable LPP messages to contain embedded SLPP messages and/or to enable SLPP procedures to align with LPP procedures which may reduce implementation and/or testing. FIG. 2 shows signaling (e.g. SLPP messages or SLPP messages embedded in LPP messages) between LMF1 120a and one or more of the UEs of subgroup 212 and signaling between LMF2 120b and one or more of the UEs of subgroup 214. FIG. 2 also shows SLPP messages, or LPP messages that contain embedded SLPP messages, and that are embedded in SUPL ULP messages that are exchanged between SUPL SLP1 119a and one or more of the UEs of subgroup 212 and between SUPL SLP2 119b and one or more of the UEs of subgroup 214. SLPP may include messages that are analogous to an LPP Request Capabilities message and an LPP Provide Capabilities message, which, for example, in SLPP may be called “Request Capabilities and Resources” and “Provide Capabilities and Resources”. The Request/Provide Capabilities and Resources in SLPP may be restricted to NR SL PRS capabilities and resources initially, but may be extended later to capabilities and resources for LTE SL PRS, RTK, Wi-Fi, BT, etc.

In another example, SLPP may include a message that is analogous to an LPP Provide Assistance Data message, which, for example, in SLPP may be called a “Provide Positioning Signal Configuration” (or just a “Provide Assistance Data”). The Provide Positioning Signal Configuration in SLPP may include one or more of, e.g., the SL PRS Configuration to be transmitted by each UE and measured by other UEs, a start time and duration of the transmission, and conditions for termination of the transmission, and the types of SL PRS measurements requested, such as Rx-Tx, AOA, RSRP, RSRD, TOA, TDOA. In some implementations, the Provide Positioning Signal Configuration in SLPP may be extended to define other types of signals, such as RTK signals to be measured, Wi-Fi signal to be transmitted and measured, etc. The Provide Positioning Signal Configuration in SLPP may include additional information, for example, to assist UEs in acquiring and measuring signals (e.g. SL PRS signals) and to determine times of transmission and measurement.

In another example, SLPP may include a message such as a “Confirm Positioning Signal Configuration” (or a “Provide Assistance Data Confirm”), which does not have an analogous LPP message. The Confirm Positioning Signal Configuration in SLPP, for example, may confirm whether a Provide Positioning Signal Configuration (or a Provide Assistance Data) is agreeable. If the Provide Positioning Signal Configuration is (partly) not agreeable, a different configuration may be provided as a Provide Positioning Signal Configuration. Because LPP does not have an analogous message, a new LPP message type may be added to carry the Confirm Positioning Signal Configuration SLPP message in the case that SLPP messages are embedded in LPP messages. However, such a new LPP message type may not be needed when SLPP messages are not embedded in LPP messages.

In another example, SLPP may include a message that is analogous to an LPP Provide Location Information message, which, for example, in SLPP may be called a “Provide Location Information” message. The Provide Location Information message in SLPP may include and provide SL PRS measurements obtained by a UE for SL PRS transmitted by one or more other UEs and/or may include and provide location results obtained for the UE and/or for other UEs. The Provide Location Information in SLPP may be extended to include and provide other measurements, such as measurements of RTK, Wi-Fi, BT, etc.

As illustrated in FIG. 2, UEs within each subgroup and UEs in different subgroups may signal each other using SLPP (e.g. where a UE sends an SLPP message to one or more other UEs). Additionally, location servers (e.g., LMF, SUPL SLP, or Server1-3) may support UEs using SLPP (as discussed above). As previously noted, SLPP may be embedded in LPP or embedded in both LPP and SUPL, or may be sent without embedding in LPP according to some embodiments. Accordingly, a first UE may receive a first SLPP message from a second UE and may send the first SLPP message to a location server that supports the first UE. The first UE may receive a second SLPP message from the location server in response to the first SLPP message and may send the second SLPP message to the second UE.

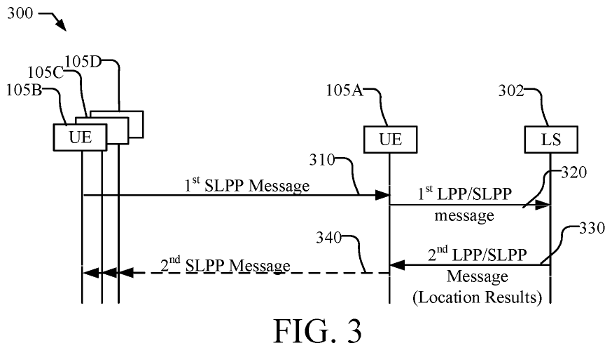

FIG. 3, by way of example, is a signal flow 300 illustrating the signaling between a UE 105A and UEs 105B, 105C, and 105D and a location server 302 for network supported sidelink positioning, as discussed herein. The UEs 105A, 105B, 105C, and 105D, may belong to the same group, and may be, e.g., the UEs 105 illustrated in FIG. 1 or any of the UEs illustrated within network supported subgroups 212 and 214 in FIG. 2. The location server 302 may be any of the LMF 120, SUPL SLP 119, Server 121, or Server 123 shown in FIG. 1 or the LMF1 120a or SUPL SLP1 119a shown in FIG. 2.

As shown in FIG. 3, at 310, the UE 105A receives a first sidelink positioning message from the UE 105B. The first sidelink positioning message, for example, may be an SLPP message, as discussed above, and may be any of the message types discussed above. The first sidelink positioning message may be sent based on SL multicasting (also referred to as SL groupcasting) if the group contains more than two UEs, e.g., as illustrated in FIG. 3, or may be sent based on SL unicasting. With SL multicasting (also referred to as SL groupcasting), a sidelink positioning message (e.g. an SLPP message) may be transmitted containing a group destination address (e.g. which may be partly or completely included in a layer 1 protocol header and/or in a layer 2 protocol header in the sidelink positioning message). A recipient UE (e.g. UE 105A) that belongs to a group which has this group destination address then recognizes the group destination address in the sidelink positioning message and receives, decodes, and processes the sidelink positioning message. With SL unicasting, the sidelink positioning message may be transmitted containing a UE destination address (e.g. a layer 2 address assigned to UE 105A) and is received, decoded, and processed only by the UE (e.g. UE 105A) whose destination address is included.

In 320, the UE 105A sends a first LPP/SLPP message (e.g., a first SLPP message or the first SLPP message embedded in an LPP message, as previously noted) to the location server 302, where the first SLPP message is based on or comprises the first sidelink positioning message.

In 330, the UE 105A receives a second LPP/SLPP message from the location server 302 in response to the first LPP/SLPP message from 320. The second LPP/SLPP message may be a second SLPP message or the second SLPP message embedded in an LPP message, as discussed above, and may be any of the message types discussed above. The second LPP/SLPP message (e.g. the second SLPP message) may include location results for at least one UE in the group (e.g. UE 105A or UE 105B). For example, location results for at least one UE in the group may comprise at least one of a range between the at least one UE and another UE, a direction from the at least one UE to another UE, a location of the at least one UE relative to the location of another UE, a velocity of the at least one UE, a relative velocity of the at least one UE relative to the velocity of another UE, or some combination of these.

In 340, the UE 105A may send a second sidelink positioning message to one or more of the UEs 105B, 105C, and 105D in the group. The second sidelink positioning message may be an SLPP message and may be based on or may comprise the second SLPP message received at 330. The second sidelink positioning message may be sent based on SL multicasting if the group contains more than two UEs, e.g., as illustrated in FIG. 3.

The sidelink positioning messages in signal flow 300 may be any of the message types as discussed above. For example, the first sidelink positioning message at 310 and the first LPP/SLPP message at 320 may include sidelink positioning capabilities, sidelink positioning resources or both for at least one UE in the group, e.g., UE 105B. The first LPP/SLPP message at 320 may include an LPP Provide Capabilities message and/or an SLPP Provide Capabilities message (e.g. where the SLPP Provide Capabilities message may be embedded in the LPP Provide Capabilities message). The second LPP/SLPP message at 330 and the second sidelink positioning message at 340 may include sidelink positioning capabilities, sidelink positioning resources or both for the UE 105A. The second LPP/SLPP message at 330 may include an LPP Provide Capabilities message and/or an SLPP Provide Capabilities message.

In another example, the first sidelink positioning message at 310 and the first LPP/SLPP message at 320 may include an SL Positioning Reference Signal (PRS) configuration for at least one UE in the group, e.g., UE 105A and/or UE 105B. The first LPP/SLPP message at 320 may include an LPP Request Assistance Data message, an LPP Provide Assistance Data message, an SLPP Request Assistance Data message and/or an SLPP Provide Assistance Data message (e.g. where an SLPP message may be embedded in an LPP message of the same type). The second LPP/SLPP message at 330 and the second sidelink positioning message at 340 may include an SL Positioning Reference Signal (PRS) configuration for at least one UE in the group, e.g., UE 105A or UE 105B. The second LPP/SLPP message at 330 may include an LPP Provide Assistance Data message and/or an SLPP Provide Assistance Data message (e.g. where the SLPP Provide Assistance Data message may be embedded in the LPP Provide Assistance Data message).

In another example, the first sidelink positioning message at 310 and the first LPP/SLPP message at 320 may include sidelink positioning measurements obtained by at least one UE in the group, e.g., UE 105B. The first LPP/SLPP message at 320 may include an LPP Provide Location Information message and/or an SLPP Provide Location Information message (e.g. where the SLPP Provide Location Information message may be embedded in the LPP Provide Location Information message). The second LPP/SLPP message at 330 may include the location results for the at least one UE in the group, where the second LPP/SLPP message includes an LPP Provide Location Information message and/or an SLPP Provide Location Information message (e.g. where the SLPP Provide Location Information message may be embedded in the LPP Provide Location Information message).

The location server 302 may be an LMF or a SUPL SLP. If the location server 302 is a SUPL SLP, the first LPP/SLPP message is sent by the UE 105A to the location server 302 at 320 as part of a first SUPL message, and the second LPP/SLPP message is received by the UE 105A at 330 from the location server 302 as part of a second SUPL message. The first SUPL message and the second SUPL message may each include a SUPL POS message.

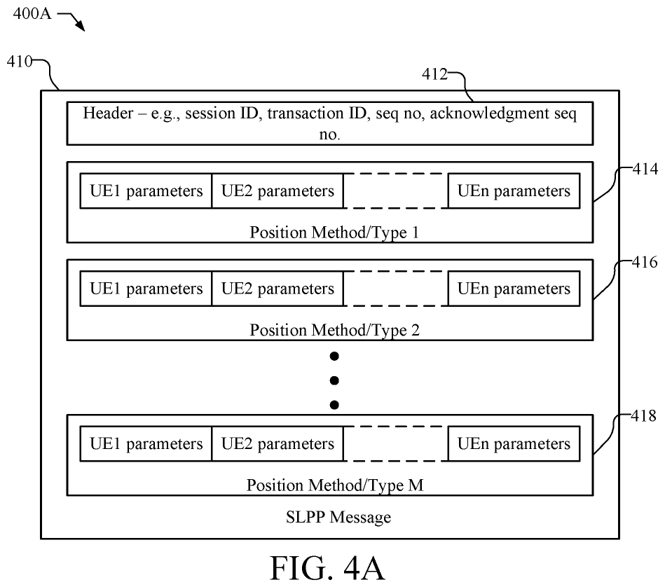

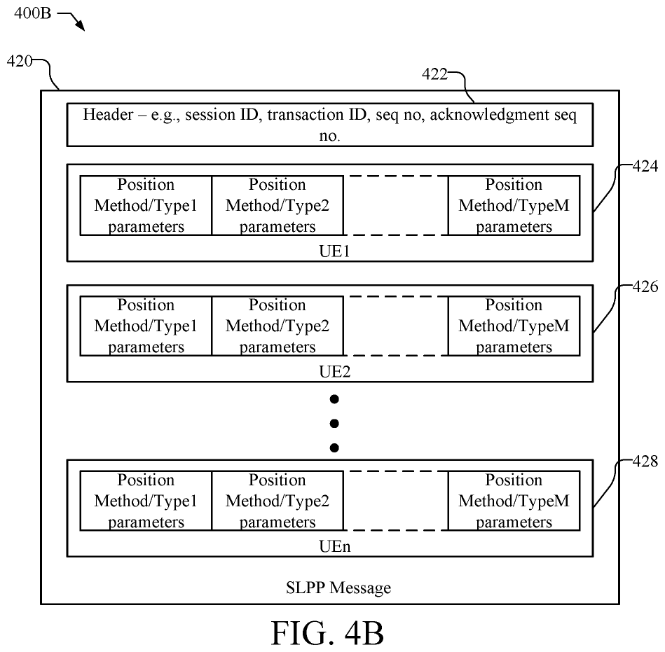

FIG. 4A, by way of example, is a block diagram 400A illustrating one implementation of the structure of an SLPP message 410. As illustrated, the SLPP message 410 includes a header 412, which may include a session ID, a transaction ID, a sequence number (seq no), an acknowledge (or acknowledgment) sequence number (acknowledgment seq no), etc. The SLPP message 410 allows for one or more position methods or position method types. For example, the SLPP message 410 includes, as entries, a position method/type 1 414, a position method/type 2 416, and a position method/type M 418 (e.g. where M could be equal to three or more). A position method, for example, may use a specific signal type or types (e.g., SL NR PRS, SL LTE PRS, Wi-Fi, GPS L1-L5, or any combination thereof) and supports one method of determining location for that specific signal type (e.g. one of RTT, AOA, RSRP, or TDOA). A position method type, on the other hand, uses a specific signal type or types and supports multiple position methods for that signal type or types. For example, a position method type could use SL PRS signals (e.g. either SL NR PRS signals or both SL NR PRS and SL LTE PRS signals) and support multiple position methods that use these SL PRS signals (e.g. could support all of RTT, AOA, RSRP, and TDOA). Another position method type could use GNSS signals and support multiple position methods that use GNSS signals (e.g. could support GNSS code phase based positioning and GNSS carrier phase based positioning such as RTK).

The SLPP message 410 may be configured to support position methods or position method types (also referred to as position types), or both position methods and position method types. As illustrated, each position method/type 414, 416, and 418 in the SLPP message 410 may include parameters for each UE in a group, which are illustrated as being identified by member IDs, e.g. UE1, UE2, UEn. It is possible that not all UEs in a group support the same position methods/types, which could mean that parameters for a UE not supporting a position method/type 414, 416, or 418 might not be present for that position method/type in the SLPP message 410. Support for multiple position methods or position method types in the SLPP message 410 may be advantageous when UEs do not all support the same position methods or same position method types. e.g. where some UEs may support positioning using RTK and SL PRS, while some other UEs only support RTK. In some implementations, however, the SLPP message 410 may provide support for only one position method (e.g. NR SL PRS RTT) or one position method type (e.g., NR SL PRS).

FIG. 4B is a block diagram 400B illustrating another implementation of the structure of an SLPP message 420. Similar to the block diagram 400A of FIG. 4A, the SLPP message 420 includes a header 422, which may include similar information to the header 412 in FIG. 4A. Here, however, data may be structured such that each UE in a group of n UEs has a separate message portion 424, 426, and 428 in the SLPP message 420 that each include parameters for that UE for each position method/type 1-M supported by that UE.

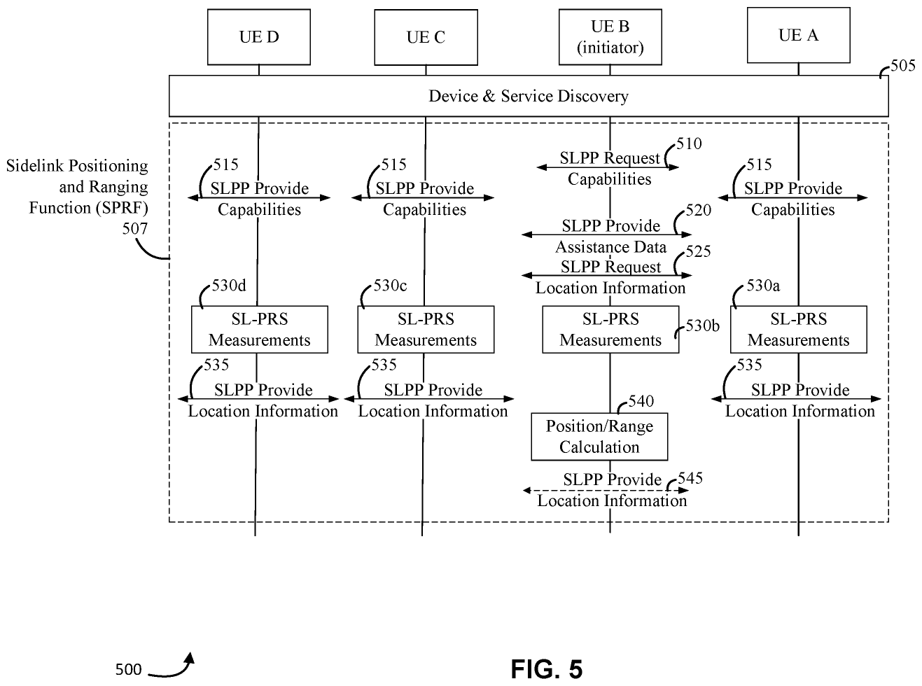

FIG. 5 is a signal flow diagram that shows four UEs (UEs A, B, C, and D) engaged in an SLPP positioning session 500 without support by a location server, such as an LMF. As with other figures provided herein, FIG. 5 is provided as a non-limiting example, and other embodiments may add, omit, and/or rearrange some of the illustrated operations. Here, a device and service discovery process may be conducted, as indicated at block 505, in which UEs may discover each other and/or each UE may determine whether it has network service. In some embodiments, a device and service discovery process (in any of FIGS. 5-10) may be followed by a potential SLPP session establishment (not shown).

After the device and service discovery process, a sidelink positioning and ranging function (SPRF) process 507 may begin in which the initiating UE (UE B in the example of FIG. 5, which may act as a coordinating UE) may broadcast or multicast an SLPP Request Capabilities message, shown by arrow 510, to request the UE positioning capabilities from UEs A, C, and D. As used in the figures herein, double-sided arrows, such as arrow 510) may signify transmissions to a plurality of receiving devices (e.g., from one UE to all other UEs), including broadcast or multicast transmissions. That said, it can be noted that alternative embodiments may similarly transmit messages to each of the plurality of receiving devices using unicast transmissions (e.g., a separate unicast transmission for each receiving device). It is noted that the UE B may be referred to as an “initiating UE”, a “coordinating UE”, an “anchor UE”, a “target UE”, or a “server UE”.

The addressed UEs may then respond by each multicasting (or possibly broadcasting or unicasting) an SLPP Provide Capabilities message including the UE positioning capabilities, as indicated at arrows 515. The UE positioning capabilities of each UE may include details of the supported SL-PRS configurations and supported SL-PRS measurements of the UE. Taking the received UE capabilities into account, UE B may then (in this example) determine SL-PRS configurations that can be broadcast and measured by all the UEs, and multicast an SLPP Provide Assistance Data message, as indicated with arrow 520, distributing the determined SL-PRS configurations to the participating UEs in this session. This may then be followed by UE B sending an SLPP Request Location Information message, as shown by arrow 525, requesting the specific SL-PRS measurement(s) from UEs A, C, and D. Each of the participating UEs (including the initiating UE B in FIG. 5) may then broadcast SL-PRS in accordance with its own SL-PRS configuration (e.g. at different times than SL-PRS transmitted by other UEs) and perform the requested measurements of SL PRS broadcast by other participating UEs, as indicated at blocks 530. For example, at block 530a, UE A may transmit SL-PRS in accordance with its SL-PRS configuration, as well as measure SL-PRS transmitted by UEs B, C, and D, which are transmitted at blocks 530b, 530c, and 530d, respectively. (The other UEs have similar functionality at blocks 530.)

Once the measurements are completed, all UEs (apart from the initiating UE B) may then each multicast (or possibly broadcast or unicast) an SLPP Provide Location Information message, as shown by arrows 535, which the initiating UE B would use to determine ranges and/or positions for the group of UEs, shown at block 540. For example, the position/range calculation at block 540 may include obtaining location results (e.g. relative locations, directions and/or ranges) for the UEs A, B, C and D. In some instances, the initiating UE B may optionally distribute the obtained UE ranges/locations to the other UEs in this group, as shown by dashed arrow 545. (As used herein, dashed arrows may represent optional functionality.) The sending of the final SLPP Provide Location Information message by UE B may be unsolicited by other UEs but may still be allowable according to applicable transaction rules for SLPP.

The procedure in FIG. 5 may be referred to as a centralized UE location or as a “UE-assisted” UE location because one UE (UE B) obtains locations or location information for the other UEs and may then send this to the other UEs.

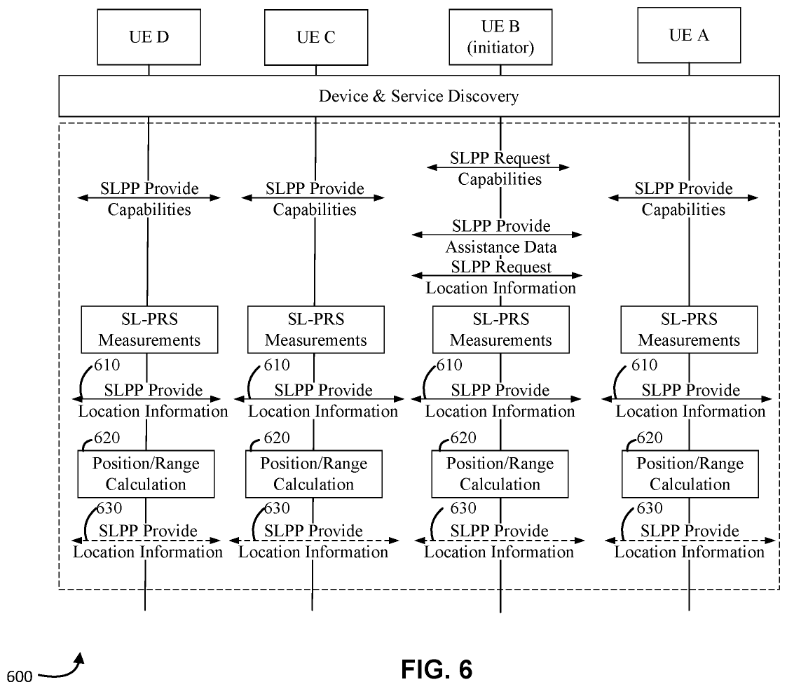

FIG. 6 is a signal flow diagram that shows another example SLPP positioning session 600. Similar to the SLPP positioning session 500 of FIG. 5, UE B is the initiator, and many of the initial operations are the same. In FIG. 6, however, each UE in the group, including initiating UE B, may distribute (e.g., via multicast) its SL-PRS measurements to all other UEs in the group using an SLPP Provide Location Information message, at arrows 610. This can allow each UE in the group to perform the range or position calculation, as indicated at blocks 620. As indicated at arrows 630, each UE then may optionally send the range or position calculation that the UE determined at block 620 to the other UEs in the group.

The procedure in FIG. 6 may be referred to as distributed or decentralized UE location or as “UE-based” UE-location because each UE obtains locations or location information for both itself and for the other UEs and may then send this to the other UEs.

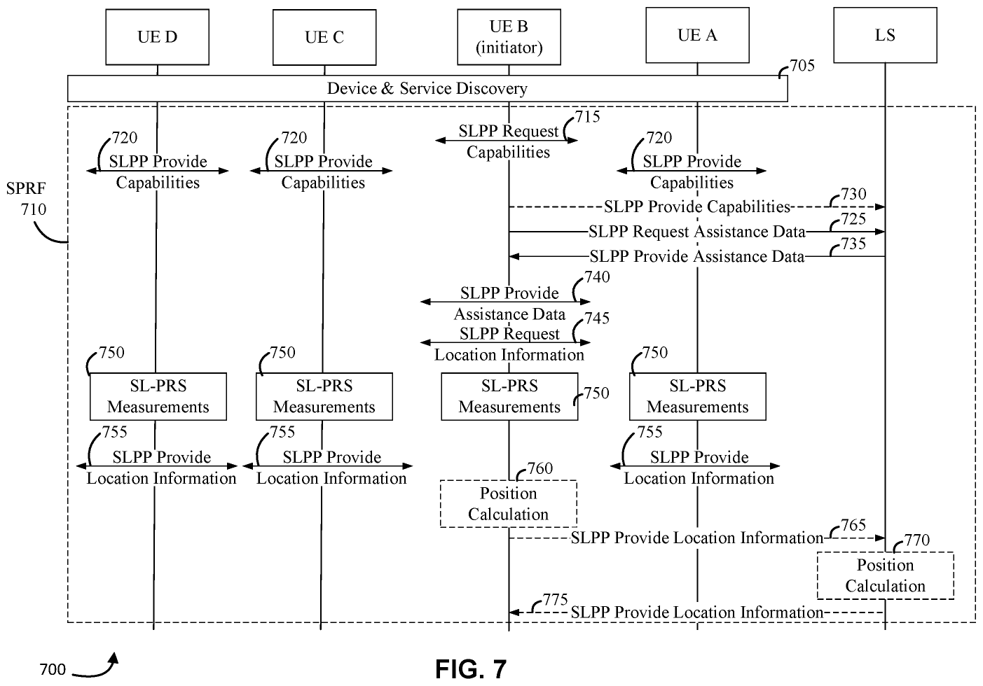

According to some embodiments, two or more UEs may use SLPP with location server support to support ranging and positioning in a network assisted mode. For example, this may be possible when at least one UE is in network coverage and enabled via a subscription to access a PLMN. In this mode, UEs with PLMN access may be assisted to use SLPP by a location server (e.g. an LMF) or may be requested by a location server to employ SLPP to obtain mobile terminal location request (MT-LR) location results. In some instances of this network assisted mode, not all UEs may have PLMN access and be supported by, or provide support to, a location server—e.g. if some UEs are out of coverage. Thus, location server support may be restricted to just some UEs in a group of UEs participating in an SLPP positioning session. FIGS. 7-10, described in more detail hereafter, illustrate methods of how positioning in such a network assisted mode may be performed.

FIG. 7 shows an example SLPP positioning session 700 where the location server (LS) (e.g., LMF) acts as an adjunct to the initiating UE B to assist the UE B to perform sidelink positioning. Similar to the processes in FIGS. 5 and 6, there may be a device and service discovery process, shown at block 705, followed by an SPRF 710. The SPRF 710 may begin with the initiating UE (UE B) multica sting (or broadcasting) an SLPP Request Capabilities message, shown by arrow 715, to request the sidelink positioning capabilities from the other participating UEs, which each respond to the initiating UE (UE B) with an SLPP Provide Capabilities message, shown at arrows 720. The initiating UE B may then request SL-PRS configuration information from an LS via an SLPP Request Assistance Data, indicated by arrow 725, to which the LS may respond with an SLPP Provide Assistance Data message, shown by arrow 735, which may have the SL-PRS configurations for all UEs. In some embodiments, to enable the LS to determine suitable SL-PRS configurations for all UEs, UE B may also provide the obtained SL-PRS capabilities of all UEs in the group to the LS in a SLPP Provide Capabilities message, indicated by optional arrow 730. (As indicated in FIG. 7, this message may precede the SLPP request assistance data message of arrow 725).

The SLPP positioning session 700 may then proceed in a manner similar to the SLPP positioning method 500 of FIG. 5, to distribute assistance data, perform SL-PRS measurements, and distribute location information. In particular, UE B may send the SL-PRS configurations received from the LS to the other UEs in the group within SLPP Provide Assistance Data message, shown by arrow 740, followed by an SLPP Request Location Information message, shown at arrow 745. The transmitting and measuring of SL-PRS measurements at blocks 750 and the sending of the measurement result in SLPP Provide Location Information messages at arrows 755 may be similar to corresponding operations in FIG. 5, previously described. As indicated by the dashed block 760, UE B may perform the range/position calculation using the measurement results received from the other UEs. Alternatively, UE B may provide the obtained location measurements from all UEs in the group to the LS in an SLPP Provide Location Information message, shown at arrow 765, for range/position calculation performed at the LS, shown by block 770. In instances in which the LS performs the range/position calculation, the LS may then provide the computed ranges/positions back to the initiating UE B in an SLPP Provide Location Information message, as shown by arrow 775. The UE B initiated SLPP transactions towards the LS might be part of a location session between UE B and the LS (e.g. imitated by a mobile originated location request (MO-LR) or a new supplementary services operation).

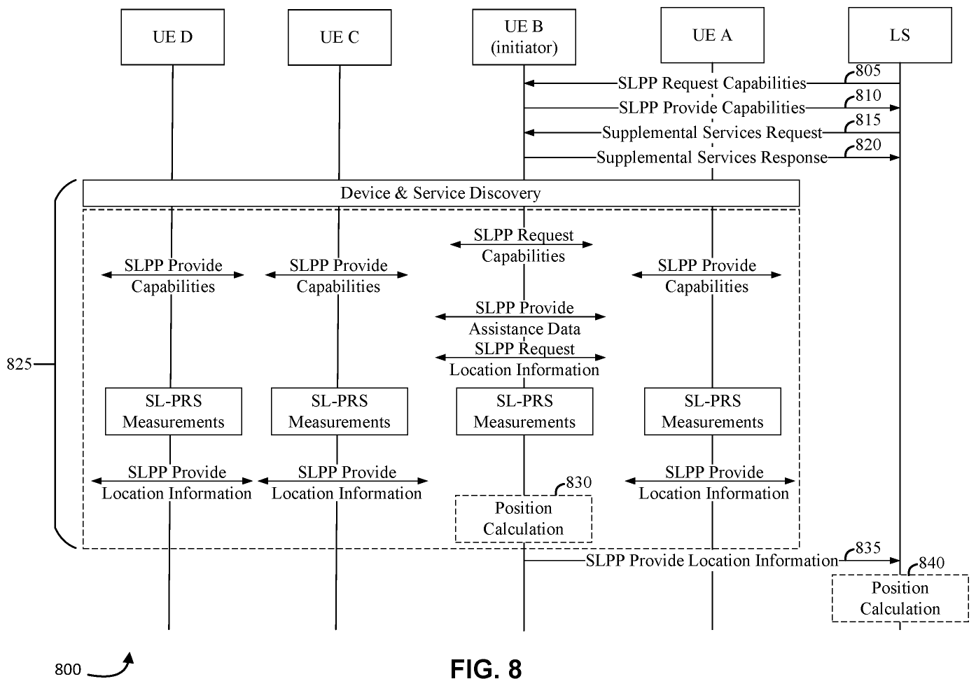

FIG. 8 shows another example SLPP positioning session 800 in network-assisted mode. In this example, the LS initiates a sidelink positioning operation with a coordinating UE (UE B) to obtain mobile terminated location request (MT-LR) location results. In this example, the coordinating UE (UE B) is the UE that coordinates obtaining SL-PRS configurations and reporting measurement results for the group of UEs participating in the SLPP positioning session 800. The LS may request the position of the coordinating UE and/or the position of any UEs (or all UEs) in the group. In some embodiments, the MT-LR that triggers the request from the location server to the coordinating UE may be instigated by an external client or application function (AF) (e.g., external client 130 of FIG. 1) which may provide all necessary information for the MT-LR to the LS (e.g. to the LMF via a GMLC and AMF). The LS may first request the sidelink positioning capabilities of UE B and possibly of other UEs (e.g. UEs A, C, D) from the UE B via SLPP Request Capabilities message, shown by arrow 805, to which the coordinating UE may respond with an SLPP Provide Capabilities message, as shown by arrow 810. The LS may then request location results from the UE B using a supplementary services operation request, indicated by arrow 815. According to some embodiments, the supplementary services operation request may, for example, indicate the type of location results requested (e.g. location of the coordinating UE and/or of one or more of the other UEs), identities and/or addresses of specific other UEs to be involved (e.g. UEs A, C, D) or whether any UEs can be used, whether a single set of location results is requested (immediate location) or whether deferred (e.g. periodic or triggered) location results are requested, or any combination thereof. The supplementary services request may also include an embedded SLPP Request Location Information message indicating specific SLPP location results or measurements to be provided by the coordinating UE and/or an embedded SLPP Provide Assistance Data message to provide assistance data for the SLPP positioning to the coordinating UE (e.g. SL PRS configurations).

According to some embodiments, the reason for using a supplementary services request (at arrow 815) may be to allow inclusion of information like UE addresses and identities and use of immediate versus deferred location which might not be suitable for inclusion in an SLPP message. However, according to some embodiments, it is possible that an SLPP message (e.g. an SLPP Request Location Information) might be used instead. The target UE may then confirm or acknowledge the supplementary services request with a supplementary services response, shown by arrow 820—e.g. which may indicate whether any requested UEs are available (e.g. whether UEs A, C, D have been discovered by the target UE B). The coordinating UE then performs SLPP positioning using the operations of process 825 to obtain measurements and location results without further LS assistance. As can be seen, the operations of the process 825 reflect those in the SLPP positioning session 500 of FIG. 5, as previously described. Alternatively, the coordinating UE may initiate a process that echoes the operations in SLPP positioning session 600 of FIG. 6, as previously described. At the end of the process 825, the coordinating UE may optionally perform the position calculation (shown at block 830), in which case the coordinating UE may then provide the calculation results in an SLPP Provide Location Information message, shown by arrow 835. Otherwise, the coordinating UE can return the measurements to the LS in the SLPP Provide Location Information message at arrow 835, in which case the LS may then determine a location (or range and/or bearing) for the coordinating UE and/or other UEs, as indicated at block 840. In either case, the LS may then provide the location determination to the external client or AF (not shown). For deferred (periodic or triggered) location, the SLPP positioning by the coordinating UE and return of location results to the LS might be repeated.

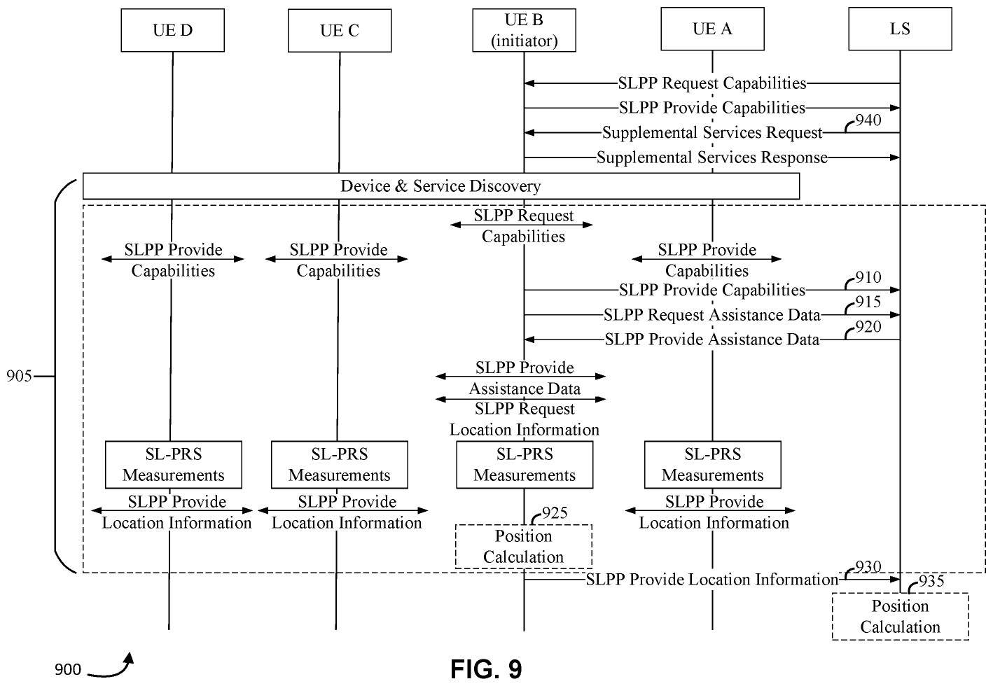

FIG. 9 shows an SLPP positioning session 900 similar to FIG. 8. In FIG. 9, however, the LS actively assists with the SLPP positioning of the four UEs as in FIG. 7. That is, the SLPP positioning session 900 of FIG. 9 may proceed in a manner similar to that of FIG. 8, as previously described. However, in FIG. 9, the process 905 may comprise operations shown by arrows 910, 915, and 920, which may be similar to operations shown by arrows 725, 730, and 735 of FIG. 7, as described above. The position calculation at block 925, SLPP provide Location Information at arrow 930, and/or position calculation at block 935 may be implemented in a manner similar to corresponding steps of FIG. 8, as previously described.

In some embodiments, the LS may indicate to the coordinating UE whether to use the LS for such active assistance. For example, according to some embodiments, the LS might indicate in the supplementary services request (at arrow 940) whether no LS assistance is preferred as in FIG. 8 or whether assistance is preferred (or required) as in FIG. 9.

It can be noted that, although the procedures shown in FIGS. 5-10 are described herein as SLPP positioning “sessions,” embodiments are not so limited. In alternative embodiments, the procedures illustrated in FIGS. 5-10 may not necessarily be conducted within an SLPP positioning session (e.g., with an established session ID, etc.). In some embodiments, some operations of the procedures (e.g., communications between and initiating/coordinating UE and an LS) may be conducted outside an SLPP positioning session, while other operations may be conducted within an SLPP positioning session (e.g., communications between UEs, such as operations within an SPRF).

Depending on desired functionality, embodiments may utilize SL positioning in conjunction with Uu positioning (e.g., with one or more base stations) to provide hybrid Uu and SL positioning.

The system architecture described previously (e.g., with respect to FIGS. 1-9) may support interactions between the UEs (e.g. UE-A and UE C, UE A and UE B, or UE C and UE-D) and between a UE and a 5GC. For the interactions between the UEs, SL signaling and messages for SL positioning and ranging may be carried over a sidelink reference point between pairs of UEs, that is commonly referred to as a PC5 reference point, and with user plane transport, that is then referred to as a PC5-U reference point. Due to different deployment scenarios and operations, the PC5 reference point may utilize different types of access technologies, including LTE based PC5 and NR based PC5 for V2X use, and 5G Proximity-based services (ProSe) based PC5. For example, among V2X capable UEs, control signaling may be carried via LTE PC5 or NR PC5. The control signaling may manage the actual AS layer Sidelink Positioning and Ranging signaling and measurements including SL PRS transmission and measurement. As another example, among 5G ProSe capable UEs, the control signaling for SL positioning and ranging may be carried out over a 5G ProSe PC5 reference point. The control signaling may manage the actual AS layer Sidelink Positioning and Ranging signaling and measurements including SL PRS transmission and measurement.

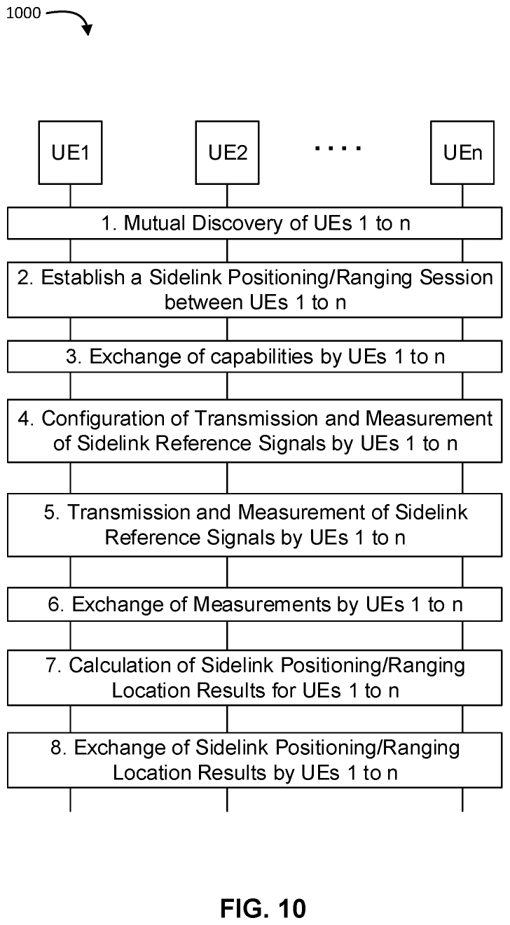

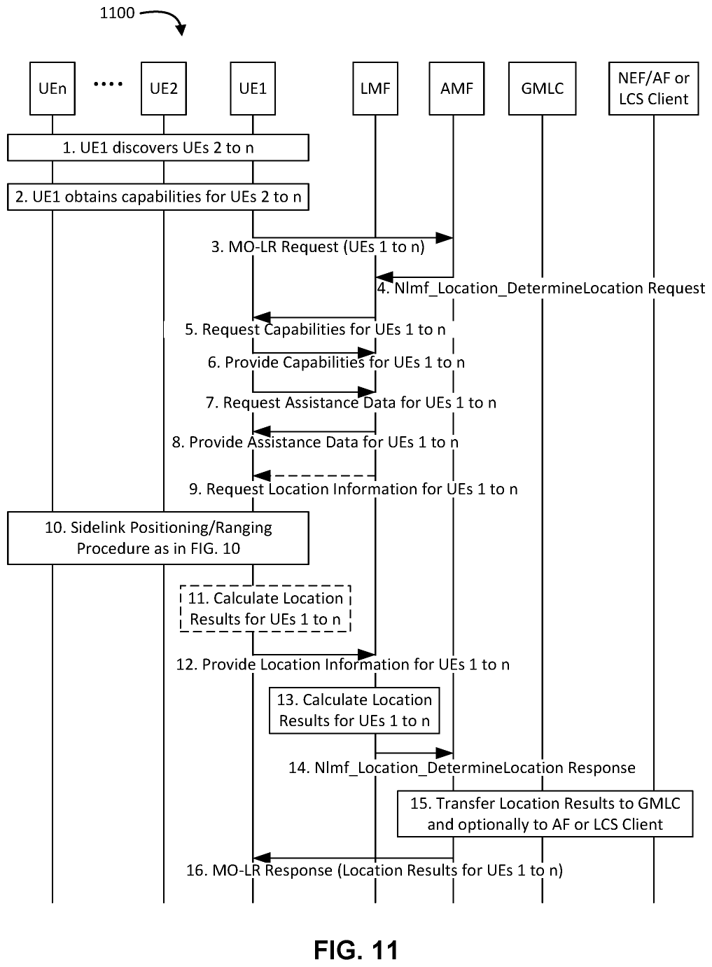

Procedures for performing enhanced sidelink positioning and ranging for n UEs labelled UE1, UE2, UEn, in accordance with embodiments herein are provided below with respect to FIGS. 10-15 and 18. In each of these procedures, one or more of the following can be supported: (i) the LMF only communicates with one UE (UE1) of the n UEs and not with other UEs of the n UEs; (ii) at least one location result is obtained for each of the n UEs; (iii) one UE (UE1) coordinates the sidelink positioning of the of n UEs based on information (e.g. assistance data or a request (e.g. for location measurements or location results)) received from an LMF; (iv) all n UEs are target UEs; and (v) positioning related messages exchanged between the n UEs and between UE1 and the LMF can be SLPP messages unless specified otherwise.

FIG. 10 shows an example of a first enhanced procedure 1000 for sidelink positioning/ranging for a group of n UEs labeled 1 to n, where n≥2 and where there is no LMF assistance (also referred to as “UE-only operation”). In this example, the n UEs may all have network coverage, may have partial network coverage, or may all be out of coverage. The various stages shown in FIG. 10 may be performed as follows:

Stage 1: UEs 1 to n may discover one another. The discovery may or may not be network assisted and may use a Device and Service Discovery Function (DSDF) service in each UE.

Stage 2: A sidelink positioning/ranging session may be established between the UEs 1 to n.

Stage 3: UEs 1 to n may exchange sidelink positioning/ranging capabilities—e.g. using SLPP signaling.

Stage 4: Transmission and measurement of Sidelink Reference Signals may be configured in UEs 1 to n—e.g. by one coordinating UE or in a distributed manner.

Stage 5: Transmission and measurement of Sidelink Reference Signals may be performed by each of UEs 1 to n according to the configurations at step 4.

Stage 6: UEs 1 to n may exchange the sidelink measurements obtained at step 5—e.g. using SLPP signaling.

Stage 7: UEs 1 to n may calculate sidelink positioning/ranging location results from the sidelink measurements obtained at steps 5 and 6. The sidelink positioning/ranging location results may include absolute locations and/or velocities, relative locations and/or velocities, ranges, and/or directions for the UEs 1 to n. The calculation may be distributed over all UEs 1 to n or may be centralized in one UE or in a few UEs.

Stage 8: UEs 1 to n may exchange the sidelink positioning/ranging location results obtained at step 7—e.g. using SLPP signaling. Stages 5-8 or stages 4-8 may be repeated.

A second enhanced procedure for sidelink positioning/ranging may comprise an MO-LR procedure with LMF assistance. In this procedure, sidelink positioning/ranging of a group of two or more UEs that are in network coverage or partial network coverage may be instigated by the UEs themselves and assisted by an LMF using a 5GC-MO-LR procedure with some enhancements. A reason to reuse and enhance the existing 5GC-MO-LR procedure is to reduce new impacts to UEs, 5GCN, LCS Client, and AF.

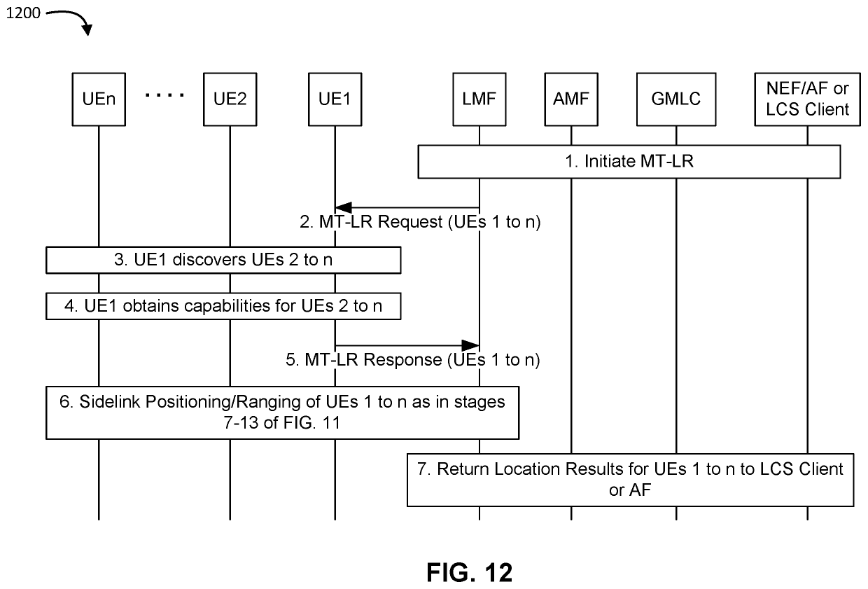

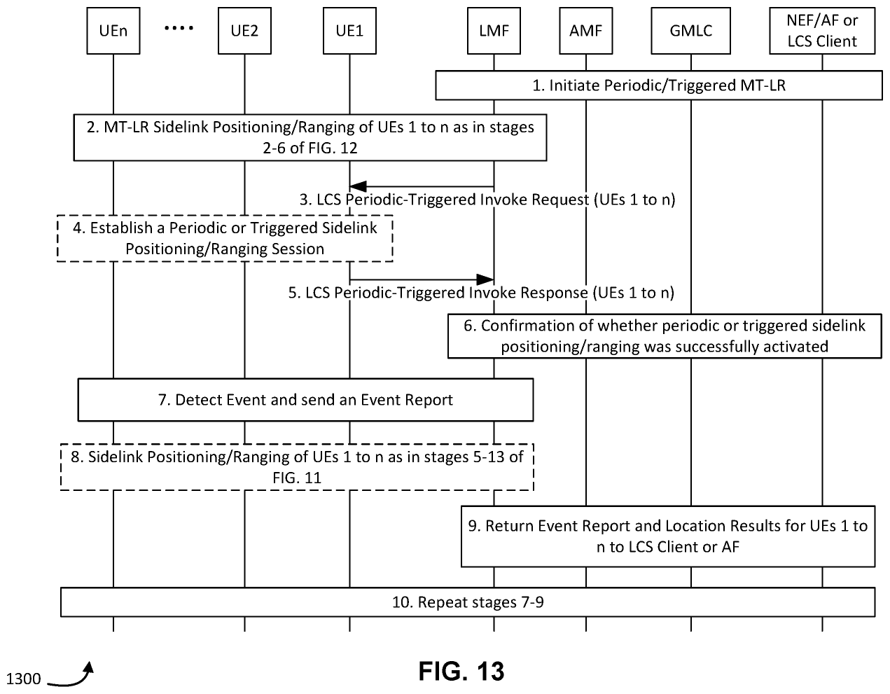

FIG. 11 shows the enhanced MO-LR procedure 1100 applied to n UEs labelled 1 to n, where n≥2. The procedure is invoked by one UE, assumed to be UE1 in FIG. 11. According to this procedure, at least one of the UEs (UE1 in this example) is in network coverage though other UEs may or may not be in coverage. The various stages shown in FIG. 11 may be performed as follows:

Stage 1: UE1 may discover UEs 2 to n. The discovery may or may not be network assisted and may be supported by the DSDF in each UE.

Stage 2: UE1 may obtain the sidelink positioning capabilities of UEs 2 to n—e.g. using SLPP.

Stage 3: UE1 may send a supplementary services MO-LR request to the serving AMF of UE1. The MO-LR request may include a request for sidelink positioning/ranging and indicates the other UEs 2 to n (e.g. by including a local label or an application level address or ID for each of the other UEs 2 to n). The MO-LR Request may indicate whether assistance data from an LMF is requested, whether location calculation assistance from the LMF is requested, and/or whether the sidelink positioning/ranging location results should be transferred to an LCS Client or AF. For transfer to an LCS Client or AF, details of the LCS Client or AF (and possibly of a GMLC) and global identities for all UEs (e.g. application level addresses or IDs or Generic Public Subscription Identifiers (GPSIs)) also may be included. For location calculation assistance from the LMF, the preferred type of sidelink positioning/ranging location results (e.g. absolute locations, relative locations, relative velocities, or ranges/directions between pairs of UEs) may be included and QoS.

Stage 4: The serving AMF may select an LMF (e.g. an LMF that supports sidelink positioning/ranging) and may send an Nlmf_Location_DetermineLocation service operation towards the LMF with the information from the MO-LR Request.

Stage 5: The LMF may send a request (e.g. an SLPP request) to UE1 for the capabilities of all UEs 1 to n. The request may be sent to UE1 via the serving AMF using a signaling connection between UE1 and the serving AMF that was used to send the MO-LR request at stage 3.

Stage 6: UE1 may return its capabilities and the capabilities for UEs 2 to n obtained at stage 2 to the LMF. This stage could occur as part of stage 3—e.g. if an SLPP message carrying the capabilities is embedded in the MO-LR Request. The capabilities may include the SL RATs (e.g. NR, LTE) and SL frequencies supported by each of the UEs 1 to n for sidelink positioning/ranging.

Stage 7: If UE1 indicates assistance data is requested at stage 3, UE1 may send a request for specific assistance data to the LMF. Specific assistance data could include assistance data to enable measurements of SL PRS or other measurements (e.g. for RTK) and/or may include assistance data to enable a UE (e.g. UE1) go calculate location results from location measurements obtained by some or all of the n UEs. As with stage 6, this stage could also occur as part of stage 3—e.g. if an SLPP message indicating the requested assistance data is embedded in the MO-LR Request

Stage 8: If stage 7 occurs, the LMF may return the requested specific assistance data to UE1. The specific assistance data may assist UEs 1 to n to obtain sidelink location measurements and/or may assist UE1 to calculate sidelink positioning/ranging location results. The specific assistance data may be determined by the LMF based on a request for specific assistance data received from UE1 at stage 7 and/or on the capabilities for UEs 1 to n received at stage 6.

Stage 9: If the MO-LR request at stage 3 indicated location calculation assistance is requested and/or indicated transfer of sidelink positioning/ranging location results to an LCS Client or AF, the LMF may send a request for location information to UE 1. The requested location information may comprise SL location measurements and/or SL location results for one or more of UEs 1 to n.

Stage 10: UE1 may instigate a sidelink positioning/ranging procedure among UEs 1 to n, e.g. as in stages 2-6 of FIG. 10. This stage can be supported using any assistance data received at stage 8. As part of this stage, the UEs 1 to n obtain sidelink location measurements of sidelink signals transmitted by other UEs.

Stage 11: If UE1 did not request location calculation assistance from the LMF at stage 3, UE1 may calculate sidelink positioning/ranging location results for itself and possibly for each of the other UEs 2 to n based on the sidelink location measurements obtained at stage 10 and possibly using any assistance data received at stage 8, The sidelink positioning/ranging location results can include absolute locations, relative locations, velocities, directions and/or ranges for one or more of the UEs 1 to n. Some or all of the location calculation might be performed by some or all of the UEs 2 to n with the location results then transferred to UE1.

Stage 12: If UE1 received a request for location information at stage 9, UE1 may send a response to the LMF and includes either the sidelink location measurements obtained at stage 10 or the sidelink positioning/ranging location results obtained at stage 11 if stage 11 occurred. Stage 12 may also be performed when no request for location information was received at stage 9, to indicate to the LMF that the sidelink positioning/ranging procedure was completed among UEs 1 to n and that no further assistance from the LMF is needed. In this case, little or no location information may be included at stage 12.

Stage 13: If stage 12 occurred and if location calculation assistance from the LMF was requested at stage 3, the LMF may calculate sidelink positioning/ranging location results for UEs 1 to n from the sidelink location measurements received at stage 12. The sidelink positioning/ranging location results can include absolute locations, relative locations, velocities, directions or ranges for some or all of the UEs 1 to n.

Stage 14: The LMF may return an Nlmf Location_DetermineLocation service operation response to the AMF and includes any sidelink positioning/ranging location results received at stage 12 or calculated at stage 13.

Stage 15: If sidelink positioning/ranging location results were received at stage 14, the AMF may send the sidelink positioning/ranging location results to a GMLC which may forward these to an AF or LCS Client if this was requested at stage 3. The sidelink positioning/ranging location results may include the global identities for the UEs 2 to n received at stage 3 and the global identity of UE 1. According to some embodiments, sending location results and global identities for UEs 2 to n to an AF or LCS Client may require privacy verification for or from UEs 2 to n and/or from the home PLMMs (HPLMNs) of UEs 2 to n (as well as privacy verification for UE1).

Stage 16: The LMF may return a supplementary services MO-LR response to UE1 and may include any sidelink positioning/ranging location results calculated at stage 13 if stage 13 was performed. UE1 may then transfer any sidelink positioning/ranging location results to UEs 2 to n.

Messages in FIG. 10 that are shown as transferred between the UEs 1 to n may be SLPP messages. Messages in FIG. 10 that are shown as transferred between UE1 and the LMF may be supplementary services messages where this is stated, or otherwise may be either SLPP messages or LPP messages with an SLPP message (or messages) embedded inside each LPP message. This same signaling convention may also be used in FIGS. 11-15 and 18 that are described next.

A third enhanced procedure for sidelink positioning/ranging may comprise an MT-LR procedure with LMF assistance. In this procedure, sidelink positioning/ranging location results for a group of two or more UEs that are in network coverage or partial network coverage may be requested by an LCS Client or AF and assisted by an LMF using a 5GC-MT-LR procedure with some enhancements. A reason to reuse and enhance the existing MT-LR procedure is to reduce new impacts to UEs, SGCN, LCS Client, and

AF.

FIG. 12 shows the enhanced MT-LR procedure 1200 applied to n UEs 1 to n where n≥2. Typically this may require an LCS Client or AF to be aware that UEs 1 to n are or may be nearby to one another. This may be possible in some IIoT scenarios (e.g. factory or warehouse) or when the AF or LCS Client has other information indicating this. At least one of the UEs (UE1 in this example) must be in network coverage though other UEs may or may not be in coverage.

Stage 1: An LCS Client or AF may initiate an MT-LR procedure, by sending a request to a GMLC (which may be an H-GMLC) or to an NEF (not shown in FIG. 12) which can forward the request to the GMLC, with the GMLC then forwarding the request to a serving AMF for UE1, which then forwards the request to an LMF. The LCS Client or AF may include global identities of the n UEs 1 to n (e.g. GPSIs and/or application layer IDs) in the request and may indicate one UE (assumed to be UE1 here) as a principal target UE. If the LCS Client or AF does not indicate a principal target UE that is in network coverage, the GMLC or serving AMF may select a principal target UE from among UEs 1 to n. In some embodiments, the principal target UE should have network coverage and preferably with the PLMN that is serving the LCS Client or AF. The principal target UE later may receive the MT-LR request and coordinate sidelink positioning/ranging among the other UEs. Therefore, in the initiation of the MT-LR procedure, the location request may be sent to the serving AMF of the principal target UE by the GMLC. The MT-LR location request may include the types of sidelink positioning/ranging location results requested (e.g. absolute locations, relative locations, velocities, ranges and/or directions), QoS, and may include conditions for canceling the location request when not all UEs 1 to n can be discovered for positioning. The conditions for canceling the location request may include (i) one or more specific identified UEs cannot be discovered, and/or (ii) the total number of UEs 1-n that are discovered is less than a quorum q, where 1≤q≤n.

According to some embodiments, privacy verification may be performed for all n UEs 1 to n. If all n UEs have the same HPLMN, this can be performed by the GMLC, which would now be an H-GMLC, in the initiation of the MT-LR procedure. If all n UEs are in network coverage and have the same serving AMF, privacy notification/verification for each of the UEs 1 to n (if needed) can be performed by the common serving AMF. If some of the UEs 1 to n have a different HPLMN, are not in network coverage, or have a different serving AMF, some additional support may be used.

Stage 2: The LMF may send a supplementary services MT-LR request to the principal target UE1 and may include the global identities of the other UEs 2 to n, the conditions for canceling the location request when not all UEs 1 to n can be discovered and may include the types of sidelink positioning/ranging location result requested.

Stage 3: UE1 may attempt to discover the other UEs 2 to n if not already discovered. If not all UEs 2 to n are discovered and if the conditions for canceling the location request when not all UEs 1 to n can be discovered are met (e.g., the conditions previously described with regard to stage 1), UE1 may return a negative response at stage 5 and the procedure may terminate after the LMF returns the negative response to the LCS Client or AF via the AMF and GMLC.

Stage 4: UE1 may obtain (e.g. requests and receives) the sidelink positioning capabilities of UEs 2 to n if not already obtained.

Stage 5: UE1 may return a supplementary services MT-LR response to the LMF indicating if the MT-LR request can be supported and which of UEs 2 to n have been discovered and are available for positioning.

Stage 6: Sidelink positioning/ranging of the UEs 1 to n may occur as for an MO-LR as described for stages 7-13 of FIG. 11 with the difference that sidelink positioning/ranging location results may always be obtained and the LMF may indicate to UE1 at stage 8 or stage 9 of FIG. 11 whether the sidelink positioning/ranging location results will be calculated by the LMF or by UE1 (and/or by other UEs).

Stage 7: The LMF may return the sidelink positioning/ranging location results for UEs 1 to n to the LCS Client or AF via the serving AMF and GMLC.

A fourth enhanced procedure for sidelink positioning/ranging may comprise a periodic or triggered MT-LR procedure with LMF assistance. In this procedure, sidelink positioning/ranging results for a group of two or more UEs that are in network coverage or partial network coverage may be requested periodically or when certain trigger events occur by an LCS Client or AF and may be assisted by an LMF using a periodic or triggered 5GC-MT-LR procedure with some enhancements. A reason to reuse and enhance the existing periodic or triggered MT-LR procedure may be to reduce new impacts to UEs, 5GCN and LCS Client and AF.

FIG. 13 shows the enhanced periodic or triggered MT-LR procedure 1300 applied to n UEs 1 to n where n≥2. Typically this may require the LCS Client or AF to be aware that UEs 1 to n are or may be nearby to one another over the whole duration of location reporting. This may be possible in some IIoT scenarios (e.g. factory or warehouse) or when the AF or LCS Client has other information indicating this, for example. At least one the UEs (UE1 in this example) must be in network coverage though other UEs may or may not be in coverage.

Stage 1: An LCS Client or AF may initiate a periodic or triggered MT-LR procedure, by sending a request to a GMLC (which may be an H-GMLC) or to an NEF (not shown in FIG. 13) which can forward the request to the GMLC, with the GMLC then forwarding the request to a serving AMF for UE1, which then forwards the request to an LMF. The LCS Client or AF may include additional information in the location request as described for stage 1 of FIG. 12. A principal target UE (UE1 here) also may be selected as described for stage 1 of FIG. 12. For triggered location reporting, different trigger events may be supported. Some examples of different trigger events are as follows: (i) area event trigger where any one UE (or all UEs) enters an area, remains in an area or leaves an area; (ii) an area event trigger where a single combined position for all n UEs 1 to n (e.g. an averaged position that may be a centroid or “center of gravity” of the n separate positions of the n UEs) enters an area, remains in an area or leaves an area; (iii) motion event trigger where any one UE (or all UEs) moves by more than a threshold distance from a previous position; (iv) a motion event trigger where a single combined position for all n UEs 1 to n (e.g. an averaged position that may be a centroid or “center of gravity” of the n separate positions of the n UEs) moves by more than a threshold distance; and (v) range trigger where a particular type of range rises above a threshold, falls below a threshold and/or increases or decreases by more than a threshold amount. The particular type of range in (v) could be the maximum range of all ranges between all pairs of the UEs 1 to n, the minimum range of all ranges between all pairs of the UEs 1 to n, the minimum range between any UE and each of the other n−1 UEs (there are n minimum ranges corresponding to the n UEs and the trigger occurs when any of the n minimum ranges crosses a threshold), an average range between all pairs of UEs, or the maximum range between any UE and each of the other n−1 UEs (there are n maximum ranges corresponding to the n UEs and the trigger occurs when any of the n maximum ranges crosses a threshold).

It can be noted that privacy verification may be supported in the procedure 1300 in the manner described above with respect to procedure 1200 of FIG. 12.

Stage 2: The LMF may instigate MT-LR sidelink positioning/ranging of the UEs 1 to n as in stages 2-6 of FIG. 12. The LMF may verify whether the conditions are met for canceling the location request when not all UEs 1 to n are discovered (in which case the location request is cancelled by the LMF) and may obtain the capabilities of the UEs 1 to n but may not always obtain immediate sidelink positioning/ranging location results.

Stage 3: The LMF may send a supplementary services LCS Periodic-Triggered Invoke Request to UE1 and includes the event trigger(s) provided in stage 1, the global IDs of the UEs 2 to n, and indicates sidelink positioning/ranging of the UEs 1 to n.

Stage 4: UE1 may establish a periodic or triggered sidelink positioning session with UEs 2 to n, which can enable UEs 2 to n to participate in detecting trigger events for stage 7 (e.g. events which affect some or all of UEs 2 to n) and speed up sidelink positioning/ranging at stage 8 by configuring UEs 2 to n in advance.

Stage 5: UE1 may return an LCS Periodic-Triggered Invoke Response to the LMF as and may indicate which of UEs 2 to n can support the periodic or triggered sidelink positioning/ranging.

Stage 6: The LMF may send a confirmation of whether periodic or triggered sidelink positioning/ranging was successfully activated in UE1 (and UEs 2 to n) to the LCS Client or AF via the GMLC only or via the serving AMF and GMLC.

Stage 7: UE1 may wait for an event to be detected (e.g. by UE1 or by one of the others UEs 2 to n), may obtain sidelink positioning/ranging measurements and possibly calculate sidelink positioning/ranging location results, and may then send a supplementary services event report to the LMF, and may receive back an event report acknowledgement from the LMF. Here, detection of an event by UE1 may depend on detecting an event related to one or more of UEs 1 to n, and any sidelink positioning/ranging measurement and calculation of location results may require interaction between UEs 1 to n (e.g. using SLPP).

Stage 8: If sidelink positioning/ranging location results for UEs 1 to n are requested and were not provided to the LMF as part of stage 7, the LMF may perform sidelink positioning/ranging of UEs 1 to n, e.g. as in stages 5-13 of FIG. 11.

Stage 9: The LMF may send an event report to the LCS Client or AF (e.g. via the GMLC) and may include any sidelink positioning/ranging location results obtained at stage 7 or stage 8. If sidelink positioning/ranging location results are provided by the LMF for only some of UEs 1 to n (e.g. in several successive event reports), the GMLC or LCS Client or AF may cancel the periodic or triggered sidelink positioning/ranging.

Stage 10: Stages 7-9 may be repeated until the periodic or triggered sidelink positioning/ranging is canceled or has attained a maximum duration or a maximum number of event reports.

A fifth enhanced procedure for sidelink positioning/ranging may comprise an SL-MO-LR procedure for ranging between target UEs with LMF assistance. This procedure can enable a UE to request assistance from an LMF to obtain Sidelink Positioning/Ranging location information for itself and one or more other target UEs. The procedure can be similar to the MO-LR procedure shown in FIG. 11 but with some differences and extra details.

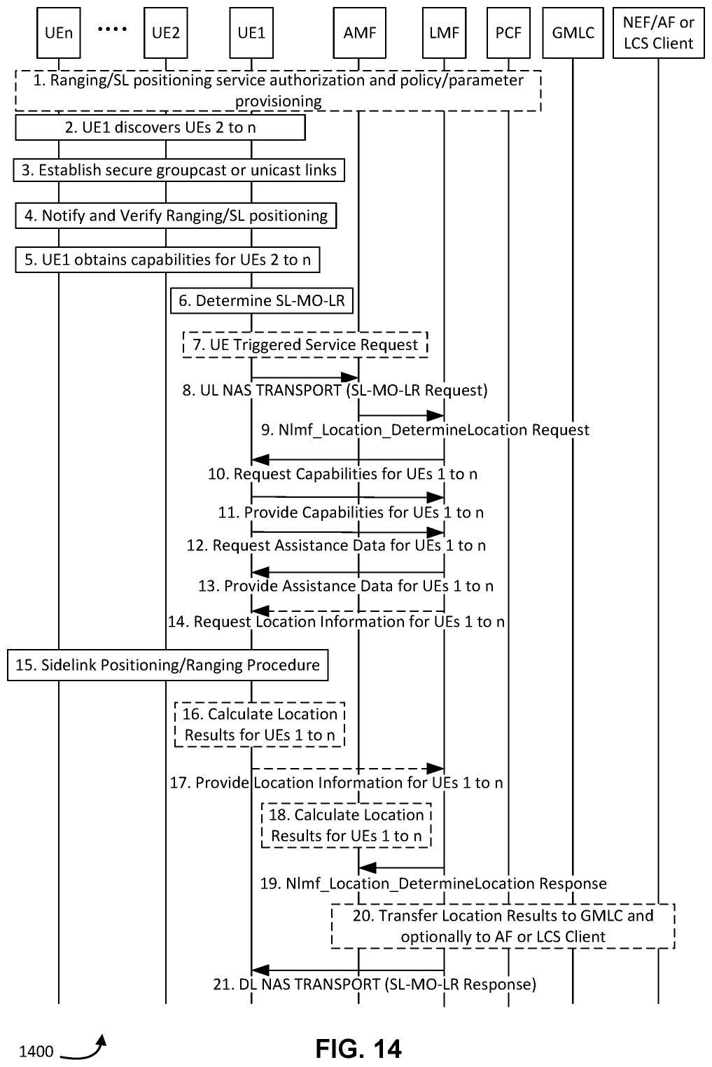

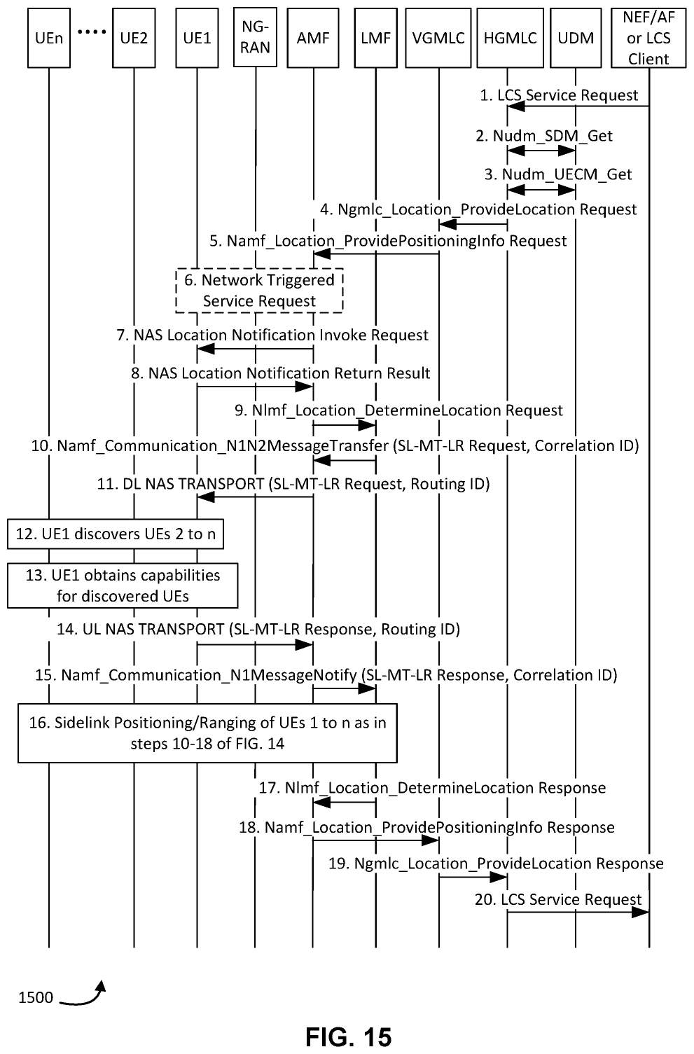

FIG. 14 illustrates the SL-MO-LR procedure 1400 to enable a UE, designated UE1, to obtain sidelink positioning/ranging location results for the UE1 and one or more other UEs designated UE2, UE3, UEn with the assistance of an LMF in a serving PLMN for UE1. The sidelink positioning/ranging location results may include absolute locations, relative locations, velocities or ranges and directions between pairs of UEs. According to this disclosure, embodiments may utilize any combination of the operations described in stages 1-21 of FIG. 14, described below.

As a precondition for the fifth enhanced procedure of FIG. 14, UE1 may be in coverage and registered with a serving PLMN. UEs 2 to n may or may not be in coverage and, if in coverage, may or may not be registered with the same serving PLMN as UE1.

Stage 1: The procedures and signaling specified for ProSe or for V2X may be used (e.g. by a PCF or serving AMF) to provision the Ranging/SL positioning service authorization and policy/parameter provisioning to UE1 and one or more of UEs 2 to n.

Stage 2: UE1 may discover UEs 2 to n. In some embodiments, discovery may use Direct Discovery. UE1 may further receive (from the UEs 2 to n) application layer IDs and/or global IDs (e.g. GPSIs) for the UEs to n when discovering the UEs 2 to n.

Stage 3: Secure groupcast and/or unicast links may be established between UEs 1 to n to enable UE1 to exchange sidelink positioning messages over PC5-U with each of UEs 2 to n and possibly enable UEs 2 to n to exchange sidelink positioning messages over PC5-U between each other.

Stage 4: UE1 may notify UEs 2 to n, using the groupcast and/or unicast links established in stage 3, of an intent to perform Ranging/SL positioning of UEs 2 to n. Each of UEs 2 to n verifies that Ranging/SL positioning may be permitted, including whether Ranging/SL positioning results may be transferred to an LCS Client or AF if this is used, according to any service authorization and policy/parameter provisioning received at stage 1. Quality of Service (QoS) requirements for the Ranging/SL positioning also may be agreed.

Stage 5: UE1 may obtain the sidelink positioning capabilities of UEs 2 to n using the groupcast and/or unicast links established in stage 3.

Stage 6: Based on the sidelink positioning capabilities of UE1, the sidelink positioning capabilities of UEs 2 to n received in stage 5, the QoS requirements agreed in stage 4, the Ranging/SL positioning service authorization and policies/parameters received in stage 1, and whether location results are to be transferred to an LCS Client or AF, UE1 may determine whether assistance for sidelink positioning/ranging of the UEs 1 to n should be obtained from an LMF. If so, stages 7-21 may be performed. Otherwise, UE1 may perform only stages 15 and 16 without LMF assistance.

Stage 7: If UE1 is in a CM-IDLE state, UE1 may instigate a UE triggered Service Request in order to establish a signaling connection with the serving AMF of UE 1.

Stage 8: UE1 may send a supplementary services SL-MO-LR request to the serving AMF of UE1 in a UL NAS TRANSPORT message. The SL-MO-LR request may indicate the other UEs 2 to n (using local or global identities), indicate any assistance data requested, may indicate whether location calculation assistance from an LMF is requested, and may indicate whether location results should be transferred to an LCS client or AF. For transfer to an LCS Client or AF, details (e.g. addresses) of the LCS Client or AF (and possibly of a GMLC) and global identities for all UEs also may be included. For location calculation assistance from the LMF, the preferred type of sidelink positioning/ranging location results (e.g. absolute locations, relative locations, velocities, or ranges and directions between pairs of UEs) may be included and QoS.

Stage 9: The serving AMF may select an LMF (e.g. an LMF that supports sidelink positioning/ranging) and sends an Nlmf_Location_DetermineLocation service operation towards the LMF with the information from the SL-MO-LR Request.

Stage 10: The LMF may send a request to UE1 for the capabilities of all UEs 1 to n.

Stage 11: UE1 may return its capabilities and the capabilities for UEs 2 to n obtained at stage 5 to the LMF.

Stage 12: If UE1 indicates assistance data is requested at stage 8, UE1 may send a request for specific assistance data to the LMF. Specific assistance data could include assistance data to enable measurements of SL PRS or other measurements (e.g. for RTK) and/or may include assistance data to enable a UE (e.g. UE1) to calculate location results from location measurements obtained by some or all of the n UEs.

According to some embodiments, stages 10 and 11 can be included as part of stage 8 if UE1 includes a message containing the capabilities of UEs 1 to n in the SL-MO-LR request at stage 8. Stage 12 can be included as part of stage 8 if UE1 includes a message containing the request for specific assistance data in the SL-MO-LR request at stage 8.

Stage 13: If stage 12 occurs, the LMF may return the requested specific assistance data to UE1. The specific assistance data may assist UEs 1 to n to obtain sidelink location measurements at stage 15 and/or may assist UE1 to calculate sidelink positioning/ranging location results at stage 16.

Stage 14: If the MO-LR request at stage 8 indicated location calculation assistance is requested and/or indicated transfer of sidelink positioning/ranging location results to an LCS Client or AF, the LMF may send a request for location information to UE 1.

Stage 15: UE1 may instigate a sidelink positioning/ranging procedure among UEs 1 to n in which UEs 1 to n obtain sidelink location measurements and UEs 2 to n transfer their sidelink location measurements to UE 1. For example, this may occur as described for stages 4 to 6 of FIG. 10.

Stage 16: If UE1 did not request location calculation assistance from the LMF at stage 8, UE1 may calculate sidelink positioning/ranging location results for itself and for each of UEs 2 to n based on the sidelink location measurements obtained at stage 15 and possibly using assistance data received at stage 13. The sidelink positioning/ranging location results can include absolute locations, relative locations, velocities, or ranges and directions between pairs of the UEs 1 to n. According to some embodiments, some or all of UEs 2 to n may calculate location results as part of stage 15 and transfer these results to UE1 to assist stage 16.

Stage 17: If UE1 received a request for location information at stage 14, UE1 may send a response to the LMF and includes either the sidelink location measurements obtained at stage 15 or the sidelink positioning/ranging location results obtained at stage 16 if stage 16 was performed. Stage 17 may also be performed when no request for location information was received at stage 14, to indicate to the LMF that the sidelink positioning/ranging procedure was completed among UEs 1 to n and that no further assistance from the LMF is needed. In this case, little or no location information may be included by UE1 at stage 17.

Stage 18: If stage 17 occurred and if location calculation assistance from the LMF was requested at stage 8, the LMF may calculate sidelink positioning/ranging location results for UEs 1 to n from the sidelink location measurements received at stage 17. The sidelink positioning/ranging location results can include absolute locations, relative locations, velocities or ranges, and directions between pairs of the UEs 1 to n.

Stage 19: The LMF may return an Nlmf_Location_DetermineLocation service operation response to the AMF and may include any sidelink positioning/ranging location results received at stage 17 or calculated at stage 18.

Stage 20: If sidelink positioning/ranging location results were received at stage 19, the AMF may send the sidelink positioning/ranging location results to the GMLC and to an AF or LCS Client if this was requested at stage 8. The sidelink positioning/ranging location results may include the global identities for UEs 1 to n received at stage 8. According to some embodiments, sending location results and global identities for UEs 1 to n to an AF or LCS Client may involve privacy verification from UEs 1 to n and/or from the HPLMNs of UEs 1 to n.

Stage 21: The LMF may return a supplementary services SL-MO-LR response to UE1 in a DL NAS TRANSPORT message and may include any sidelink positioning/ranging location results calculated at stage 18 if stage 18 was performed. UE1 may then transfer any sidelink positioning/ranging location results to UEs 2 to n.

A sixth enhanced procedure for sidelink positioning/ranging may comprise an SL-MT-LR procedure for ranging between target UEs. This procedure can enable an LCS Client or AF to request and obtain Sidelink Positioning/Ranging location information for two or more target UEs.

FIG. 15 illustrates the SL-MT-LR procedure 1500 to enable an LCS Client or AF to obtain sidelink positioning/ranging location results for a group of n UEs (n≥2) UE1, UE2, UEn. The sidelink positioning/ranging location results may include absolute locations, relative locations, velocities, or ranges and directions between pairs of UEs. According to this disclosure, embodiments may utilize any combination of the operations described in stages 1-20 of FIG. 15, described below.

According to some embodiments, as a precondition for the sixth enhanced procedure of FIG. 15, at least one of the n target UEs (assumed to be UE1 here) may be in coverage and registered with a serving PLMN.

Stage 1: The LCS Client or the AF (via a Network Exposure Function (NEF)) may send an LCS service request to the (H)GMLC for sidelink positioning/ranging location results for the n target UEs which may each be identified by a GPSI and/or a SUPI. The request may include the required QoS, the required location results (e.g. absolute locations, relative locations, velocities or ranges and directions between pairs of UEs), and other attributes. The (H)GMLC or NEF may authorize the LCS Client or the AF for the usage of the LCS service. If the authorization fails, the remaining stages may be skipped and the (H)GMLC or NEF responds to the LCS Client or the AF with the failure of the service authorization. In some cases, the (H)GMLC may derive at least some of the GPSIs and/or SUPIs of the n target UEs and possibly the QoS from others of the GPSIs and/or SUPIs that are provided by the LCS Client or AF, or from subscription data in or accessible to the (H)GMLC, or from other data supplied by the LCS Client or AF.

A preferred ordering for the n target UEs may be indicated by the LCS Client or the AF to assist in determination of a principal target UE at stage 3. The (H)GMLC may modify any preferred ordering provided by the LCS Client or AF. For example, the (H)GMLC may prioritize a UE for which the PLMN of the (H)GMLC is the home PLMN (HPLMN) of the UE. In addition, an Application Layer ID may be included for each of the n target UEs to enable discovery of the UEs at stage 12. The request also may include conditions for canceling the location request when not all n target UEs can be discovered for positioning. The conditions for canceling the location request may include: (i) one or more specific target UEs cannot be discovered; and/or (ii) the total number of target UEs that are discovered is less than a quorum q, where 2≤q≤n.

The LCS Client or AF may determine before stage 1 that the n target UEs are all in proximity to one another and may obtain their Application Layer IDs and/or global IDs. For example, one or more of the n target UEs may be in communication with the LCS Client or AF (e.g. using an application protocol such as the Hypertext Transfer Protocol (HTTP) or HTTP Secure (HTTPS)) and may provide the LCS Client or AF with the Application layer IDs and/or global IDs of all n target UEs, an approximate (coarse) relative or absolute location of each of the n target UEs and/or may indicate whether the n target UEs have performed mutual discovery (e.g. where one target UE has discovered the other n−1 target UEs). This may enable the LCS Client or AF to provide the LCS service request at stage 1 and to know in advance that the n target UEs are in proximity to one another.

Stage 2: The (H)GMLC may invoke a Nudm_SDM_Get service operation towards the UDM of each of the n target UEs to get the privacy settings of the UE identified by its GPSI or SUPI. The UDM may return the target UE Privacy setting of the UE. The (H)GMLC may check the UE LCS privacy profile. If any of the n target UEs are not allowed to be located, stages 3-19 may be skipped.

Stage 3: The (H)GMLC may invoke a Nudm_UECM_Get service operation towards the UDM of each of the n target UEs (which may be in a different PLMN if a UE is roaming), one at a time and possibly in turn according to the preferred ordering in stage 1 (if this was included) and including a GPSI or SUPI of each UE being queried in the service operation for that UE. If any target UE is in coverage and has registered with a serving PLMN, the UDM may return the network address of the current serving AMF and additionally the address of a visited GMLC (V-GMLC) for a UE that is roaming. The (H)GMLC may stop the Nudm_UECM_Get service operations towards the UDM(s) as soon as a UDM returns either serving PLMN and AMF information for one of the n target UEs or serving PLMN and AMF information for one of the n target UEs that show that the one of the target UEs is served by the PLMN of the (H)GMLC. This one UE may be treated as the principal target UE and may be treated as being UE1 here. According to some embodiments, the UDM may be aware of the serving AMF address at UE registration with an AMF, and/or a serving V-GMLC address at UE registration with an AMF.

Stage 4: For a non-roaming case, this stage may be skipped. In the case of roaming, the (H)GMLC may receive an address of a V-GMLC (together with the network address of the current serving AMF) from the UDM in stage 3; otherwise, the (H)GMLC may use a Network Repository Function (NRF) to select an available V-GMLC in the VPLMN that is serving the UE, based on the VPLMN identification contained in the AMF address received in stage 3. The (H)GMLC then may send the location request to the V-GMLC by invoking the Ngmlc_Location_ProvideLocation service operation towards the V-GMLC. In the cases when the (H)GMLC did not receive the address of the V-GMLC, or when the V-GMLC address is the same as the (H)GMLC address, or when both PLMN operators agree, the (H)GMLC may send the location service request message to the serving AMF. In this case, stage 4 may be skipped. The (H)GMLC also may provide the LCS client type of the AF, if received in stage 1, or the LCS client type of the LCS client, and other attributes to be sent to the AMF at stage 5.

Stage 5: In the case of roaming, the V-GMLC may first authorize that the location request is allowed from this (H)GMLC, PLMN, or from this country. If not, an error response may be returned. The (H)GMLC or V-GMLC may invoke the Namf_Location_ProvidePositioningInfo service operation towards the AMF to request sidelink positioning/ranging location results of the n target UEs. The service operation may include the SUPI of UE1, the Application layer IDs of the n UEs, and the client type, and may further include the required LCS QoS, the required location results (e.g. absolute locations, relative locations, velocities or ranges and directions between pairs of UEs), and other attributes as received or determined in stage 1. According to some embodiments, the location request forwarded at stage 4 and stage 5 may also carry the result of the privacy check in stage 2 and an indication of a privacy related action.

Stage 6: If UE1 is in a Connection Management (CM) IDLE state, the AMF may initiate a network triggered Service Request procedure to establish a signaling connection with UE1.

If signaling connection establishment fails, stages 7-17 may be skipped.

Stage 7: If an indicator of privacy check related action indicates that UE1 may either be notified or notified with privacy verification and if UE1 supports LCS notification (e.g. according to UE capability information provided to the AMF by UE1), a notification invoke message may be sent to UE1 by the serving AMF, indicating the identity of the LCS client, the type of location request, and whether privacy verification may be required.

Stage 8: If stage 7 has occurred, UE1 may notify the user of UE1 of the location request and, if privacy verification was requested, may wait for the user to grant or withhold permission. UE1 then may return a notification result to the AMF indicating, if privacy verification was requested, whether permission is granted or denied for the LCS request. If the user does not respond after a predetermined time period, the AMF may infer a “no response” condition. The AMF may return an error response in stage 18, and if roaming the V-GMLC may forward in stage 19, to the (H)GMLC if privacy verification was requested and either the UE1 user denies permission or there is no response with the indication received from the (H)GMLC indicating barring of the location request and stages 9-17 are skipped. According to some embodiments, a notification or a privacy check may be performed (as at stages 7 and 8) for some or all of the other target UEs 2 to n by the AMF, e.g. if some or all of other target UEs have the same serving AMF as UE1. For other UEs that are out of network coverage or have a different serving PLMN or a different serving AMF to UE1, the AMF may send a notification invoke message to each UE via UE1 (which may act as a relay), and UE 1 may return (e.g. relay) a notification result from each UE to the AMF. Alternatively, privacy verification by UE1 might be possible on behalf of all UEs (e.g. if all n target UEs belong to a common organization).

Stage 9: The serving AMF may select an LMF (e.g. an LMF that supports sidelink positioning/ranging) and sends an Nlmf_Location_DetermineLocation service operation towards the LMF with the information received at stage 5.

Stage 10: The LMF may send an SL-MT-LR request to the serving AMF as a supplementary services message, using the Namf_Communication_N1N2MessageTransfer service operation, and a Correlation ID identifying the LMF or the location request (e.g. where the correlation ID may have been assigned by the AMF and sent to the LMF at stage 9). The SL-MR-LR request may include the application layer IDs of the other UEs 2 to n, the conditions for canceling the location request when not all UEs 2 to n can be discovered, and the types of sidelink positioning/ranging location results requested.

Stage 11: The serving AMF may forward the SL-MT-LR request and a Routing ID equal to the Correlation ID to UE1 using a DL NAS TRANSPORT message.

Stage 12: UE1 may attempt to discover the other UEs 2 to n using their application layer IDs and if not already discovered. If not all UEs 2 to n are discovered and if the conditions for canceling the location request when not all n target UEs can be discovered are met, UE1 may return a negative response at stage 14 and the procedure may terminate after the LMF returns a negative response to the LCS Client or AF via the AMF and GMLC(s).

Stage 13: UE1 may obtain (e.g. request and receive) the sidelink positioning capabilities of the discovered target UEs if not already obtained.

Stage 14: UE1 may return a supplementary services SL-MT-LR response to the serving AMF in a UL NAS TRANSPORT message and includes the Routing ID received in stage 11. The SL-MT-LR response may indicate if the SL-MT-LR request can be supported and which of UEs 2 to n have been discovered and are available for positioning.

Stage 15: The serving AMF may forward the SL-MT-LR response to the LMF indicated by the Routing ID received at stage 14 and may include a Correlation ID equal to the Routing ID.

Stage 16: Sidelink positioning/ranging of UE1 and the other discovered target UEs may occur as for an SL-MO-LR as described for stages 10-18 of FIG. 14 with the difference that sidelink positioning/ranging location results may always be obtained and the LMF indicates to UE1 at stage 13 or stage 14 of FIG. 14 whether the sidelink positioning/ranging location results will be calculated by the LMF (at stage 18 of FIG. 14) or by UE1 (at stage 16 of FIG. 14).

Stages 17-20: The LMF may return the sidelink positioning/ranging location results to the LCS Client or AF via the serving AMF, V-GMLC (if included), (H)GLMC and, in the case of an AF, an NEF.

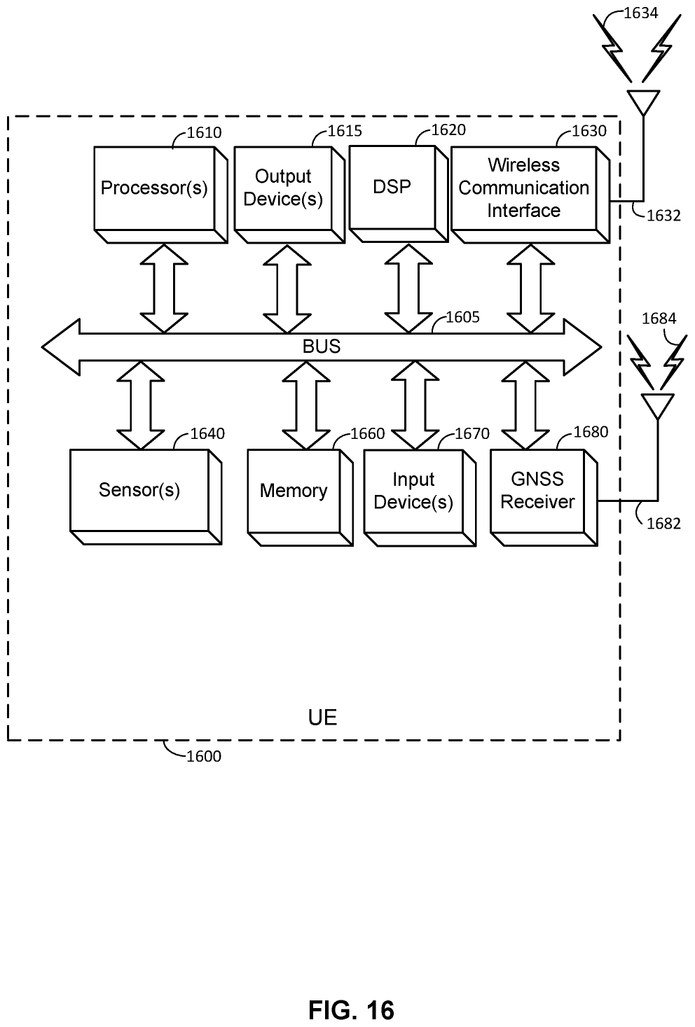

FIG. 16 is a block diagram of an embodiment of a UE 1600 (e.g. a UE 105), which can be utilized as described herein above (e.g., in association with the previously-described figures, with respect to a UE, mobile device, etc.). It should be noted that FIG. 16 is meant only to provide a generalized illustration of various components, any or all of which may be utilized as appropriate. Furthermore, the functionality of the UE discussed herein may be executed by one or more of the hardware and/or software components illustrated in FIG. 16.

The UE 1600 is shown comprising hardware elements that can be electrically coupled via a bus 1605 (or may otherwise be in communication, as appropriate). The hardware elements may include a processor(s) 1610 which can include without limitation one or more general-purpose processors (e.g., an application processor), one or more special-purpose processors (such as DSP chips, graphics acceleration processors, application specific integrated circuits (ASICs), and/or the like), and/or other processing structures or means. Processor(s) 1610 may comprise one or more processing units, which may be housed in a single integrated circuit (IC) or multiple ICs. As shown in FIG. 16, some embodiments may have a separate DSP 1620, depending on desired functionality. Location determination and/or other determinations based on wireless communication may be provided in the processor(s) 1610 and/or wireless communication interface 1630 (discussed below). The UE 1600 also can include one or more input devices 1670, which can include without limitation one or more keyboards, touch screens, touch pads, microphones, buttons, dials, switches, and/or the like; and one or more output devices 1615, which can include without limitation one or more displays (e.g., touch screens), light emitting diodes (LEDs), speakers, and/or the like.

The UE 1600 may also include a wireless communication interface 1630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1600 to communicate with other devices as described in the embodiments above. The wireless communication interface 1630 may permit data and signaling to be communicated and/or measured (e.g., transmitted and received) with other UEs (e.g. using SL signaling), TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1632 that send and/or receive wireless signals 1634. According to some embodiments, the wireless communication antenna(s) 1632 may comprise a plurality of discrete antennas, antenna arrays, or any combination thereof. The antenna(s) 1632 may be capable of transmitting and receiving wireless signals using beams (e.g., Tx beams and Rx beams). Beam formation may be performed using digital and/or analog beam formation techniques, with respective digital and/or analog circuitry. The wireless communication interface 1630 may include such circuitry.

Depending on desired functionality, the wireless communication interface 1630 may comprise a separate receiver and transmitter, or any combination of transceivers, transmitters, and/or receivers to communicate with other UEs, base stations (e.g., ng-eNBs and gNBs) and other terrestrial transceivers, such as wireless devices and access points. The UE 1600 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3r d Generation Partnership Project (3GPP). CDMA2000® is described in documents from a consortium named “3^{rd} Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1600 can further include sensor(s) 1640. Sensor(s) 1640 may comprise, without limitation, one or more inertial sensors and/or other sensors (e.g., accelerometer(s), gyro scope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1600 may also include a Global Navigation Satellite System (GNSS) receiver 1680 capable of receiving signals 1684 from one or more GNSS satellites using an antenna 1682 (which could be the same as antenna 1632). Positioning based on GNSS signal measurement can be utilized to complement and/or incorporate the techniques described herein. The GNSS receiver 1680 can extract a position of the UE 1600, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1680 is illustrated in FIG. 16 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1610, DSP 1620, and/or a processor within the wireless communication interface 1630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1610 or DSP 1620.

The UE 1600 may further include and/or be in communication with a memory 1660. The memory 1660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1660 of the UE 1600 also can comprise software elements (not shown in FIG. 16), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1660 that are executable by the UE 1600 (and/or processor(s) 1610 or DSP 1620 within UE 1600). In some embodiments, then, such code and/or instructions can be used to configure and/or adapt a general-purpose computer (or other device) to perform one or more operations in accordance with the described methods.

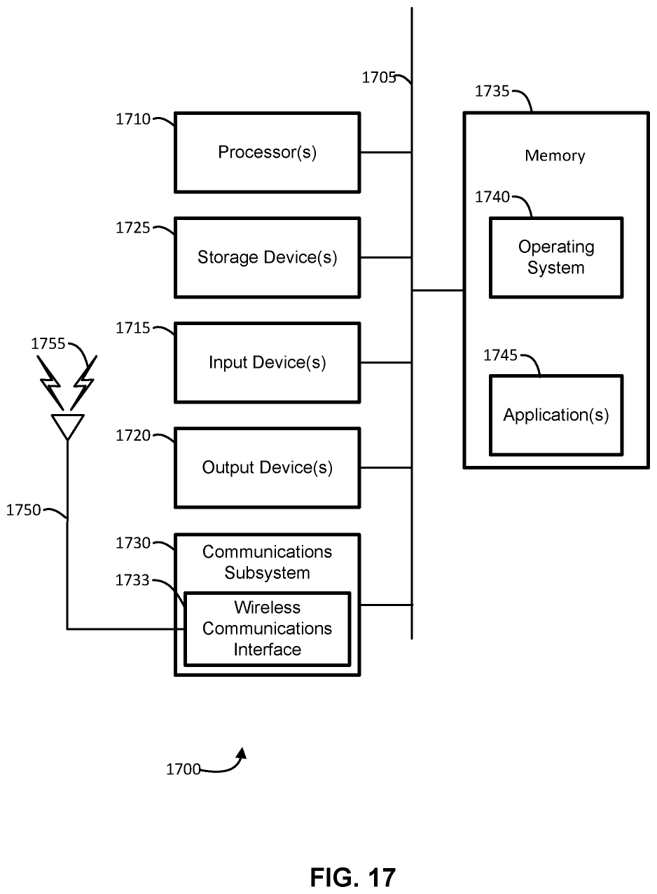

FIG. 17 is a block diagram of an embodiment of a computer system 1700, which may be used, in whole or in part, to provide the functions of one or more components and/or devices as described in the embodiments herein (including a location server, such as an LMF, an AMF, NEF and a GMLC). This may include, for example, a computer server, personal computer, personal electronic device, or the like. It should be noted that FIG. 17 is meant only to provide a generalized illustration of various components, any or all of which may be utilized as appropriate. FIG. 17, therefore, broadly illustrates how individual system elements may be implemented in a relatively separated or relatively more integrated manner. In addition, it can be noted that components illustrated by FIG. 17 can be localized to a single device and/or distributed among various networked devices, which may be disposed at different geographical locations.

The computer system 1700 is shown comprising hardware elements that can be electrically coupled via a bus 1705 (or may otherwise be in communication, as appropriate). The hardware elements may include processor(s) 1710, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1700 also may comprise one or more input devices 1715, which may comprise without limitation a mouse, a keyboard, a camera, a microphone, and/or the like; and one or more output devices 1720, which may comprise without limitation a display device, a printer, and/or the like.

The computer system 1700 may further include (and/or be in communication with) one or more non-transitory storage devices 1725, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1700 may also include a communications subsystem 1730, which may comprise wireless communication technologies managed and controlled by a wireless communication interface 1733, as well as wired technologies (such as Ethernet, coaxial communications, universal serial bus (USB), and the like). The wireless communication interface 1733 may comprise one or more wireless transceivers that may send and receive wireless signals 1755 (e.g., signals according to 5G NR or LTE) via wireless antenna(s) 1750. Thus the communications subsystem 1730 may comprise a modem, a network card (wireless or wired), an infrared communication device, a wireless communication device, and/or a chipset, and/or the like, which may enable the computer system 1700 to communicate on any or all of the communication networks described herein to any device on the respective network, including a User Equipment (UE), base stations and/or other transmission reception points (TRPs), and/or any other electronic devices described herein. Hence, the communications subsystem 1730 may be used to receive and send messages and data as described in the embodiments herein.

In many embodiments, the computer system 1700 will further comprise a working memory 1735, which may comprise a RAM or ROM device, as described above. Software elements, shown as being located within the working memory 1735, may comprise an operating system 1740, device drivers, executable libraries, and/or other code, such as one or more applications 1745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1725 described above. In some cases, the storage medium might be incorporated within a computer system, such as computer system 1700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1700 and/or might take the form of source and/or installable code, which, upon compilation and/or installation on the computer system 1700 (e.g., using any of a variety of generally available compilers, installation programs, compression/decompression utilities, etc.), then takes the form of executable code.

A periodic and triggered Sidelink Mobile Terminated Location Request (SL-MT-LR) procedure may be used to estimate the relative locations or distances and/or directions between UEs periodically or following certain trigger events.

A seventh enhanced procedure for sidelink positioning/ranging may comprise a periodic or triggered SL-MT-LR procedure for ranging between target UEs. This procedure can enable an LCS Client or AF to request and obtain Sidelink Positioning/Ranging location information for two or more target UEs whenever a trigger event or periodic event is detected by the UEs.

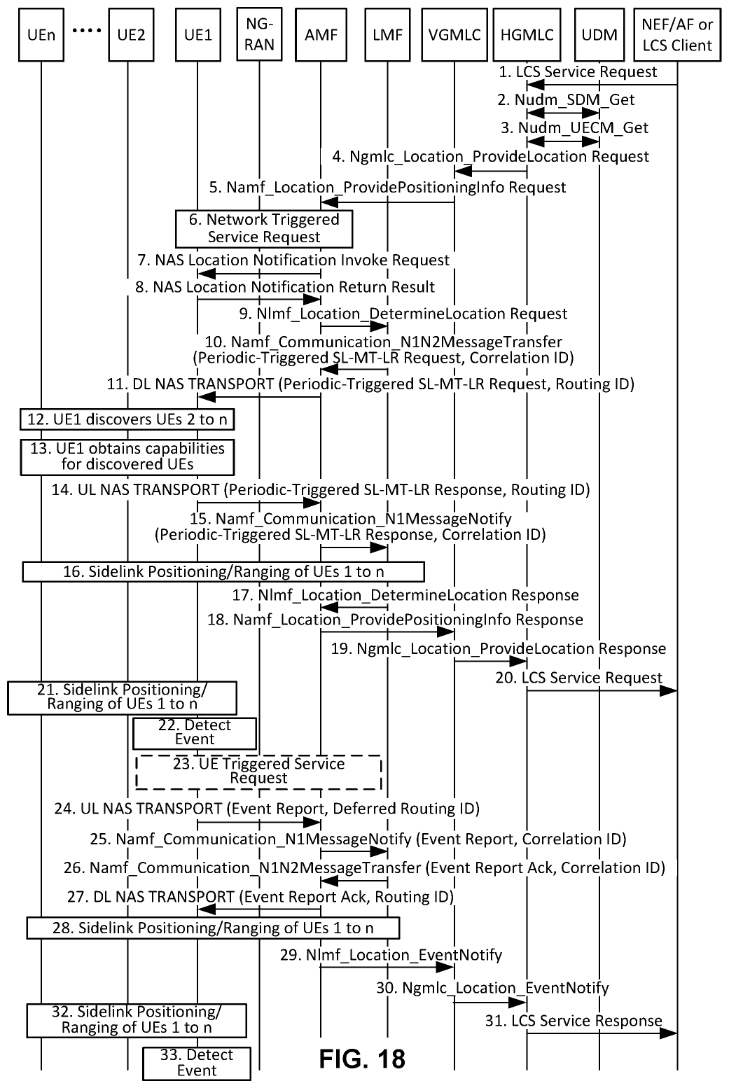

FIG. 18 illustrates the periodic or triggered SL-MT-LR procedure to enable an LCS Client or AF to obtain Ranging/Sidelink Positioning location results for a group of n UEs (n≥2), i.e. UE1, UE2, UEn either periodically or when certain trigger events occur, according to some embodiments. In the procedure, the GMLC determines a UE among the n UEs to be designated UE1 (e.g. a principal target UE) and one or more other UEs designated UE2, UE3, UEn (n≥2) (e.g. target, reference or located UEs). The Ranging/Sidelink Positioning location results may include absolute locations, relative locations, ranges, directions, velocities, and relative velocities related to the UEs, based on the service request. According to some embodiments, the procedure in FIG. 18 may be used when at least one of the n UEs is in coverage and registered with a serving PLMN. Details regarding the various stages of the procedure in FIG. 18 are described in the following paragraphs.

According to some embodiments, as a precondition for the seventh enhanced procedure of FIG. 18, at least one of the n target UEs (assumed to be UE1 here) may be in coverage and registered with a serving PLMN.

Stage 1: The LCS Client or the AF (via an NEF) may send an LCS service request to the (H)GMLC for Ranging/Sidelink Positioning location results for the n UEs which may each be identified by a GPSI or a SUPI. The request may include the required QoS, the required location results (e.g. absolute locations, relative locations, velocities and/or distances and/or directions related to the UEs).

The service request may further include periodic or trigger event parameters. For periodic location, the LCS Service Request may include the time interval between successive location reports and the total number of reports. For triggered location, the LCS Service Request may include details of the trigger event, the duration of event reporting, the minimum and maximum time intervals between successive event reports, the maximum event sampling interval, whether location estimates shall be included in event reports, whether only one location report is required or more than one, or any combination thereof. Trigger events can be one of the following: (i) a ranging event with range threshold and threshold type (type a, b, c, or d as below): a trigger event then occurs if the ranges (e.g. distances) between at least one UE of the n UEs and each of the other n−1 UEs are such that any range for the one UE is less than the threshold (type a), any range for the one UE exceeds the threshold (type b), all ranges for the one UE are less than the threshold (type c), or all ranges for the one UE exceed the threshold (type d); (ii) a radial velocity event with radial velocity threshold and threshold type (type a, b, c, or d as below): a trigger event then occurs if the radial velocities between at least one UE of the n UEs and each of the other n−1 UEs are such that any radial velocity for the one UE is less than the threshold (type a), any radial velocity for the one UE exceeds the threshold (type b), all radial velocities for the one UE are less than the threshold (type c), or all radial velocities for the one UE exceed the threshold (type d). It is noted that a radial velocity between a first UE and a second UE may equal the rate of change of the range (i.e. distance) between the first UE and the second UE. Other possible types of trigger event can be as described for stage 1 of FIG. 13.

A preferred ordering for the n target UEs may be indicated by the LCS Client or the AF to assist in determination of a principal target UE at stage 3. The (H)GMLC may modify any preferred ordering provided by the LCS Client or AF. For example, the (H)GMLC may prioritize a UE for which the PLMN of the (H)GMLC is the home PLMN (HPLMN) of the UE. The request also may include conditions for canceling the location request when not all n target UEs can be discovered for positioning. The conditions for canceling the location request may include: (i) one or more specific target UEs cannot be discovered; and/or (ii) the total number of target UEs that are discovered is less than a quorum q, where 2≤q≤n.

The LCS Client or AF may determine before stage 1 that the n target UEs are all in proximity to one another and may obtain their Application Layer IDs and/or global IDs. For example, one or more of the n target UEs may be in communication with the LCS Client or AF (e.g. using an application protocol such as the Hypertext Transfer Protocol (HTTP) or HTTP Secure (HTTPS)) and may provide the LCS Client or AF with the Application layer IDs and/or global IDs of all n target UEs, an approximate (coarse) relative or absolute location of each of the n target UEs and/or may indicate whether the n target UEs have performed mutual discovery (e.g. where one target UE has discovered the other n−1 target UEs). This may enable the LCS Client or AF to provide the LCS service request at stage 1 and to know in advance that the n target UEs are in proximity to one another.

The (H)GMLC or NEF may authorize the LCS Client or the AF for the usage of the LCS service. If the authorization fails, the remaining stages may be skipped and the (H)GMLC or NEF may respond to the LCS Client or the AF with the failure of the service authorization.

In addition, an Application Layer ID may be included by the LCS Client or AF for each of the n UEs to enable discovery of the UEs at stage 12.

Stage 2: The (H)GMLC may invoke a Nudm_SDM_Get service operation towards the UDM of each of the n UEs to get the privacy settings of the UE identified by its GPSI or SUPI. The UDM may return the UE Privacy setting of the UE. The (H)GMLC checks the UE LCS privacy profile.

Stage 3: The (H)GMLC may invoke a Nudm_UECM_Get service operation towards the UDM of each of the n UEs (for which GPSI or SUPI is available), one at a time, using the GPSI or SUPI of each UE. In some embodiments, the (H)GMLC may invoke the Nudm_UECM_Get service operation towards the UDM of each of the n target UEs one at a time and in turn according to the preferred ordering in stage 1 (if this was included). If any target UE is in coverage and has registered with a serving PLMN, the UDM may return the network address of the current serving AMF and additionally the address of a visited GMLC (V-GMLC) for a UE that is roaming. The (H)GMLC may stop the Nudm_UECM_Get service operations towards the UDM(s) as soon as a UDM returns either serving PLMN and AMF information for one of the n target UEs or serving PLMN and AMF information for one of the n target UEs that show that the one of the target UEs is served by the PLMN of the (H)GMLC. This one UE may be treated as the principal target UE and may be treated as being UE1 here. According to some embodiments, the UDM may be aware of the serving AMF address at UE registration with an AMF, and/or a serving V-GMLC address at UE registration with an AMF.

According to some embodiments, the UDM may be aware of the serving AMF address at UE registration with an AMF. The UDM may also be aware of a serving V-GMLC address at UE registration with an AMF.

Stage 4: For a non-roaming case, this stage may be skipped. In the case of roaming, the (H)GMLC may receive an address of a V-GMLC (together with the network address of the current serving AMF) from the UDM in stage 3; otherwise, the (H)GMLC may use an NRF service to select an available V-GMLC in the VPLMN, based on the VPLMN identification contained in the AMF address received in stage 3. The (H)GMLC then sends the location request to the V-GMLC by invoking the Ngmlc_Location_ProvideLocation service operation towards the V-GMLC. The (H)GMLC also may include a contact address for the (H)GMLC (which may be referred to as Notification Target Address and may be a Uniform Resource Identifier (URI)) and a Location Deferred Request (LDR) reference number (which may be referred to as a Notification correlation ID) to be used for event reporting at stages 24-31. The LDR reference number may be either allocated by the (H-)GMLC based on predefined rules, e.g. operator's policy, or may be allocated by an NEF. In the cases when the (H)GMLC did not receive the address of the V-GMLC, or when the V-GMLC address is the same as the (H)GMLC address, or when both PLMN operators agree, the (H)GMLC may send the location service request message to the serving AMF. In this case, stage 4 may be skipped. The (H)GMLC also may provide the LCS client type of AF, if received in stage 1, or LCS client type of LCS client and other attributes to be sent to AMF in stage 5.

Stage 5: In the case of roaming, the V-GMLC may first authorize that the location request is allowed from this (H)GMLC, PLMN, or from this country. If not, an error response may be returned. The (H)GMLC or V-GMLC may invoke the Namf_Location_ProvidePositioningInfo service operation towards the AMF to request periodic or triggered sidelink positioning/ranging location results of the n UEs. The service operation may include the SUPI of UE1, the Application layer IDs of the UEs that were determined by the (H)GMLC or V-GMLC to participate in the procedure, the LCS client type and may include the required LCS QoS, the required location results (e.g. relative locations, velocities or ranges and directions related to the UEs), the periodic or trigger event parameters, other attributes as received or determined in stages 1 and 4, or any combination thereof.

According to some embodiments, the location request may be sent to one V-GMLC at stage 4 for roaming and to one AMF at stage 5, which is the serving AMF for UE 1.

Stage 6: If UE1 is in a CM IDLE state, the AMF may initiate a network triggered Service Request procedure to establish a signaling connection with UE1.

If signaling connection establishment fails, stages 7-17 may be skipped.

Stages 7-8: a NAS Location Notification invoke request and return result exchange may be carried out, e.g. as described for stages 7 and 8 of FIG. 15.

Stage 9: The serving AMF may select an LMF serving UE1 (e.g. an LMF that supports Ranging/Sidelink Positioning for periodic and triggered location) and may send an Nlmf_Location_DetermineLocation service operation towards the LMF with the information received at stage 5, e.g. required location results (e.g. relative locations, velocities, or ranges and directions between pairs of UEs) and periodic or trigger event parameters.

Stage 10: The LMF may send a Periodic-Triggered SL-MT-LR request to the serving AMF as a supplementary services message, using the Namf_Communication_N1N2MessageTransfer service operation, and a Correlation ID identifying the LMF or the location request (e.g. where the correlation ID may have been assigned by the AMF and sent to the LMF at stage 9). The LCS Periodic-Triggered SL-MT-LR request may include a deferred routing identifier, which can be the identification of the LMF when the LMF will act as a serving LMF or a default LMF identification otherwise. The LCS Periodic-Triggered SL-MT-LR request may indicate the allowed access types for event reporting at stage 24 (e.g. one or more of NR, LTE, WiFi, NR or LTE satellite access) and may include the QoS and allowed or required location results at stage 24 for each location event reported. The LCS Periodic-Triggered SL-MT-LR request also may include the application layer IDs of UEs 1 to n, the contact address for the (H)GMLC and LDR reference number.

Stage 11: The serving AMF may forward the Periodic-Triggered SL-MT-LR request and an immediate Routing ID equal to the Correlation ID to UE1 using a DL NAS TRANSPORT message. According to some embodiments, the deferred routing identifier may be global (e.g. an IP address, Universally Unique Identifier (UUID), or URI) or may be local. The deferred routing identifier may be used for routing in stages 24 and 25. The immediate routing identifier included by the AMF in stage 11 may be used for routing in stages 14 and 15.

Stage 12: UE1 may attempt to discover the other UEs 2 to n using their application layer IDs and if not discovered already.

Stage 13: UE1 may obtain the sidelink positioning capabilities of the discovered UEs if not already obtained.

Stage 14: UE1 may return a supplementary services Periodic-Triggered SL-MT-LR response to the serving AMF in an UL NAS TRANSPORT message and may include the immediate Routing ID received in stage 11. The Periodic-Triggered SL-MT-LR response may indicate if the periodic or triggered SL-MT-LR request can be supported and which of UEs 2 to n have been discovered and are available for positioning.

Stage 15: The serving AMF may forward the Periodic-Triggered SL-MT-LR response to the LMF indicated by the immediate Routing ID received at stage 14 and may include a Correlation ID equal to the immediate Routing ID.

Stage 16: Ranging/Sidelink Positioning of UE1 and the other discovered UEs may occur as for an SL-MO-LR as described for stages 10-18 of FIG. 14 with the difference that Ranging/Sidelink Positioning location results may always be obtained and the LMF may indicate to UE1 at stage 13 or stage 14 of FIG. 14 whether the Ranging/Sidelink Positioning location results will be calculated by the LMF (at stage 18 of FIG. 14) or by UE1 (at stage 16 of FIG. 14). According to some embodiments, stage 16 (of FIG. 18) may enable the LMF to obtain the capabilities and initial location results for the UEs 1 to n.

Stages 17-20: The LMF may return the initial sidelink positioning/ranging location results to the LCS Client or AF via the serving AMF, V-GMLC (if included), (H)GLMC and, in the case of an AF, an NEF.

Stage 21: The UEs 1 to n may periodically perform sidelink positioning/ranging in order to support stages 22 and 24. According to some embodiments, the UEs 1 to n may perform sidelink positioning/ranging at intervals of the maximum event sampling interval provided at stage 1.

Stage 22: UE1 may monitor for occurrence of the trigger or periodic event requested in stage 11. For a trigger event, UE1 may monitor the requested event at intervals equal to or less than the maximum event sampling interval. An event trigger may be detected by UE1 when any one or more of the following occur: (i) a requested non-periodic trigger event has been detected and the minimum reporting time interval has elapsed since the last report (if this is not the first event report); (ii) a requested periodic location event has occurred; or (iii) the maximum reporting time for a non-periodic trigger event has expired (since the last event report was sent at stage 24 or since the start of event reporting if this is the first event). When a trigger or periodic event is detected and if UE1 is camped on or connected to (or can otherwise access) an access type allowed by the LMF at stage 11, UE1 may proceed to stage 23. If UE1 cannot access an allowed access type, UE1 may skip reporting the trigger event or may report the trigger event at a later time when an allowed access type becomes available, according to requirements received from the LMF at stage 11.

Stage 23: UE1 may perform a UE triggered service request if in a CM-IDLE state in order to establish a signaling connection with the AMF.

Stage 24: UE1 may send a supplementary services event report message to the serving AMF (which may be different to the serving AMF at stages 11-16) using the Namf_Communication_N1N2MessageTransfer service operation, and may include the deferred Routing ID received in stage 11. The event report may indicate the type of event being reported (e.g. whether a normal event or expiration of the maximum reporting interval) and may include location results obtained at stage 21. UE1 also may include the (H)GMLC contact address, the LDR reference number, whether location results are to be reported and if so the location QoS in the event report, or any combination thereof.

Stage 25: The AMF may forward the event report to the LMF indicated by the deferred Routing ID received at stage 24 and may include a Correlation ID equal to the deferred Routing ID.

Stage 26: When the LMF receives the event report and if it can handle this event report, the LMF may update the status of event reporting (e.g. the number of event reports so far received from UE1 and/or the duration of event reporting so far) and may return a supplementary services acknowledgment for the event report to the serving AMF using the Namf_Communication_N1N2MessageTransfer service operation, and a Correlation ID identifying the LMF. The acknowledgment may optionally include a new deferred routing identifier indicating a new serving LMF or a default (any) LMF.

Stage 27: The serving AMF may forward the event report Ack and an immediate Routing ID equal to the Correlation ID to UE1 using a DL NAS TRANSPORT message. If UE1 does not receive any response from the LMF after a predefined time, e.g. the current LMF does not support the deferred location request (for temporary or permanent reasons) or due to some radio access failures, UE1 may re-send the report one or more times. According to some embodiments, inclusion of a new deferred routing identifier in the event report acknowledgment at stage 26 may be used to change the serving LMF (e.g. if a UE moves into an area or to an access type that is better supported by a different LMF or if the serving LMF is overloaded) or to enable a default LMF to become a serving LMF.

Stage 28: If location results are used for event reporting and are not received at stage 25, the LMF may instigate Ranging/Sidelink Positioning of UEs 1 to m as at stage 16.

Stages 29-31: The LMF may return the event report and any location results obtained at stage 25 or stage 28 to the LCS Client or AF via the serving AMF, V-GMLC (if included), (H)GLMC and, in the case of an AF, an NEF.

Stage 32: UEs 1 to n may continue to periodically perform sidelink positioning/ranging as in stage 21.

Stage 33: UE1 may continue to monitor for further periodic or trigger events as in stage 22 and may instigate stages 23-31 each time a periodic or trigger event is detected. For example, a further periodic or trigger event may be detected at each of a succession of different times and steps 23-31 may thereby be performed at each of the succession of different times.

The description of sidelink positioning up until this point has either not indicated particular position methods or has assumed and made reference to positioning based on SL PRS transmission and measurement by participating UEs. However, the procedures described herein for an MO-LR, MT-LR or periodic or triggered MT-LR request for SL positioning of a plurality of UEs can instead use other position methods. These may be Radio Access Technology (RAT) independent position methods in some embodiments. These other position methods may include: real time kinematic (RTK); transmission and measurement by participating UEs of WiFi signals; and transmission and measurement by participating UEs of ultra-wideband (UWB) signals. For example, when sidelink positioning of a plurality of UEs is performed using RTK, each UE in the plurality of UEs may measure and obtain carrier phase measurements of Global Navigation Satellite (GNSS) signals (e.g. for GPS, Galileo, GLONASS or Beidou). The carrier phase measurements obtained by the plurality of UEs may then be provided to at least one UE in the plurality of UEs (e.g. a UE1), where the at least one UE determines location results for the plurality of UEs based on the carrier phase measurements obtained by the plurality of UEs. The use of RTK (or WiFi or UWB) rather than SL PRS may have little impact on how an MO-LR, MT-LR or periodic or triggered MT-LR request for SL positioning of a plurality of UEs is supported except to no longer require SL PRS configurations to be sent to UEs and either be transmitted or measured, and instead other assistance data could be sent to UEs such as configurations to be transmitted or measured for WiFi or UWB signals or details of GNSS signals to be measured (but not transmitted) for RTK. It would also no longer be necessary to transmit and measure SL PRS and instead either WiFi signals or UWB signals might be transmitted and measured, or, in the case of RTK, RTK signals might be measured (though not transmitted). These changes would require certain changes to FIGS. 10-15 and 18 but can otherwise leave in stages specific to an MO-LR, MT-LR or periodic or triggered MT-LR request for SL positioning of a plurality of UEs.

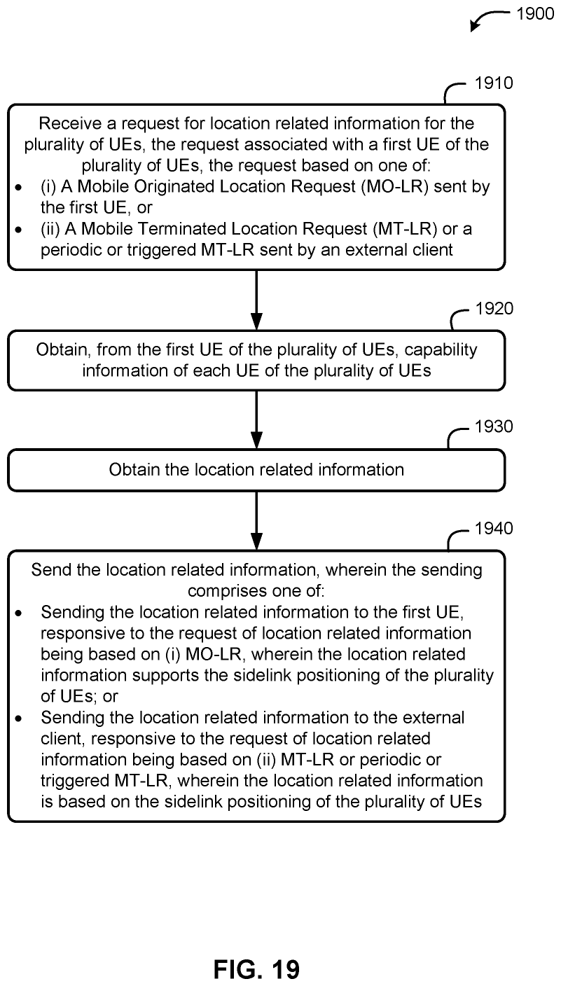

FIG. 19 is a diagram of an embodiment of a method 1900 performed at a location server for supporting sidelink positioning of a plurality of UEs (e.g. UEs 105), according to an embodiment. The location server may comprise an LMF (e.g. an LMF 120) as described herein, for example. Aspects of the method 1900 may reflect the functionality of a location server as described in various embodiments herein, such as those illustrated in FIGS. 11-15 and 18. Means and/or structure for performing the functions of one or more of the blocks illustrated in FIG. 19 may comprise software and/or hardware components of a computer system, such as the computer system 1700 of FIG. 17.

The functionality at block 1910 comprises receiving a request for location related information for the plurality of UEs, the request associated with a first UE of the plurality of UEs, the request based on one of (i) A Mobile Originated Location Request (MO-LR) sent by the first UE, or (ii) A Mobile Terminated Location Request (MT-LR) or a periodic or triggered MT-LR sent by an external client (e.g. external client 130, an LCS Client or an AF). Means and/or structure for performing the functionality at block 1910 may comprise one or more processors 1710, memory 1735, communications subsystem 1730, and/or other components of a computer system 1700, as described in FIG. 17.

The functionality at block 1920 comprises obtaining, from the first UE of the plurality of UEs, capability information of each UE of the plurality of UEs. Means and/or structure for performing the functionality at block 1920 may comprise one or more processors 1710, memory 1735, communications subsystem 1730, and/or other components of a computer system 1700, as described in FIG. 17.

The functionality at block 1930 comprises obtaining the location related information. Means and/or structure for performing the functionality at block 1930 may comprise one or more processors 1710, memory 1735, communications subsystem 1730, and/or other components of a computer system 1700, as described in FIG. 17.

The functionality at block 1940 comprises sending the location related information, wherein the sending comprises one of: sending the location related information to the first UE, responsive to the request of location related information being based on (i) MO-LR, wherein the location related information supports the sidelink positioning of the plurality of UEs; or sending the location related information to the external client, responsive to the request of location related information being based on (ii) MT-LR or periodic or triggered MT-LR, wherein the location related information is based on the sidelink positioning of the plurality of UEs. Means and/or structure for performing the functionality at block 1940 may comprise one or more processors 1710, memory 1735, communications subsystem 1730, and/or other components of a computer system 1700, as described in FIG. 17.

As described herein, embodiments may include one or more of the following features. In some embodiments, the location server may not communicate with any UEs of the plurality of UEs, other than the first UE, for the sidelink positioning of the plurality of UEs. The location related information may comprise one or more location results for the sidelink positioning of the plurality of UEs, wherein a location result comprises one of: a range between a pair of UEs of the plurality of UEs; a direction between one UE and another UE of the plurality of UEs; a location of a UE of the plurality of UEs; a location of a one UE relative to the location of another UE of the plurality of UEs; a velocity of a UE of the plurality of UEs; and a velocity of one UE relative to the velocity of another UE of the plurality of UEs. In such embodiments, the location related information may comprise at least one location result for each UE of the plurality of UEs. Additionally or alternatively, obtaining the location related information may comprise sending a request for location measurements to the first UE, wherein the first UE coordinates the sidelink positioning of the plurality of UEs based on the request for the location measurements, wherein the first UE obtains the location measurements based on the sidelink positioning of the plurality of UEs; receiving the location measurements from the first UE; and calculating the location related information based on the location measurements. According to some embodiments, obtaining the location related information may comprise sending a request for the location related information to the first UE, wherein the first UE coordinates the sidelink positioning of the plurality of UEs based on the request for the location related information, wherein the first UE obtains the location related information based on the sidelink positioning of the plurality of UEs; and receiving the location related information from the first UE.

Additionally or alternatively, embodiments may include one or more of the following features. According to some embodiments, each UE of the plurality of UEs may comprise a target UE. The request may be based on (i) the MO-LR sent by the first UE, wherein the location related information comprises assistance data. Such embodiments may further comprise receiving a request for specific assistance data from the first UE; determining the specific assistance data based at least in part on the request for the specific assistance data and/or the capability information of each UE of the plurality of UEs; and sending the specific assistance data to the first UE, wherein the specific assistance data enables the sidelink positioning of the plurality of UEs. The request for location related information may include an application layer identity for each UE of the plurality of UEs. The request may be based on (ii) the MT-LR or the periodic or triggered MT-LR sent by the external client, wherein the MT-LR or the periodic or triggered MT-LR is received by a GMLC, wherein the GMLC determines the first UE based on at least one of: a preferred ordering of UEs of the plurality of UEs indicated in the MT-LR or the periodic or triggered MT-LR sent by the external client; the first UE having a same home PLMN as a PLMN for the GMLC; or the first UE being served by the same home PLMN as the PLMN for the GMLC. According to some embodiments, the request may be based on the periodic or triggered MT-LR sent by the external client, wherein the periodic or triggered MT-LR includes a periodic event or a trigger event, the trigger event based on ranges or relative velocities of UEs of the plurality of UEs. Such embodiments may further comprise obtaining the location related information at each of a succession of different times; and sending the location related information to the external client in an event report at each of the succession of different times. According to some embodiments, the request may be based on (ii) the MT-LR or the periodic or triggered MT-LR sent by the external client. Embodiments may further comprise, prior to obtaining the capability information, sending a separate MT-LR request or a periodic or triggered MT-LR request to the first UE, the separate MT-LR request or the periodic or triggered MT-LR request including identities for other UEs of the plurality of UEs to enable the first UE to discover the other UEs of the plurality of UEs based on the identities for the other UEs of the plurality of UEs; and receiving, from the first UE, an MT-LR response or a periodic or triggered MT-LR response, wherein the MT-LR response or the periodic or triggered MT-LR response indicates whether the first UE has discovered the other UEs of the plurality of UEs and whether the other UEs of the plurality of UEs are available for the sidelink positioning of the plurality of UEs.

Some embodiments may further comprise, prior to obtaining the capability information of each UE of the plurality of UEs, sending a capability request to the first UE for the capability information of each UE of the plurality of UEs, wherein obtaining the capability information of each UE of the plurality of UEs is responsive to the capability request.

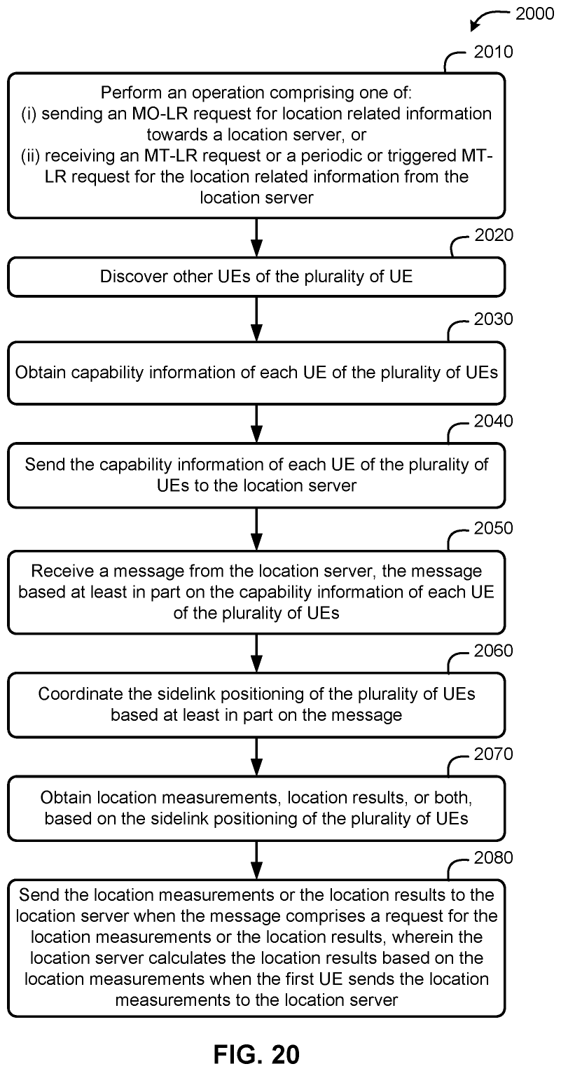

FIG. 20 is a diagram of an embodiment of a method 2000 performed at a first UE (e.g. a UE 105) for supporting sidelink positioning of a plurality of UEs, according to an embodiment. Aspects of the method 2000 may reflect the functionality of a UE as described in various embodiments herein, such as those illustrated in FIGS. 10-15 and 18. Means and/or structure for performing the functions of one or more of the blocks illustrated in FIG. 20 may comprise software and/or hardware components of a UE, such as the UE 1600 of FIG. 16.

The functionality at block 2010 comprises performing an operation comprising one of: (i) sending an MO-LR request for location related information towards a location server (e.g. an LMF 120), or (ii) receiving an MT-LR request or a periodic or triggered MT-LR request for the location related information from the location server. Means and/or structure for performing the functionality at block 2010 may comprise one or more processors 1610, memory 1660, wireless communication interface 1630, and/or other components of a UE 1600, as described in FIG. 16.

The functionality at block 2020 comprises discovering other UEs of the plurality of UE. This may involve a discovery processes described herein, which may be governed by applicable wireless standards. Means and/or structure for performing the functionality at block 2020 may comprise one or more processors 1610, memory 1660, wireless communication interface 1630, and/or other components of a UE 1600, as described in FIG. 16.

The functionality at block 2030 comprises obtaining capability information of each UE of the plurality of UEs. This may involve a capability exchange, as described herein. Means and/or structure for performing the functionality at block 2030 may comprise one or more processors 1610, memory 1660, wireless communication interface 1630, and/or other components of a UE 1600, as described in FIG. 16.

The functionality at block 2040 comprises sending the capability information of each UE of the plurality of UEs to the location server. Means and/or structure for performing the functionality at block 2040 may comprise one or more processors 1610, memory 1660, wireless communication interface 1630, and/or other components of a UE 1600, as described in FIG. 16.

The functionality at block 2050 comprises receiving a message from the location server, the message based at least in part on the capability information of each UE of the plurality of UEs. Means and/or structure for performing the functionality at block 2050 may comprise one or more processors 1610, memory 1660, wireless communication interface 1630, and/or other components of a UE 1600, as described in FIG. 16.

The functionality at block 2060 comprises coordinating the sidelink positioning of the plurality of UEs based at least in part on the message. Means and/or structure for performing the functionality at block 2060 may comprise one or more processors 1610, memory 1660, wireless communication interface 1630, and/or other components of a UE 1600, as described in FIG. 16.

The functionality at block 2070 comprises obtaining location measurements, location results, or both, based on the sidelink positioning of the plurality of UEs. Means and/or structure for performing the functionality at block 2070 may comprise one or more processors 1610, memory 1660, wireless communication interface 1630, and/or other components of a UE 1600, as described in FIG. 16.

The functionality at block 2080 comprises sending the location measurements or the location results to the location server when the message comprises a request for the location measurements or the location results, wherein the location server calculates the location results based on the location measurements when the first UE sends the location measurements to the location server. Means and/or structure for performing the functionality at block 2080 may comprise one or more processors 1610, memory 1660, wireless communication interface 1630, and/or other components of a UE 1600, as described in FIG. 16.

As described herein, according to some embodiments, location related information may comprise the location results, wherein a location result comprises one or more of a range between a pair of UEs of the plurality of UEs; a direction between one UE and another UE of the plurality of UEs; a location of a UE of the plurality of UEs; a location of a one UE relative to the location of another UE of the plurality of UEs; a velocity of a UE of the plurality of UEs; or a velocity of one UE relative to the velocity of another UE of the plurality of UEs. The location results may comprise at least one location result for each UE of the plurality of UEs. According to some embodiments, each UE of the plurality of UEs comprises a target UE.

As described herein, embodiments may include one or more of the following features. In some embodiments, the location server may not communicate with any of the UEs of the plurality of UEs, other than the first UE, for the sidelink positioning of the plurality of UEs. According to some embodiments, the message may comprise a request for the location measurements or the location results and method 2000 may further comprise sending the location measurements or the location results to the location server in response to the request for the location measurements or the location results. According to some embodiments, the first UE performs the operation comprising (i) sending the MO-LR request for location related information, and wherein the location related information comprises assistance data. Such embodiments may further comprise sending a request for specific assistance data to the location server, wherein the location server determines the specific assistance data based at least in part on the request for the specific assistance data and/or the capability information of each UE of the plurality of UEs; and receiving the specific assistance data from the location server in the message, wherein the specific assistance data enables the sidelink positioning of the plurality of UEs.

According to some embodiments, the first UE performs the operation comprising (ii) receiving the MT-LR request or the periodic or triggered MT-LR request, where the MT-LR request or the periodic or triggered MT-LR request for the location related information includes an application layer identity for each UE of the plurality of UEs, and where discovering the other UEs of the plurality of UEs is based on the application layer identity for each UE of the plurality of UEs.

According to some embodiments, the first UE may perform the operation comprising (i) sending the MO-LR request for the location related information, and where the method further comprises: obtaining an application layer identity for each UE of the plurality of UEs based on the discovering the other UEs of the plurality of UEs; and including the application layer identity for each UE of the plurality of UEs in the MO-LR request for the location related information.

Additionally or alternatively, embodiments may include one or more of the following features. According to some embodiments, the first UE may perform the operation comprising (ii) receiving the MT-LR request or the periodic or triggered MT-LR request; where a separate request for the MT-LR or the periodic or triggered MT-LR sent by an external client (e.g. external client 130, an LCS Client or an AF) is received by a GMLC (e.g. GMLC 125), and where the GMLC determines the first UE based on at least one of: a preferred ordering of the UEs of the plurality of UEs indicated in the request for the MT-LR or the periodic or triggered MT-LR; the first UE having a same home PLMN as a PLMN for the GMLC; or the first UE being served by the same home PLMN as the PLMN for the GMLC.

According to some embodiments, the first UE may perform the operation comprising (ii) receiving the MT-LR request or the periodic or triggered MT-LR request, the MT-LR request comprising the periodic or triggered MT-LR request; and where the periodic or triggered MT-LR request includes a periodic event or a trigger event, the trigger event based on ranges or relative velocities of the UEs of the plurality of UEs. Some embodiments may further comprise detecting the periodic event or the trigger event at each of a succession of different times; obtaining the location measurements or the location results at each of the succession of different times; and sending the location measurements or the location results to the location server in an event report at each of the succession of different times.

According to some embodiments, the first UE may perform the operation comprising (ii) receiving the MT-LR request or the periodic or triggered MT-LR request, and wherein the method further comprises sending an MT-LR response or a periodic or triggered MT-LR response to the location server, wherein the MT-LR response or the periodic or triggered MT-LR response indicates whether the first UE has discovered the other UEs of the plurality of UEs, wherein the MT-LR response or the periodic or triggered MT-LR response indicates whether the other UEs of the plurality of UEs are available for the sidelink positioning of the plurality of UEs.

Some embodiments may further comprise, prior to obtaining the capability information of each UE of the plurality of UEs, receiving a request for the capability information of each UE of the plurality of UEs from the location server, wherein obtaining the capability information of each UE of the plurality of UEs is responsive to the request for the capability information.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

Clause 1: A method performed at a location server for supporting sidelink positioning of a plurality of user equipments (UEs), the method comprising: receiving a request for location related information for the plurality of UEs, the request associated with a first UE of the plurality of UEs, the request based on one of: a Mobile Originated Location Request (MO-LR) sent by the first UE, or a Mobile Terminated Location Request (MT-LR) or a periodic or triggered MT-LR sent by an external client; obtaining, from the first UE of the plurality of UEs, capability information of each UE of the plurality of UEs; obtaining the location related information; and sending the location related information, wherein the sending comprises one of: sending the location related information to the first UE, responsive to the request of location related information being based on (i) MO-LR, wherein the location related information supports the sidelink positioning of the plurality of UEs; or sending the location related information to the external client, responsive to the request of location related information being based on (ii) MT-LR or periodic or triggered MT-LR, wherein the location related information is based on the sidelink positioning of the plurality of UEs.

Clause 2: The method of clause 1, wherein the location server does not communicate with any UEs of the plurality of UEs, other than the first UE, for the sidelink positioning of the plurality of UEs.

Clause 3: The method of any one of clauses 1-2 wherein the location related information comprises one or more location results for the sidelink positioning of the plurality of UEs, wherein a location result comprises one or more of: a range between a pair of UEs of the plurality of UEs; a direction between one UE and another UE of the plurality of UEs; a location of a UE of the plurality of UEs; a location of a one UE relative to the location of another UE of the plurality of UEs; a velocity of a UE of the plurality of UEs; or a velocity of one UE relative to the velocity of another UE of the plurality of UEs.

Clause 4: The method of clause 3 wherein the location related information comprises at least one location result for each UE of the plurality of UEs.

Clause 5: The method of clause 3 wherein obtaining the location related information comprises: sending a request for location measurements to the first UE, wherein the first UE coordinates the sidelink positioning of the plurality of UEs based on the request for the location measurements, wherein the first UE obtains the location measurements based on the sidelink positioning of the plurality of UEs; receiving the location measurements from the first UE; and calculating the location related information based on the location measurements.

Clause 6: The method of clause 3 wherein obtaining the location related information comprises: sending a request for the location related information to the first UE, wherein the first UE coordinates the sidelink positioning of the plurality of UEs based on the request for the location related information, wherein the first UE obtains the location related information based on the sidelink positioning of the plurality of UEs; and receiving the location related information from the first UE.

Clause 7: The method of any one of clauses 1-6 wherein each UE of the plurality of UEs is a target UE.

Clause 8: The method of any one of clauses 1-7 wherein the request is based on (i) the MO-LR sent by the first UE, wherein the location related information comprises assistance data.

Clause 9: The method of clause 8 further comprising receiving a request for specific assistance data from the first UE; determining the specific assistance data based at least in part on the request for the specific assistance data and the capability information of each UE of the plurality of UEs; and sending the specific assistance data to the first UE, wherein the specific assistance data enables the sidelink positioning of the plurality of UEs.

Clause 10: The method of any one of clauses 1-9 wherein the request for location related information includes an application layer identity for each UE of the plurality of UEs.

Clause 11: The method of any one of clauses 1-10 wherein the request is based on (ii) the MT-LR or the periodic or triggered MT-LR sent by the external client, wherein the MT-LR or the periodic or triggered MT-LR is received by a GMLC, wherein the GMLC determines the first UE based on at least one of: a preferred ordering of UEs of the plurality of UEs indicated in the MT-LR or the periodic or triggered MT-LR sent by the external client; the first UE having a same home PLMN as a PLMN for the GMLC; or the first UE being served by the same home PLMN as the PLMN for the GMLC.

Clause 12: The method of any one of clauses 1-11 wherein the request is based on the periodic or triggered MT-LR sent by the external client, wherein the periodic or triggered MT-LR includes a periodic event or a trigger event, the trigger event based on ranges or relative velocities of UEs of the plurality of UEs.

Clause 13: The method of clause 12 further comprising obtaining the location related information at each of a succession of different times; and sending the location related information to the external client in an event report at each of the succession of different times.

Clause 14: The method of any one of clauses 1-13 wherein the request is based on (ii) the MT-LR or the periodic or triggered MT-LR sent by the external client, and further comprising: prior to obtaining the capability information, sending a separate MT-LR request or a periodic or triggered MT-LR request to the first UE, the separate MT-LR request or the periodic or triggered MT-LR request including identities for other UEs of the plurality of UEs to enable the first UE to discover the other UEs of the plurality of UEs based on the identities for the other UEs of the plurality of UEs; and receiving, from the first UE, an MT-LR response or a periodic or triggered MT-LR response, wherein the MT-LR response or the periodic or triggered MT-LR response indicates whether the first UE has discovered the other UEs of the plurality of UEs and whether the other UEs of the plurality of UEs are available for the sidelink positioning of the plurality of UEs.

Clause 15: The method of any one of clauses 1-14 further comprising, prior to obtaining the capability information of each UE of the plurality of UEs, sending a capability request to the first UE for the capability information of each UE of the plurality of UEs, wherein obtaining the capability information of each UE of the plurality of UEs is responsive to the capability request.

Clause 16: A method performed at a first UE of a plurality of UEs for supporting sidelink positioning of the plurality of UEs, the method comprising: performing an operation comprising one of: (i) sending an MO-LR request for location related information towards a location server, or (ii) receiving an MT-LR request or a periodic or triggered MT-LR request for the location related information from the location server; discovering other UEs of the plurality of UEs; obtaining capability information of each UE of the plurality of UEs; sending the capability information of each UE of the plurality of UEs to the location server; receiving a message from the location server, the message based at least in part on the capability information of each UE of the plurality of UEs; coordinating the sidelink positioning of the plurality of UEs based at least in part on the message; obtaining location measurements, location results, or both, based on the sidelink positioning of the plurality of UEs; and sending the location measurements or the location results to the location server when the message comprises a request for the location measurements or the location results, wherein the location server calculates the location results based on the location measurements when the first UE sends the location measurements to the location server.

Clause 17: The method of clause 16, wherein the location server does not communicate with any of the UEs of the plurality of UEs, other than the first UE, for the sidelink positioning of the plurality of UEs.

Clause 18: The method of any one of clauses 16-17 wherein the location related information comprises the location results, wherein a location result comprises one or more of: a range between a pair of UEs of the plurality of UEs; a direction between one UE and another UE of the plurality of UEs; a location of a UE of the plurality of UEs; a location of a one UE relative to the location of another UE of the plurality of UEs; a velocity of a UE of the plurality of UEs; or a velocity of one UE relative to the velocity of another UE of the plurality of UEs.

Clause 19: The method of clause 18 wherein the location results comprise at least one location result for each UE of the plurality of UEs.

Clause 20: The method of any one of clauses 18-19 wherein each UE of the plurality of UEs is a target UE.

Clause 21: The method of any one of clauses 16-20 wherein the message comprises a request for the location measurements or the location results and further comprising sending the location measurements or the location results to the location server in response to the request for the location measurements or the location results.

Clause 22: The method of any one of clauses 16-21 wherein the first UE performs the operation comprising (i) sending the MO-LR request for location related information, and wherein the location related information comprises assistance data.

Clause 23: The method of clause 22 further comprising sending a request for specific assistance data to the location server, wherein the location server determines the specific assistance data based at least in part on the request for the specific assistance data and the capability information of each UE of the plurality of UEs; and receiving the specific assistance data from the location server in the message, wherein the specific assistance data enables the sidelink positioning of the plurality of UEs.

Clause 24: The method of any one of clauses 16-23 wherein the first UE performs the operation comprising (ii) receiving the MT-LR request or the periodic or triggered MT-LR request; the MT-LR request or the periodic or triggered MT-LR request for the location related information includes an application layer identity for each UE of the plurality of UEs; and discovering the other UEs of the plurality of UEs is based on the application layer identity for each UE of the plurality of UEs.

Clause 25: The method of any one of clauses 16-24 wherein the first UE performs the operation comprising (i) sending the MO-LR request for the location related information, and wherein the method further comprises: obtaining an application layer identity for each UE of the plurality of UEs based on the discovering the other UEs of the plurality of UEs; and including the application layer identity for each UE of the plurality of UEs in the MO-LR request for the location related information.

Clause 26: The method of any one of clauses 16-25 wherein the first UE performs the operation comprising (ii) receiving the MT-LR request or the periodic or triggered MT-LR request; and wherein a separate request for the MT-LR or the periodic or triggered MT-LR sent by an external client is received by a GMLC, wherein the GMLC determines the first UE based on at least one of: a preferred ordering of the UEs of the plurality of UEs indicated in the request for the MT-LR or the periodic or triggered MT-LR; the first UE having a same home PLMN as a PLMN for the GMLC; or the first UE being served by the same home PLMN as the PLMN for the GMLC.

Clause 27: The method of any one of clauses 16-26 wherein the first UE performs the operation comprising (ii) receiving the MT-LR request or the periodic or triggered MT-LR request, the MT-LR request comprising the periodic or triggered MT-LR request; and wherein the periodic or triggered MT-LR request includes a periodic event or a trigger event, the trigger event based on ranges or relative velocities of the UEs of the plurality of UEs.

Clause 28: The method of clause 27 further comprising detecting the periodic event or the trigger event at each of a succession of different times; obtaining the location measurements or the location results at each of the succession of different times; and sending the location measurements or the location results to the location server in an event report at each of the succession of different times.

Clause 29: The method of any one of clauses 16-28 wherein the first UE performs the operation comprising (ii) receiving the MT-LR request or the periodic or triggered MT-LR request, and wherein the method further comprises sending an MT-LR response or a periodic or triggered MT-LR response to the location server, wherein the MT-LR response or the periodic or triggered MT-LR response indicates whether the first UE has discovered the other UEs of the plurality of UEs, wherein the MT-LR response or the periodic or triggered MT-LR response indicates whether the other UEs of the plurality of UEs are available for the sidelink positioning of the plurality of UEs.

Clause 30: The method of any one of clauses 16-29 further comprising, prior to obtaining the capability information of each UE of the plurality of UEs, receiving a request for the capability information of each UE of the plurality of UEs from the location server, wherein obtaining the capability information of each UE of the plurality of UEs is responsive to the request for the capability information.

Clause 31: A location server for supporting sidelink positioning of a plurality of user equipments (UEs), the location server comprising: one or more transceivers; one or more memories; and one or more processors communicatively coupled with the one or more transceivers and the one or more memories, wherein the one or more processors are configured to: receive, via the one or more transceivers, a request for location related information for the plurality of UEs, the request associated with a first UE of the plurality of UEs, the request being based on one of: a Mobile Originated Location Request (MO-LR) sent by the first UE, or a Mobile Terminated Location Request (MT-LR) or a periodic or triggered MT-LR sent by an external client; obtain, via the one or more transceivers from the first UE of the plurality of UEs, capability information of each UE of the plurality of UEs; obtain the location related information; and send the location related information via the one or more transceivers, wherein the sending comprises one of: sending the location related information to the first UE, responsive to the request of location related information being based on (i) MO-LR, wherein the location related information supports the sidelink positioning of the plurality of UEs; or sending the location related information to the external client, responsive to the request of location related information being based on (ii) MT-LR or periodic or triggered MT-LR, wherein the location related information is based on the sidelink positioning of the plurality of UEs.

Clause 32: The location server of clause 31, wherein the one or more processors are configured not to communicate with any UEs of the plurality of UEs, other than the first UE, for the sidelink positioning of the plurality of UEs.

Clause 33: The location server of any one of clauses 31-32 wherein the one or more processors are configured to include, in the location related information, one or more location results for the sidelink positioning of the plurality of UEs, wherein a location result comprises one or more of: a range between a pair of UEs of the plurality of UEs; a direction between one UE and another UE of the plurality of UEs; a location of a UE of the plurality of UEs; a location of a one UE relative to the location of another UE of the plurality of UEs; a velocity of a UE of the plurality of UEs; or a velocity of one UE relative to the velocity of another UE of the plurality of UEs.

Clause 34: The location server of clause 33 wherein to obtain the location related information, the one or more processors are configured to obtain at least one location result for each UE of the plurality of UEs.

Clause 35: The location server of clause 33 wherein each UE of the plurality of UEs is a target UE.

Clause 36: The location server of clause 33 wherein, to obtain the location related information, the one or more processors are configured to send a request for location measurements to the first UE, wherein the first UE coordinates the sidelink positioning of the plurality of UEs based on the request for the location measurements, wherein the first UE obtains the location measurements based on the sidelink positioning of the plurality of UEs; receive the location measurements from the first UE; and calculate the location related information based on the location measurements.

Clause 37: The location server of any one of clauses 31-36 wherein, to obtain the location related information, the one or more processors are configured to send a request for the location related information to the first UE, wherein the first UE coordinates the sidelink positioning of the plurality of UEs based on the request for the location related information, wherein the first UE obtains the location related information based on the sidelink positioning of the plurality of UEs; and receive the location related information from the first UE.

Clause 38: The location server of any one of clauses 31-37 wherein, to obtain the location related information, responsive to the request being based on (i) the MO-LR sent by the first UE, the one or more processors are configured to obtain assistance data.

Clause 39: The location server of clause 38 wherein the one or more processors are further configured to: receive a request for specific assistance data from the first UE; determine the specific assistance data based at least in part on the request for the specific assistance data and the capability information of each UE of the plurality of UEs; and send the specific assistance data to the first UE, wherein the specific assistance data enables the sidelink positioning of the plurality of UEs.

Clause 40: The location server of any one of clauses 31-39 wherein, to receive the request for location related information, the one or more processors are configured to receive an application layer identity for each UE of the plurality of UEs.

Clause 41: The location server of any one of clauses 31-40 wherein, to receive the request based on the periodic or triggered MT-LR sent by the external client, the one or more processors are configured to receive includes a periodic event or a trigger event, the trigger event based on ranges or relative velocities of UEs of the plurality of UEs.

Clause 42: The location server of clause 41 wherein the one or more processors are further configured to: obtain the location related information at each of a succession of different times; and send the location related information to the external client in an event report at each of the succession of different times.

Clause 43: The location server of any one of clauses 31-42 wherein, responsive to the request being based on (ii) the MT-LR or the periodic or triggered MT-LR sent by the external client, the one or more processors are configured to prior to obtaining the capability information, send a separate MT-LR request or a periodic or triggered MT-LR request to the first UE, the separate MT-LR request or the periodic or triggered MT-LR request including identities for other UEs of the plurality of UEs to enable the first UE to discover the other UEs of the plurality of UEs based on the identities for the other UEs of the plurality of UEs; and receive, from the first UE, an MT-LR response or a periodic or triggered MT-LR response, wherein the MT-LR response or the periodic or triggered MT-LR response indicates whether the first UE has discovered the other UEs of the plurality of UEs and whether the other UEs of the plurality of UEs are available for the sidelink positioning of the plurality of UEs.

Clause 44: The location server of any one of clauses 31-43 wherein the one or more processors are further configured to, prior to obtaining the capability information of each UE of the plurality of UEs, send a capability request to the first UE for the capability information of each UE of the plurality of UEs, wherein obtaining the capability information of each UE of the plurality of UEs is responsive to the capability request.

Clause 45: A first UE of a plurality of UEs for supporting sidelink positioning of the plurality of UEs, the first UE comprising: one or more transceivers; one or more memories; and one or more processors communicatively coupled with the one or more transceivers and the one or more memories, wherein the one or more processors are configured to: perform an operation comprising one of: (i) sending an MO-LR request for location related information towards a location server, or (ii) receiving an MT-LR request or a periodic or triggered MT-LR request for the location related information from the location server; discover other UEs of the plurality of UEs; obtain capability information of each UE of the plurality of UEs; send the capability information of each UE of the plurality of UEs to the location server; receive a message from the location server, the message based at least in part on the capability information of each UE of the plurality of UEs; coordinate the sidelink positioning of the plurality of UEs based at least in part on the message; obtain location measurements, location results, or both, based on the sidelink positioning of the plurality of UEs; and send the location measurements or the location results to the location server when the message comprises a request for the location measurements or the location results, wherein the location server calculates the location results based on the location measurements when the first UE sends the location measurements to the location server.

Clause 46: The first UE of clause 45, wherein the location related information comprises the location results, wherein a location result comprises one or more of: a range between a pair of UEs of the plurality of UEs; a direction between one UE and another UE of the plurality of UEs; a location of a UE of the plurality of UEs; a location of a one UE relative to the location of another UE of the plurality of UEs; a velocity of a UE of the plurality of UEs; or a velocity of one UE relative to the velocity of another UE of the plurality of UEs.

Clause 47: The first UE of clause 46 wherein the location results comprise at least one location result for each UE of the plurality of UEs.

Clause 48: The first UE of any one of clauses 45-47 wherein each UE of the plurality of UEs is a target UE.

Clause 49: The first UE of any one of clauses 45-48 wherein, to receive the message, the one or more processors are configured to receive a request for the location measurements or the location results and wherein the one or more processors are further configured to send the location measurements or the location results to the location server in response to the request for the location measurements or the location results.

Clause 50: The first UE of any one of clauses 45-49 wherein, to perform the operation comprising (i) sending the MO-LR request for location related information, the one or more processors are configured to request assistance data.

Clause 51: The first UE of clause 50 wherein the one or more processors are further configured to: send a request for specific assistance data to the location server, wherein the location server determines the specific assistance data based at least in part on the request for the specific assistance data and the capability information of each UE of the plurality of UEs; and receive the specific assistance data from the location server in the message, wherein the specific assistance data enables the sidelink positioning of the plurality of UEs.

Clause 52: The first UE of any one of clauses 45-51 wherein to perform the operation comprising (ii) receiving the MT-LR request or the periodic or triggered MT-LR request, the one or more processors are configured to receive, in the MT-LR request or the periodic or triggered MT-LR request for the location related information, an application layer identity for each UE of the plurality of UEs; and the one or more processors are configured to discover the other UEs of the plurality of UEs based on the application layer identity for each UE of the plurality of UEs.

Clause 53: The first UE of any one of clauses 45-52 wherein the one or more processors are configured to, prior to performing the operation comprising (i) sending the MO-LR request for the location related information: obtain an application layer identity for each UE of the plurality of UEs based on the discovering the other UEs of the plurality of UEs; and include the application layer identity for each UE of the plurality of UEs in the MO-LR request for the location related information.

Clause 54: The first UE of any one of clauses 45-53 wherein, to perform the operation comprising (ii) receiving the MT-LR request or the periodic or triggered MT-LR request, the one or more processors are configured to receive the periodic or triggered MT-LR request; and wherein the periodic or triggered MT-LR request includes a periodic event or a trigger event, the trigger event based on ranges or relative velocities of the UEs of the plurality of UEs.

Clause 55: The first UE of any one of clauses 45-54 wherein the one or more processors are further configured to: detect the periodic event or the trigger event at each of a succession of different times; obtain the location measurements or the location results at each of the succession of different times; and send the location measurements or the location results to the location server in an event report at each of the succession of different times.

Clause 56: The first UE of clause 55 wherein the one or more processors are configured to, after performing the operation comprising (ii) receiving the MT-LR request or the periodic or triggered MT-LR request, send an MT-LR response or a periodic or triggered MT-LR response to the location server, wherein the MT-LR response or the periodic or triggered MT-LR response indicates whether the first UE has discovered the other UEs of the plurality of UEs, and wherein the MT-LR response or the periodic or triggered MT-LR response indicates whether the other UEs of the plurality of UEs are available for the sidelink positioning of the plurality of UEs.

Clause 57: The first UE of any one of clauses 45-56 wherein the one or more processors are further configured to, prior to obtaining the capability information of each UE of the plurality of UEs, receive a request for the capability information of each UE of the plurality of UEs from the location server, wherein obtaining the capability information of each UE of the plurality of UEs is responsive to the request for the capability information.

An apparatus having means for performing the method of any one of clauses 1-30.

A non-transitory computer-readable medium storing instructions, the instructions comprising code for performing the method of any one of clauses 1-30.

What is claimed is:

1. A method performed at a location server for supporting sidelink positioning of a plurality of user equipments (UEs), the method comprising:
receiving a request for location related information for the plurality of UEs, the request associated with a first UE of the plurality of UEs, the request based on one of:
(i) a Mobile Originated Location Request (MO-LR) sent by the first UE, or
(ii) a Mobile Terminated Location Request (MT-LR) or a periodic or triggered MT-LR sent by an external client;
obtaining, from the first UE of the plurality of UEs, capability information of each UE of the plurality of UEs;
obtaining the location related information; and
sending the location related information, wherein the sending comprises one of:
sending the location related information to the first UE,
responsive to the request of location related information being based on (i) MO-LR, wherein the location related information supports the sidelink positioning of the plurality of UEs; or
sending the location related information to the external client, responsive to the request of location related information being based on (ii) MT-LR or periodic or triggered MT-LR, wherein the location related information is based on the sidelink positioning of the plurality of UEs.

2. The method of claim 1, wherein the location server does not communicate with any UEs of the plurality of UEs, other than the first UE, for the sidelink positioning of the plurality of UEs.

3. The method of claim 1, wherein the location related information comprises one or more location results for the sidelink positioning of the plurality of UEs, wherein a location result comprises one or more of:
a range between a pair of UEs of the plurality of UEs;
a direction between one UE and another UE of the plurality of UEs;
a location of a UE of the plurality of UEs;
a location of a one UE relative to the location of another UE of the plurality of UEs;
a velocity of a UE of the plurality of UEs; or
a velocity of one UE relative to the velocity of another UE of the plurality of UEs.

4. The method of claim 3, wherein the location related information comprises at least one location result for each UE of the plurality of UEs.

5. The method of claim 3, wherein obtaining the location related information comprises:
sending a request for location measurements to the first UE, wherein the first UE coordinates the sidelink positioning of the plurality of UEs based on the request for the location measurements, wherein the first UE obtains the location measurements based on the sidelink positioning of the plurality of UEs;
receiving the location measurements from the first UE; and
calculating the location related information based on the location measurements.

6. The method of claim 3, wherein obtaining the location related information comprises:
sending a request for the location related information to the first UE, wherein the first UE coordinates the sidelink positioning of the plurality of UEs based on the request for the location related information, wherein the first UE obtains the location related information based on the sidelink positioning of the plurality of UEs; and
receiving the location related information from the first UE.

7. The method of claim 1, wherein each UE of the plurality of UEs comprises a target UE.

8. The method of claim 1, wherein the request is based on (i) the MO-LR sent by the first UE, wherein the location related information comprises assistance data.

9. The method of claim 8, further comprising:
receiving a request for specific assistance data from the first UE;
determining the specific assistance data based at least in part on the request for the specific assistance data and the capability information of each UE of the plurality of UEs; and
sending the specific assistance data to the first UE, wherein the specific assistance data enables the sidelink positioning of the plurality of UEs.

10. The method of claim 1, wherein the request for location related information includes an application layer identity for each UE of the plurality of UEs.

11. The method of claim 1, wherein the request is based on (ii) the MT-LR or the periodic or triggered MT-LR sent by the external client, wherein the MT-LR or the periodic or triggered MT-LR is received by a GMLC, wherein the GMLC determines the first UE based on at least one of:
a preferred ordering of UEs of the plurality of UEs indicated in the MT-LR or the periodic or triggered MT-LR sent by the external client;
the first UE having a same home PLMN as a PLMN for the GMLC; or
the first UE being served by the same home PLMN as the PLMN for the GMLC.

12. The method of claim 1, wherein the request is based on the periodic or triggered MT-LR sent by the external client, wherein the periodic or triggered MT-LR includes a periodic event or a trigger event, the trigger event based on ranges or relative velocities of UEs of the plurality of UEs.

13. The method of claim 12, further comprising:
obtaining the location related information at each of a succession of different times; and
sending the location related information to the external client in an event report at each of the succession of different times.

14. The method of claim 1, wherein the request is based on (ii) the MT-LR or the periodic or triggered MT-LR sent by the external client, and further comprising:
prior to obtaining the capability information, sending a separate MT-LR request or a periodic or triggered MT-LR request to the first UE, the separate MT-LR request or the periodic or triggered MT-LR request including identities for other UEs of the plurality of UEs to enable the first UE to discover the other UEs of the plurality of UEs based on the identities for the other UEs of the plurality of UEs; and
receiving, from the first UE, an MT-LR response or a periodic or triggered MT-LR response, wherein the MT-LR response or the periodic or triggered MT-LR response indicates whether the first UE has discovered the other UEs of the plurality of UEs and whether the other UEs of the plurality of UEs are available for the sidelink positioning of the plurality of UEs.

15. The method of claim 1, further comprising, prior to obtaining the capability information of each UE of the plurality of UEs, sending a capability request to the first UE for the capability information of each UE of the plurality of UEs, wherein obtaining the capability information of each UE of the plurality of UEs is responsive to the capability request.

16. A method performed at a first UE of a plurality of UEs for supporting sidelink positioning of the plurality of UEs, the method comprising:
performing an operation comprising one of:
(i) sending an MO-LR request for location related information towards a location server, or
(ii) receiving an MT-LR request or a periodic or triggered MT-LR request for the location related information from the location server;
discovering other UEs of the plurality of UEs;
obtaining capability information of each UE of the plurality of UEs;
sending the capability information of each UE of the plurality of UEs to the location server;
receiving a message from the location server, the message based at least in part on the capability information of each UE of the plurality of UEs;
coordinating the sidelink positioning of the plurality of UEs based at least in part on the message;
obtaining location measurements, location results, or both, based on the sidelink positioning of the plurality of UEs; and
sending the location measurements or the location results to the location server when the message comprises a request for the location measurements or the location results, wherein the location server calculates the location results based on the location measurements when the first UE sends the location measurements to the location server.

17. The method of claim 16, wherein the location server does not communicate with any of the UEs of the plurality of UEs, other than the first UE, for the sidelink positioning of the plurality of UEs.

18. The method of claim 16, wherein the location related information comprises the location results, wherein a location result comprises one or more of:
a range between a pair of UEs of the plurality of UEs;
a direction between one UE and another UE of the plurality of UEs;
a location of a UE of the plurality of UEs;
a location of a one UE relative to the location of another UE of the plurality of UEs;
a velocity of a UE of the plurality of UEs; or
a velocity of one UE relative to the velocity of another UE of the plurality of UEs.

19. The method of claim 18, wherein the location results comprise at least one location result for each UE of the plurality of UEs.

20. The method of claim 18, wherein each UE of the plurality of UEs comprises a target UE.

21. The method of claim 16, wherein the message comprises a request for the location measurements or the location results and further comprising sending the location measurements or the location results to the location server in response to the request for the location measurements or the location results.

22. The method of claim 16, wherein the first UE performs the operation comprising (i) sending the MO-LR request for location related information, and wherein the location related information comprises assistance data.

23. The method of claim 22, further comprising:
sending a request for specific assistance data to the location server, wherein the location server determines the specific assistance data based at least in part on the request for the specific assistance data and the capability information of each UE of the plurality of UEs; and
receiving the specific assistance data from the location server in the message, wherein the specific assistance data enables the sidelink positioning of the plurality of UEs.

24. The method of claim 16, wherein:
the first UE performs the operation comprising (ii) receiving the MT-LR request or the periodic or triggered MT-LR request;
the MT-LR request or the periodic or triggered MT-LR request for the location related information includes an application layer identity for each UE of the plurality of UEs; and
discovering the other UEs of the plurality of UEs is based on the application layer identity for each UE of the plurality of UEs.

25. The method of claim 16, wherein the first UE performs the operation comprising (i) sending the MO-LR request for the location related information, and wherein the method further comprises:
obtaining an application layer identity for each UE of the plurality of UEs based on the discovering the other UEs of the plurality of UEs; and
including the application layer identity for each UE of the plurality of UEs in the MO-LR request for the location related information.

26. The method of claim 16, wherein the first UE performs the operation comprising (ii) receiving the MT-LR request or the periodic or triggered MT-LR request; and wherein a separate request for the MT-LR or the periodic or triggered MT-LR sent by an external client is received by a GMLC, wherein the GMLC determines the first UE based on at least one of:
a preferred ordering of the UEs of the plurality of UEs indicated in the request for the MT-LR or the periodic or triggered MT-LR;
the first UE having a same home PLMN as a PLMN for the GMLC; or
the first UE being served by the same home PLMN as the PLMN for the GMLC.

27. The method of claim 16, wherein the first UE performs the operation comprising (ii) receiving the MT-LR request or the periodic or triggered MT-LR request, the MT-LR request comprising the periodic or triggered MT-LR request; and wherein the periodic or triggered MT-LR request includes a periodic event or a trigger event, the trigger event based on ranges or relative velocities of the UEs of the plurality of UEs.

28. The method of claim 27, further comprising:
detecting the periodic event or the trigger event at each of a succession of different times;
obtaining the location measurements or the location results at each of the succession of different times; and
sending the location measurements or the location results to the location server in an event report at each of the succession of different times.

29. The method of claim 16, wherein the first UE performs the operation comprising (ii) receiving the MT-LR request or the periodic or triggered MT-LR request, and wherein the method further comprises sending an MT-LR response or a periodic or triggered MT-LR response to the location server, wherein the MT-LR response or the periodic or triggered MT-LR response indicates whether the first UE has discovered the other UEs of the plurality of UEs, wherein the MT-LR response or the periodic or triggered MT-LR response indicates whether the other UEs of the plurality of UEs are available for the sidelink positioning of the plurality of UEs.

30. The method of claim 16, further comprising, prior to obtaining the capability information of each UE of the plurality of UEs, receiving a request for the capability information of each UE of the plurality of UEs from the location server, wherein obtaining the capability information of each UE of the plurality of UEs is responsive to the request for the capability information.

31. A location server for supporting sidelink positioning of a plurality of user equipments (UEs), the location server comprising:
one or more transceivers;
one or more memories; and
one or more processors communicatively coupled with the one or more transceivers and the one or more memories, wherein the one or more processors are configured to:
receive, via the one or more transceivers, a request for location related information for the plurality of UEs, the request associated with a first UE of the plurality of UEs, the request being based on one of:
(i) a Mobile Originated Location Request (MO-LR) sent by the first UE, or
(ii) a Mobile Terminated Location Request (MT-LR) or a periodic or triggered MT-LR sent by an external client;
obtain, via the one or more transceivers from the first UE of the plurality of UEs, capability information of each UE of the plurality of UEs;
obtain the location related information; and
send the location related information via the one or more transceivers, wherein the sending comprises one of:
sending the location related information to the first UE, responsive to the request of location related information being based on (i) MO-LR, wherein the location related information supports the sidelink positioning of the plurality of UEs; or
sending the location related information to the external client, responsive to the request of location related information being based on (ii) MT-LR or periodic or triggered MT-LR, wherein the location related information is based on the sidelink positioning of the plurality of UEs.

32. The location server of claim 31, wherein the one or more processors are configured not to communicate with any UEs of the plurality of UEs, other than the first UE, for the sidelink positioning of the plurality of UEs.

33. The location server of claim 31, wherein the one or more processors are configured to include, in the location related information, one or more location results for the sidelink positioning of the plurality of UEs, wherein a location result comprises one or more of:
a range between a pair of UEs of the plurality of UEs;
a direction between one UE and another UE of the plurality of UEs;
a location of a UE of the plurality of UEs;
a location of a one UE relative to the location of another UE of the plurality of UEs;
a velocity of a UE of the plurality of UEs; or
a velocity of one UE relative to the velocity of another UE of the plurality of UEs.

34. The location server of claim 33, wherein to obtain the location related information, the one or more processors are configured to obtain at least one location result for each UE of the plurality of UEs.

35. The location server of claim 33, wherein, to obtain the location related information, the one or more processors are configured to:
send a request for location measurements to the first UE, wherein the first UE coordinates the sidelink positioning of the plurality of UEs based on the request for the location measurements, wherein the first UE obtains the location measurements based on the sidelink positioning of the plurality of UEs;
receive the location measurements from the first UE; and
calculate the location related information based on the location measurements.

36. The location server of claim 33, wherein, to obtain the location related information, the one or more processors are configured to:
send a request for the location related information to the first UE, wherein the first UE coordinates the sidelink positioning of the plurality of UEs based on the request for the location related information, wherein the first UE obtains the location related information based on the sidelink positioning of the plurality of UEs; and
receive the location related information from the first UE.

37. The location server of claim 31, wherein each UE of the plurality of UEs comprises a target UE.

38. The location server of claim 31, wherein, to obtain the location related information, responsive to the request being based on (i) the MO-LR sent by the first UE, the one or more processors are configured to obtain assistance data.

39. The location server of claim 38, wherein the one or more processors are further configured to:
receive a request for specific assistance data from the first UE;
determine the specific assistance data based at least in part on the request for the specific assistance data and the capability information of each UE of the plurality of UEs; and
send the specific assistance data to the first UE, wherein the specific assistance data enables the sidelink positioning of the plurality of UEs.

40. The location server of claim 31, wherein, to receive the request for location related information, the one or more processors are configured to receive an application layer identity for each UE of the plurality of UEs.

41. The location server of claim 31, wherein, to receive the request based on the periodic or triggered MT-LR sent by the external client, the one or more processors are configured to receive includes a periodic event or a trigger event, the trigger event based on ranges or relative velocities of UEs of the plurality of UEs.

42. The location server of claim 41, wherein the one or more processors are further configured to:
obtain the location related information at each of a succession of different times; and
send the location related information to the external client in an event report at each of the succession of different times.

43. The location server of claim 31, wherein, responsive to the request being based on (ii) the MT-LR or the periodic or triggered MT-LR sent by the external client, the one or more processors are configured to:
prior to obtaining the capability information, send a separate MT-LR request or a periodic or triggered MT-LR request to the first UE, the separate MT-LR request or the periodic or triggered MT-LR request including identities for other UEs of the plurality of UEs to enable the first UE to discover the other UEs of the plurality of UEs based on the identities for the other UEs of the plurality of UEs; and
receive, from the first UE, an MT-LR response or a periodic or triggered MT-LR response, wherein the MT-LR response or the periodic or triggered MT-LR response indicates whether the first UE has discovered the other UEs of the plurality of UEs and whether the other UEs of the plurality of UEs are available for the sidelink positioning of the plurality of UEs.

44. The location server of claim 31, wherein the one or more processors are further configured to, prior to obtaining the capability information of each UE of the plurality of UEs, send a capability request to the first UE for the capability information of each UE of the plurality of UEs, wherein obtaining the capability information of each UE of the plurality of UEs is responsive to the capability request.

45. A first UE of a plurality of UEs for supporting sidelink positioning of the plurality of UEs, the first UE comprising:
one or more transceivers;
one or more memories; and
one or more processors communicatively coupled with the one or more transceivers and the one or more memories, wherein the one or more processors are configured to:
perform an operation comprising one of:
(i) sending an MO-LR request for location related information towards a location server, or
(ii) receiving an MT-LR request or a periodic or triggered MT-LR request for the location related information from the location server;
discover other UEs of the plurality of UEs;
obtain capability information of each UE of the plurality of UEs;
send the capability information of each UE of the plurality of UEs to the location server;
receive a message from the location server, the message based at least in part on the capability information of each UE of the plurality of UEs;
coordinate the sidelink positioning of the plurality of UEs based at least in part on the message;
obtain location measurements, location results, or both, based on the sidelink positioning of the plurality of UEs; and
send the location measurements or the location results to the location server when the message comprises a request for the location measurements or the location results, wherein the location server calculates the location results based on the location measurements when the first UE sends the location measurements to the location server.

46. The first UE of claim 45, wherein the location related information comprises the location results, wherein a location result comprises one or more of:
a range between a pair of UEs of the plurality of UEs;
a direction between one UE and another UE of the plurality of UEs;
a location of a UE of the plurality of UEs;
a location of a one UE relative to the location of another UE of the plurality of UEs;
a velocity of a UE of the plurality of UEs; or
a velocity of one UE relative to the velocity of another UE of the plurality of UEs.

47. The first UE of claim 46, wherein the location results comprise at least one location result for each UE of the plurality of UEs.

48. The first UE of claim 45, wherein each UE of the plurality of UEs comprises a target UE.

49. The first UE of claim 45, wherein, to receive the message, the one or more processors are configured to receive a request for the location measurements or the location results and wherein the one or more processors are further configured to send the location measurements or the location results to the location server in response to the request for the location measurements or the location results.

50. The first UE of claim 45, wherein, to perform the operation comprising (i) sending the MO-LR request for location related information, the one or more processors are configured to request assistance data.

51. The first UE of claim 50, wherein the one or more processors are further configured to:
send a request for specific assistance data to the location server, wherein the location server determines the specific assistance data based at least in part on the request for the specific assistance data and the capability information of each UE of the plurality of UEs; and
receive the specific assistance data from the location server in the message, wherein the specific assistance data enables the sidelink positioning of the plurality of UEs.

52. The first UE of claim 45, wherein:
to perform the operation comprising (ii) receiving the MT-LR request or the periodic or triggered MT-LR request, the one or more processors are configured to receive, in the MT-LR request or the periodic or triggered MT-LR request for the location related information, an application layer identity for each UE of the plurality of UEs; and
the one or more processors are configured to discover the other UEs of the plurality of UEs based on the application layer identity for each UE of the plurality of UEs.

53. The first UE of claim 45, wherein the one or more processors are configured to, prior to performing the operation comprising (i) sending the MO-LR request for the location related information:
obtain an application layer identity for each UE of the plurality of UEs based on the discovering the other UEs of the plurality of UEs; and
include the application layer identity for each UE of the plurality of UEs in the MO-LR request for the location related information.

54. The first UE of claim 45, wherein, to perform the operation comprising (ii) receiving the MT-LR request or the periodic or triggered MT-LR request, the one or more processors are configured to receive the periodic or triggered MT-LR request; and wherein the periodic or triggered MT-LR request includes a periodic event or a trigger event, the trigger event based on ranges or relative velocities of the UEs of the plurality of UEs.

55. The first UE of claim 54, wherein the one or more processors are further configured to:
detect the periodic event or the trigger event at each of a succession of different times;
obtain the location measurements or the location results at each of the succession of different times; and
send the location measurements or the location results to the location server in an event report at each of the succession of different times.

56. The first UE of claim 45, wherein the one or more processors are configured to, after performing the operation comprising (ii) receiving the MT-LR request or the periodic or triggered MT-LR request, send an MT-LR response or a periodic or triggered MT-LR response to the location server, wherein the MT-LR response or the periodic or triggered MT-LR response indicates whether the first UE has discovered the other UEs of the plurality of UEs, and wherein the MT-LR response or the periodic or triggered MT-LR response indicates whether the other UEs of the plurality of UEs are available for the sidelink positioning of the plurality of UEs.

57. The first UE of claim 45, wherein the one or more processors are further configured to, prior to obtaining the capability information of each UE of the plurality of UEs, receive a request for the capability information of each UE of the plurality of UEs from the location server, wherein obtaining the capability information of each UE of the plurality of UEs is responsive to the request for the capability information.
